(19) United States
(12) Patent Application Publication
(10) Pub. No.: US 2026/0146852 A1
(43) Pub. Date: May 28, 2026

(54) METHOD AND SYSTEM FOR CHARACTERISING VISUAL IDENTITIES USED FOR LOCALISATION TO AID ACCURACY AND LONG-TERM MAP MANAGEMENT

(71) Applicant: Opteran Technologies Limited, Sheffield South Yorkshire (GB)

(72) Inventors: Alexander John Cope, Walkley, Sheffield South Yorkshire (GB); Mark Francis Kelly, Mexborough, Doncaster South Yorkshire (GB); Sebastian Scott James, Sheffield South Yorkshire (GB); Alexander Blenkinsop, Walkley, Sheffield South Yorkshire (GB)

(73) Assignee: Opteran Technologies Limited, Sheffield South Yorkshire (GB)

(21) Appl. No.: 18/881,054

(22) PCT Filed: Jul. 4, 2023
(86) PCT No.: PCT/GB2023/051759

§ 371 Date: Jan. 3, 2025

(30) Foreign Application Priority Data
Jul. 4, 2022 (GB) 2209825.5

(51) Int. Cl. G01C 21/00

(52) U.S. Cl. CPC G01C 21/005; G01C 21/3848; G01C 21/3859

(57) ABSTRACT

There is provided a method, device and computer program for navigating an agent in a multidimensional space, the method comprising: generating a data field that spatially corresponds to a multidimensional space in which an agent resides, wherein the data field is populated with observation comparison measure data with respect to a stored observation, the stored observation including second sensor data describing an environment of a first position in the multidimensional space, wherein the generating the data field comprises: obtaining a plurality of current observations made by the agent at different respective positions in the multidimensional space, the current observations including first sensor data describing an environment of each of the different respective positions in the multidimensional space; comparing each of the current observations with the stored observation to obtain respective observation comparison measure data for the different respective positions in the multidimensional space; and populating the data field with the observation comparison measure data according to the different respective positions in the multidimensional space; the method further comprising: determining a reliability measure associated with the stored observation by performing a reliability check of the data field; and managing a digital map of the multidimensional space by maintaining, updating, or deleting information in the digital map regarding the stored observation based on the reliability measure.

### TECHNICAL FIELD

The invention relates to a computer-implemented method, device, system and computer program for map management, and in particular, improving reliability and the accuracy of a map for the purposes of navigating a two or three dimensional space.

### BACKGROUND OF INVENTION

Simultaneous localization and mapping (SLAM) is the problem and process of computationally constructing or updating a map of an unknown environment, while simultaneously keeping track of an agent's location within it. SLAM algorithms are based on concepts in computational geometry and computer vision, and are used in robot navigation, robotic mapping and odometry for virtual reality or augmented reality.

SLAM algorithms are also used in the control of autonomous vehicles, to map out unknown environments in the vicinity of the vehicle. The resulting map information may be used to carry out tasks such as path planning and obstacle avoidance.

Visual SLAM uses an approach consisting of a front end, which processes images from a camera to perform ‘feature extraction’. This feature extraction process finds small regions of the image that meet certain criteria for being visually distinct, such as high local spatial frequency and contrast. These regions can then be stored for the purpose of locating the same region in a subsequent camera image from the same camera, taken a short interval later. These features' locations are then mapped onto directions in the real world by applying a camera model that accounts for the distortions of the camera lens. These are then provided to the back end of the algorithm, which is known as a bundle adjuster. The bundle adjuster attempts to compare the predicted locations in 3D space of the features based on previous camera images with the new directions from the current camera image and determine, simultaneously, the location of the features relative to each other in 3D space, and the location of the camera relative to the features. By repeating this process the bundle adjuster tracks the location of the moving camera and the locations of a map of features over time.

This approach suffers from several drawbacks that limit its effectiveness in real world robotic applications. Firstly, both feature extraction and bundle adjustment are very computationally expensive processes. Feature extraction can be readily parallelised for improvements to efficiency, however bundle adjustment is a strictly sequential process.

Secondly, bundle adjustment requires that the new feature directions and the predicted feature locations converge to a stable solution, something that is heavily influenced by sensor noise and changes in the environment, such as wind blowing leaves on bushes. If features are erroneously detected in incorrect locations on the camera image, then bundle adjustment can fail to converge to a stable solution, and the system becomes ‘lost’ and unable to localise.

To address bundle adjuster convergence failure, the state of the art takes two approaches. One reduces failure, and the other allows the system to continue with reduced performance when convergence fails.

The first approach is outlier rejection. A set of constraints is used to evaluate how likely it is that when a feature is found it is the same one as found previously. If the feature has moved from one side of the camera to the other, for example, it is unlikely to be the same unless the camera is moving very fast, and is rejected as a match. If it is close to the previous location, then it is likely to be the same feature and is accepted. Accepted features are passed to the bundle adjuster, rejected ones are not. Outlier rejection is another highly computationally expensive process, and for some SLAM systems is the largest computational component.

The second approach is Visual-Inertial Odometry. This is a system that uses the features located by the feature extractor in a different way. It uses a second source of motion information, a measure of linear acceleration from an inertial sensor, along with tracking features, to predict the velocity of the camera, rather than the position. This velocity measure can then be integrated over time and used in combination with the bundle adjuster to compensate for convergence failure. However, integrating VIO will accumulate a position error over time, and since this approach to SLAM relies on metric measurements of position this will cause failure over longer integration times. Due to VIO and bundle adjustment using the same features, feature extraction is a single point of failure for the entire system.

Another weakness of the feature extraction front end is that the size of the features means that the data is relatively low dimensional for a single feature, and as such, there is a high probability of multiple parts of the image matching the feature, especially in aliased environments, such as a hotel corridor with identical doors that are evenly spaced. In these environments, it is possible for the bundle adjuster to converge to an incorrect location.

Loop closure is another weakness of the state of the art. When the moving camera traverses a complete loop and returns to the same location from a different direction the system must identify that it has returned to the same location. As the system is metric, it must also make sure that the map is consistent with the same location at the same place. Due to accumulated errors in the bundle adjustment process, this is rarely true, and there is usually a metric error between the representations of the location at the two ends of the loop. The system must then go back though all the features it stored around the entire loop and adjust them to compensate for and remove this error. This loop closure process is both computationally expensive and prone to error.

Computational complexity for algorithms that can cope with such environments and problems is very high, limiting the platforms they can be deployed on. Additionally, memory consumption for generated maps is very high, in the order of hundreds of megabytes to multiple gigabytes. Furthermore, the generated maps may become unreliable due to minor changes in the environment, such as the displacement of a feature of the environment. These changes have to be accounted for by adding or removing points from the map, which is a laborious process when using SLAM algorithms.

It is appreciated that a method and system for managing a map utilising an alternative to SLAM, and improving the reliability thereof, is required.

### SUMMARY OF INVENTION

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a computer-implemented method of navigating an agent in a multidimensional space, the method comprising: generating a data field that spatially corresponds to a multidimensional space in which an agent resides, wherein the data field is populated with observation comparison measure data with respect to a stored observation, the stored observation including second sensor data describing an environment of a first position in the multidimensional space, wherein the generating the data field comprises: obtaining a plurality of current observations made by the agent at different respective positions in the multidimensional space, the current observations including first sensor data describing an environment of each of the different respective positions in the multidimensional space; comparing each of the current observations with the stored observation to obtain respective observation comparison measure data for the different respective positions in the multidimensional space; and populating the data field with the observation comparison measure data according to the different respective positions in the multidimensional space; the method further comprising: determining a reliability measure associated with the stored observation by performing a reliability check of the data field; and managing a digital map of the multidimensional space by maintaining, updating, or deleting information in the digital map regarding the stored observation based on the reliability measure.

The agent may be a real device or system such as a vehicle or robot or may be virtual.

The first sensor data and the second sensor data may be first and second image data respectively, wherein the first and second sensor data are arranged in a first vector and a second vector extracted from the first and second image data respectively.

The method may further comprise obtaining the first sensor data and the second sensor data, wherein obtaining the first sensor data comprises: obtaining original first sensor data of the environment of the agent at each of the different respective positions in the multidimensional space; processing the original first sensor data to reduce the size of the original first sensor data to obtain the first sensor data, such that the first sensor data is in a reduced-size format relative to the original first sensor data; wherein obtaining the second sensor data comprises: obtaining original second sensor data of the environment of the agent at the first location; and processing the original second sensor data to reduce the size of the original second sensor data to obtain the second sensor data, such that the second sensor data is in a reduced-size format relative to the original second sensor data; and storing the second sensor data in the reduced-size format.

Processing the original first and original second sensor data may comprise applying one or more filters and/or masks to the original first and original second sensor data to reduce the size of each dimension of the original first and original second sensor data respectively.

The method may further comprise navigating the agent to the stored observation according to the digital map.

The digital map may comprise information regarding a series of stored observations and displacement vectors linking the series of observations; and wherein navigating includes using the digital map information to navigate the agent to one of the series of stored observations.

The data field may include an action vector field, the action vector field comprising a plurality of action vectors, wherein the observation comparison measure data is the plurality of action vectors, and wherein each of the plurality of action vectors originates at one of the different respective first positions in the vector field and are directed in an estimated direction of the first position in the vector field.

Comparing each of the current observations with the stored observation to obtain respective observation comparison measure data for the different respective positions in the multidimensional space may comprise, for each current observation: obtaining a plurality of first sub-regions of the first sensor data, each first sub-region describing a respective first portion of the environment around the agent at the one of the different respective positions, each first portion being associated with a respective first direction from the one of the different respective positions; obtaining a plurality of second sub-regions of the second sensor data, each second sub-region describing a respective second portion of the environment around the first position, each second portion being associated with a respective second direction from the first position; and, for each second sub-region: comparing the second sub-region against each first sub-region using a similarity comparison measure to determine a most similar first sub-region to the second sub-region; determining a relative rotation between the second direction associated with the second sub-region and the first direction associated with the most similar first sub-region; the method further comprising: aggregating the relative rotations for the plurality of second sub-regions to obtain an action vector, the action vector indicative of an estimated direction from the one of the different respective positions to the first position, wherein the observation comparison measure includes the action vector.

Determining a reliability measure associated with the stored observation by performing a reliability check of the data field may comprise: obtaining a model action vector field spatially corresponding to the action vector field, wherein the model action vector field comprises a plurality of model action vectors, each of which are directed directly to the first position, such that the model vector field is radially convergent on the first position; comparing the plurality of action vectors of the action vector field to the spatially corresponding model action vectors of the model action vector field to determine an angular deviation between each action vector and corresponding model action vector; aggregating or averaging the angular deviations between the plurality of action vectors and the plurality of model action vectors to determine a first scalar measure, wherein the reliability measure includes the first scalar measure.

The determining a reliability measure associated with the stored observation by performing a reliability check of the data field may comprise: determining a first number of the different respective positions for which it is not possible to obtain an action vector; determining a second number of the different respective positions for which it is possible to obtain an action vector; dividing the first number by the second number to determine a second scalar measure, wherein the reliability measure includes the second scalar measure.

Managing a digital map of the multidimensional space by maintaining, updating, or deleting information in the digital map regarding the stored observation based on the reliability measure may comprise: comparing the reliability measure to one or more thresholds to determine whether to update, delete or maintain the information in the digital map. Managing the map is important as it allows for more accurate or successful navigation of the space. Deleting the information in the digital map may comprise deleting information regarding the stored observation in the digital map and adjusting the map to account for the deleted information; and/or updating the information in the digital map comprises: obtaining replacement second sensor data at the first position in the multidimensional space to form a replacement stored observation; and regenerating the data field according to the replacement stored observation.

Adjusting the map to account for the deleted information may include adjusting displacements and other connections, such as odometrical data between neighbouring nodes (stored observations), since these neighbouring nodes may have to be connected together, for example, if the deleted information corresponds to an intermediate node.

The method may further include aggregating the first scalar measure and the second scalar measure, such that the reliability measure includes both the first and second scalar measures.

The data field may include a similarity magnitude scalar field, the similarity magnitude scalar field comprising a plurality of similarity magnitude values indicative of a similarity between the stored observation and respective current observations at each of the different respective positions, wherein the observation comparison measure data is the plurality of similarity magnitude values.

Comparing each of the current observations with the stored observation to obtain respective observation comparison measure data for the different respective positions in the multidimensional space may comprise: comparing each current observation with the stored observation using a similarity comparison measure to determine a similarity magnitude value for each of different respective positions, wherein the observation comparison measure data includes the similarity magnitude values.

The current observation and the stored observation may be arranged as vectors and the similarity comparison measure is the inner product of these vectors.

The determining a reliability measure associated with the stored observation by performing a reliability check of the data field may comprise: determining a maximum similarity magnitude value of the plurality of similarity magnitude values of the similarity magnitude scalar field; dividing the maximum similarity magnitude value by the mean of the plurality of the similarity magnitude values to determine a third scalar value, wherein the reliability measure includes the third scalar measure.

The method may further comprise generating a parameterised model of the similarity magnitude scalar field that approximates the similarity magnitude scalar field.

The determining of the reliability measure may be performed with respect to the parameterised model.

The determining a reliability measure associated with the stored observation by performing a reliability check of the data field may comprise: determining the variability between the similarity magnitude values and model values of the parameterised model; and obtaining a fourth scalar value based on the variability, wherein the reliability measure includes the fourth scalar measure.

Managing the digital map by maintaining, updating, or deleting the information associated with the stored observation based on the reliability measure may comprise comparing the reliability measure to one or more thresholds to determine whether to update, delete or maintain the information in the digital map and

The method may comprise aggregating the third scalar measure and the fourth scalar measure, such that the reliability measure includes both the first and second scalar measures.

The method may comprise aggregating the first scalar measure and the second scalar measure and the third scalar measure and the fourth scalar measure, such that the reliability measure includes all of the first, second, third and fourth scalar measures.

According to a second aspect of this disclosure, there is provided a computing device or system comprising a processor and a memory, the memory having instructions stored thereon, that, when executed by the processor, cause the computing device to perform the method of the first aspect above.

According to a third aspect of this disclosure, there is provided a computer program, which, when executed by a processor, causes the processor to perform the method of the first aspect above.

According to a fourth aspect of this disclosure, there is provided a computer-implemented method of determining a position of an agent in a multi-dimensional space, the method comprising: obtaining a similarity magnitude field that spatially corresponds to a multidimensional space in which an agent resides, wherein the similarity magnitude field comprises a plurality of similarity magnitude values indicative of a similarity between a stored observation corresponding to a first position in the multidimensional space, and respective current observations each corresponding to one of a plurality of different respective positions in the multidimensional space; obtaining, by the agent, a new observation at a present position of the agent in the multidimensional space; comparing the new observation to the stored observation to obtain a new similarity magnitude value; comparing a new location measure based on the new similarity magnitude value to a field location measure based on the similarity magnitude values of the similarity magnitude field, to identify a most likely or matching field location measure to the new location measure; and identifying one or more possible positions of the agent in the multidimensional space based on one or more field positions in the similarity magnitude field corresponding to the most likely or matching field location measure.

The new location measure and the field location measure may combine one or more different measures or functions based on the similarity magnitude field and/or other modalities. In the following description, the new and field location measures may be based on the first to fourth ‘modes’.

The new location measure may include the new similarity magnitude value; and the field location measure may be each of the similarity magnitude values of the similarity magnitude field, such that the most likely or matching field location measure is a matching similarity magnitude value of the similarity magnitude field or a range of similarity magnitude values of the similarity magnitude field wherein the range contains the new similarity magnitude value; and identifying the one or more possible positions of the agent in the multidimensional space may comprise: retrieving the one or more field positions of the matching similarity magnitude value of the similarity magnitude field or the range of similarity magnitude values of the similarity magnitude field wherein the range; and determining the one or more positions of the agent in the multidimensional space according to the field position.

The method may further comprise generating the similarity magnitude field, by: obtaining the stored observation, the stored observation including second sensor data describing an environment of the first position in the multidimensional space, obtaining the plurality of current observations made by the agent at the different respective positions in the multidimensional space, the current observations including first sensor data describing an environment of each of the different respective positions in the multidimensional space; comparing each of the current observations with the stored observation to obtain using a similarity comparison measure to determine a similarity magnitude value for each of the different respective positions in the multidimensional space; and populating the similarity magnitude field with the similarity magnitude values according to the different respective positions in the multidimensional space.

The current observations and the stored observation may be arranged as vectors and the similarity comparison measure is the inner product of these vectors.

The method may further comprise obtaining a second similarity magnitude field that spatially corresponds to the multidimensional space in which an agent resides, wherein the second similarity magnitude field comprises a second plurality of similarity magnitude values indicative of a similarity between a second stored observation corresponding to a second position in the multidimensional space, and respective current observations each corresponding to one of a plurality of different respective positions in the multidimensional space; comparing the new observation to the second stored observation to obtain a second new similarity magnitude value; wherein the new location measure includes a ratio between the new similarity magnitude value and the second new similarity magnitude value, and wherein the field location measure includes a plurality of field ratios between the plurality of similarity magnitude values and the second plurality of similarity magnitude values, wherein each field ratio of the plurality of field ratios is determined for different positions in the similarity magnitude field; such that the most likely or matching field location measure to the new location measure includes one or more field ratios; and wherein identifying the one or more positions of the agent in the multidimensional space based on the one or more field positions in the similarity magnitude field corresponding to the most likely or matching field location measure comprises: retrieving the one or more field positions of the matching one or more field ratios in the similarity magnitude field; and determining the one or more positions of the agent in the multidimensional space according to the field position.

The second stored observation and the second similarity magnitude field may be used without ratios, to narrow down the possible one or more positions of the agent in the space, since the positions will have to provide matches for both the stored observation and second stored observation. This may also apply to more than two stored observations. Using three stored observations increases the precision of the method and reduces the number of possibilities for the position of the agent, as three matches are required to register the position as a possible position of the agent.

The new location measure may both the ratio between the new similarity magnitude value and the new similarity magnitude value; and wherein the field location measure includes each of the similarity magnitude values of the similarity magnitude field and the plurality of field ratios, such that the most likely or matching field location measure is both: a matching similarity magnitude value of the similarity magnitude field or a range of similarity magnitude values of the similarity magnitude field wherein the range contains the new similarity magnitude value; and one or more matching field ratios; whereby the matching similarity magnitude value and the matching field ratio are associated with the same one or more positions in the multidimensional space.

Using both the ratios and the similarity magnitude values increases the precision and narrows down the possible position of the agent in the space, since a match requires a match of the ratio and a match of the similarity magnitude value, rather than just one of these matches.

The method may further include, prior to comparing the new location measure based on the new similarity magnitude value to the field location measure based on the similarity magnitude values of the similarity magnitude field: generating a parameterised model of the similarity magnitude field, such that the comparing is performed with respect to a model field location measure based on model similarity magnitude values of the model similarity magnitude field.

The method may further include obtaining an action vector field that spatially corresponds to a multidimensional space in which an agent resides, wherein the action vector field comprises a plurality of action vectors indicative of a direction towards the first position of the stored observation from the plurality of different respective positions in the multidimensional space; the method further comprising: discounting one or more of the one or more possible positions of the agent based on the direction of one or more action vectors associated with the field position.

The action vector field may be obtained in the same manner as the first aspect above.

The method may further include generating an output field, wherein the output field is based on the identified one or more positions of the agent in the multidimensional space, the output field having the same dimensions as the similarity magnitude field and indicating a probabilistic distribution of the identified one or more positions of the agent in the multidimensional space. The output field may be referred to as a likely location array or field.

Discounting the one or more of the one or more possible positions of the agent based on the direction of one or more action vectors associated with the one or more field positions may comprise: adjusting the probabilistic distribution of the identified one or more positions of the agent in the output field based on the direction of the one or more action vectors associated with the one or more field positions.

The probabilistic distribution of the output field may be based on the one or more possible positions of the agent determined according to the similarity magnitude field values, the ratios, and the action vectors as set out above. Each of the possible positions of the agent, determined from each of these modalities or modes, may be mapped in a probability distribution of possible agent locations according to each of the similarity magnitude field values, the ratios, and the action vectors. These arrays may then be summed element-wise and optionally normalised to form the output field.

The method may further comprise: obtaining a plurality of similarity magnitude fields that spatially corresponds to the multidimensional space in which the agent resides, wherein the plurality of similarity magnitude fields comprises respective sets of similarity magnitude values indicative of a similarity between a respective plurality of stored observations corresponding to a plurality of respective first positions in the multidimensional space, and respective current observations each corresponding to one of a plurality of different respective positions in the multidimensional space; and, for each of the plurality of stored observations, comparing the new observation to the stored observation to obtain a respective plurality of new similarity magnitude values; comparing a plurality of new location measures based on the plurality of new similarity magnitude values to respective field location measures based on the sets of similarity magnitude values of the plurality of similarity magnitude fields, to identify a most likely or matching field location measure to each of the plurality of new location measures; and identifying one or more possible positions of the agent in the multidimensional space based on one or more field positions in the similarity magnitude field corresponding to the most likely or matching field location measure for each of the plurality of new location measures.

Thus, each one of, or a combination of, the similarity magnitude values, the ratios, the action vectors, and the odometrical information may be used with respect to several stored observations, combining the output to determine possible positions of the agent from multiple different fields and associated stored observations.

Taking the similarity magnitude field as an example, three stored observations and three associated similarity magnitude fields may be used to determine the possible agent positions. These possible agent positions, with respect to each similarity magnitude field, may then be combined under a probability distribution.

The method may further include receiving odometrical data relating to movement of the agent; determining an estimated distance travelled by the agent from a previous position in the multidimensional space; and modifying the probabilities of the identified one or more positions of the agent in the multidimensional space based on the estimated distance. The modified output field may be referred to as an odom updated array.

The method may further include modifying the probabilities of the identified one or more positions of the agent in the multidimensional space based on the reliability measure of the first aspect.

The method may further include navigating the agent based on the one or more identified positions of the agent.

According to a fifth aspect of this disclosure, there is provided a computer implemented method of navigating an agent and determining the reliability of its path of navigation. This method may be independent or performed with the first and/or fourth aspect.

The method comprises navigating from the identified one or more positions of the agent in the multidimensional space to the first position corresponding to the stored observation along a first path from the identified one or more positions to the first position; determining the length of the first path to compute a metric of edge traversal reliability, wherein the length of path is inversely proportional to the metric of edge traversal reliability; comparing the metric of edge traversal reliability to a historic metric of edge traversal reliability, the historic metric calculated from the average length of paths previously travelled from the one or more positions of the agent to the first position in the multidimensional space; and if the metric of edge traversal reliability is lower than the historic metric by a threshold amount or more: determining that the first path is unreliable.

The method may further include, if the first path is determined as unreliable: performing at least one of: recording a new stored observation along the first path between the one or more positions of the agent and the first position in the multidimensional space; discounting the first path from future navigating; re-attempting the first path one or more times with different path parameters to optimise the first path by maximising the metric of edge traversal reliability; and alerting an operator of the agent.

According to a sixth aspect of this disclosure, there is provided a computing device or system comprising a processor and a memory, the memory having instructions stored thereon, that, when executed by the processor, cause the computing device to perform the method of the fourth or fifth aspects as set out above.

According to a seventh aspect of this disclosure, there is provided a computer program, which, when executed by a processor, causes the processor to perform the method of the fourth or fifth aspect as set out above.

The methods described herein may be performed by software in machine readable form on a tangible storage medium e.g., in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF FIGURES

Embodiments of the invention will be described, by way of example, with reference to the following drawings, in which:

FIG. 1 is a schematic diagram of a physical space to be parsed by an agent;

FIG. 2 is a schematic diagram of a physical/logical space to be parsed by an agent;

FIG. 3 is a flow diagram outlining a method of finding an attribute of a space;

FIG. 4 is a detailed flow diagram outlining a section of the method of finding an attribute;

FIG. 5 is a schematic diagram outlining a system for performing the methods;

FIG. 6 is a schematic diagram of a function performed by the agent in various methods;

FIG. 7 is a schematic diagram showing various ways in which an agent can move according to the methods;

FIG. 8 is a schematic showing an identity which may be used to generate a map of a space; and

FIGS. 9 and 10 show various schematic representations of vectors and matrices obtained in various methods;

FIG. 11 shows a flow diagram illustrating the process of forming sub-regions from an observation vector according to various embodiments;

FIG. 12 shows a schematic diagram of the spatial set of sub-regions corresponding to a current observation vector, according to various embodiments;

FIG. 13A shows a schematic diagram of a comparison between a sub-region of a stored observation vector and a sub-region of a current observation vector, according to various embodiments;

FIG. 13B shows a schematic diagram of a comparison between a sub-region of a stored observation vector and a sub-region of a current observation vector, according to various embodiments;

FIG. 14 shows a schematic diagram of a comparison performed by an agent between a stored observation vector and a current observation vector, according to various embodiments;

FIG. 15A shows a schematic diagram of an axis of the agent overlaid with offsets determined from the comparison of current and stored sub-regions, according to various embodiments;

FIG. 15B shows a schematic diagram of an axis of the agent overlaid with offsets determined from the comparison of current and stored sub-regions, according to various embodiments;

FIG. 15C shows a schematic diagram of an axis of the agent overlaid with an action vector determined from the comparison of current and stored sub-regions, according to various embodiments;

FIG. 15D shows a schematic diagram of an axis of the agent overlaid with an action vector determined from the comparison of current and stored sub-regions, according to various embodiments;

FIG. 16a shows a schematic diagram of a model vector field according to various embodiments;

FIG. 16b shows a schematic diagram of a realistic vector field according to various embodiments;

FIG. 17 shows a schematic diagram of the vector angle deviations between the model vector field of FIG. 16a and the realistic vector field of FIG. 16b, according to various embodiments;

FIG. 18 shows a schematic diagram of a similarity magnitude field according to various embodiments;

FIG. 19 shows a schematic diagram of a model similarity magnitude field according to various embodiments;

FIG. 20 shows a schematic diagram of a digital map according to various embodiments;

FIG. 21 shows a schematic diagram of a combination of a vector field with a similarity magnitude field according to various embodiments;

FIG. 22 illustrates a process performed to identify possible locations of an agent, according to various embodiments; and

FIG. 23 shows a schematic diagram of an edge traversal of a digital map, according to various embodiments.

Common reference numerals are used throughout the figures to indicate similar features.

### DETAILED DESCRIPTION

Examples described herein relate to a computer implemented method and system for parsing a multi-dimensional space and determining the structure of the space, and managing a map generated as a consequence of parsing the space. The approach taken by the examples described herein treats the problem of understanding space as a closed loop problem, wherein sensory data from a sensor or a virtual sensor, describing the environment of an agent, directly drives changes in the behaviour of the agent.

The term ‘agent’ is used to refer to either or both of a physical agent that exists in a real-world physical space, such as a vehicle or robot, and a non-physical agent, that exists in a logical space, such as a point or pixel in an image or map.

The agent is capable of moving within its respective space. In the physical space, the agent moves from activation of a movement module, which may be an actuator or motor for example. In the logical space, the agent moves from a first point or pixel to a second point or pixel. The agent may be real or virtual. A real agent, such as a robot, occupies an area in the space. A virtual agent is a projection onto the space, and does not actually exist in the space. For example, a virtual agent may be the projection of a centre point of the field of view of a camera that observes a two-dimensional scene. The camera may move and/or rotate to change the centre point of the field of view on the scene and thus the location of the virtual agent. This is explained in more detail below.

A physical space refers to any three-dimensional space that may be physically reached or traversed by an object, vehicle, robot or any other agent in the real world. The three-dimensional space may comprise one or more other physical or material objects. The three-dimensional space may also encompass an interval of distance (or time) between two points, objects, or events, with which the agent may interact when traversing the physical space.

A logical space refers to a space, such as a mathematical or topological space, with any set of points. A logical space may thus be an image or map or a concept map, for example. A set of points may satisfy a set of postulates or constraints. The logical space may correspond with the physical space as described above.

Data is captured with respect to the position of the agent in the space, and the data captured describes the environment of the space in the vicinity of the agent. The capturing of data is performed by a sensor in the physical space, such as a camera, radar, tactile sensor, LIDAR sensor, infrared sensor or the like. The capturing of data is performed by a virtual sensor in the logical space, which retrieves data of the logical space within the vicinity of the agent.

In the physical space, there is an observability problem in that not all the physical space may be observable by the agent at any given time. The physical space may be too large for the sensor to observe, and/or the physical space may include objects, terrain or the like that occludes regions of the physical space.

In the logical space, all of the logical space may be observable at once. For example, when the logical space is an image, the entirety of the image may be stored on a memory accessible by the agent.

However, in the logical space, it is not necessary, and is more efficient, if the agent does not observe the entire logical space at once. For this reason, the virtual sensor may only obtain a portion of the logical space, thus simulating the sensor of the physical space in that only the vicinity of the agent in the logical space is captured and/or retrieved by the virtual sensor.

Thus, in both scenarios of an agent in a logical space and an agent in the physical space, it is not necessary for the agent to observe the entirety of the respective space, and it is advantageous computationally if the agent only observes a portion of the respective space in the vicinity of the agent.

When the agent is a non-physical agent in the logical space, it is not necessary that the vicinity of the agent is observed directly by a sensor or a virtual sensor. For example, the vicinity of the agent may be a portion or region of a pre-recorded image that defines the overall logical space.

Data captured by the sensor or virtual sensor observing the space in the vicinity of the agent is defined as observation data. This observation data is used to make an ‘observation’. An observation is thus the result of processing the observation data in a way that concisely describes the environment in the vicinity of the agent.

In the physical space, an observation may be represented by a matrix or vector that provides spatial information derived from observation data. The observation data may be an image or point cloud data of the surroundings of the agent, for example.

In the logical space, an observation may be represented by a matrix or vector that provides spatial information in the vicinity of the agent. The observation data from which this observation is derived may be a collection of pixels or points from the logical space around the agent. For example, the observation data could be a matrix of pixels that are within an observable threshold distance away from the agent.

The agent may make a plurality of different observations at different locations in the space. The agent moves between these locations to make the observations. The vector between two observations is defined as ‘a displacement’, which has both a magnitude and direction. Thus, the agent moves between two particular locations where observations are made by travelling along the displacement between the two particular locations.

Each of the observations and displacements made by the agent within the space may be stored in a memory associated with the agent. If the agent makes a series or sequence of observations and displacements in the space, the series or sequence may be stored together as a set of observations and displacements. The sequence of observations and displacements may be used to generate a map of the space. The map may include both observations and displacements, one of observations or displacements, or a characteristic associated with an observation and/or displacement, such as an action vector or similarity measure, as will be explained later.

The sequence of observations and displacements may form an ‘identity’. An identity may be descriptive of a particular feature or attribute of the space in which it was found. The terms attribute and feature are used interchangeably henceforth.

For example, in a physical space, an identity may be descriptive of an attribute such as a particular object or a path to a particular destination within the space. The observations in the set that form the identity indicate how the space is perceived by the agent and thus how the particular feature is perceived. For example, if there is a particular object such as a chair in the space, the identity of the chair may include several observations taken from different locations of portions or aspects of the chair. Similarly, if there is a particular destination in the space, the identity may include several observations taken from locations on a path to the destination. The displacements in the set that form the identity indicate how the agent moves between the locations of the observations. For example, a first observation of a chair in the space may be made from a position near a rear leg of the chair. A second observation of the chair in the space may be made from a position near a front leg of the chair. A first displacement of the identity is then a displacement required to move from the position near the rear leg of the chair to the position near the front leg of the chair.

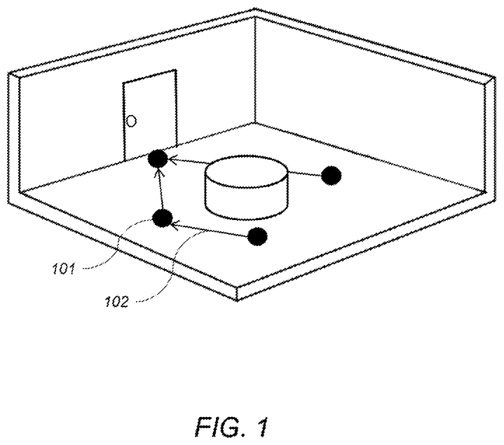

An example identity is illustrated in FIG. 1. FIG. 1 shows a series of observations 101 connected by a series of displacements 102 in an exemplary room space comprising a door and a central obstacle. This exemplary room space may be a physical space, such as an apartment in the real world. The observations 101 may be captured using a camera on a robot. The displacements 102 may be made by moving the robot. In this example, the identity represents a path to the door, which may be considered to be a destination. Each of the observations 101 provide data descriptive of the environment from the location at which the observation is made.

Although the displacements are illustrated as being one-directional in FIG. 1, it is to be understood that a corresponding set of negative displacements may also be recorded such that the identity comprises the observations 101, and a set of displacements 102 and negative displacements linking the observations.

The attribute of the space of the identity as illustrated in FIG. 1 may be the destination, such as the door. This identity can thus be used for the purposes of navigating in the room, around the central obstacle, and to the door.

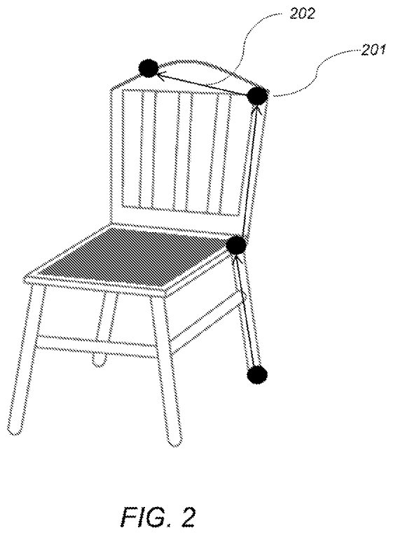

A second example of an identity is illustrated in FIG. 2. FIG. 2 shows a series of observations 201 connected together by a series of displacements 202 on a chair. The chair may be three-dimensional in a physical space such as the real-world, or may be two dimensional in a logical space, such as in an image. As with FIG. 1, the displacements 202 may also include opposite negative displacements.

A camera may be responsible for capturing the observations 201 and performing the displacements 202 to obtain the identity as seen in FIG. 2, for example, in the physical space. In the logical space, this may be performed by a virtual agent.

In the case of a camera in the physical space, the camera may or may not be in a fixed position. If in a non-fixed position with respect to the space, the camera may move within the space. For example, the camera may be attached to a robot. In this case, the agent may be the robot (or camera), and observation data is recorded at the location of the agent simply by recording an image or images of the surroundings of the robot or camera. If in a fixed position, the camera may rotate or zoom or the like so as to focus on different parts of the chair. In this case, the aim and focus of the camera, (i.e., the direction of gaze) in terms of the visual field of view of the camera may represent the agent. In this case, the agent may thus be defined as a centre point or projection of another certain pixel in the field of view of the camera, for example. The camera does not move in a translational manner, but the agent ‘moves’ when the camera is zoomed or rotated, because such actions modify the position of the centre point or certain pixel in the field of view of the camera with respect to the scene/image being observed. The location of the agent thus does not have to correspond to the location of the camera. When fixed, the camera may not displace between the observations to obtain the displacements 202. Instead, the displacements may be made and stored as the distance between two fixed points in the field of view of the camera across two observations. The displacements can be performed by rotating the camera to ‘move’ the agent, by moving the centre point of the field of view of the camera.

For example, the camera may first capture an image centred on the chair leg. This image is then processed into a first observation. The location of the agent is deemed to be the centre point of the field of view of the camera with respect to the first image. The camera may then pan upwards by rotating, and capture and process a second image, of the back rest of the chair. The second observation is thus processed from the image of the back rest. The location of the agent for this second observation is deemed to be the centre point of the field of view of the camera with respect to the second image, and the displacement between the first observation and the second observation is the distance, in pixels and/or relating to the size of the rotation, between the centre point of the field of view with respect to the first image and the centre point of the field of view with respect to the second image. This may be estimated using visual inertial odometry, for example.

When the camera is not fixed, the agent is the camera itself (or the device to which the camera is attached). In this example, the camera/device moves to a location, makes an observation at that location, and then performs a displacement. The displacements are recorded, using odometry for example, as will be understood.

In the case of a logical space, FIG. 2 may represent an image of a chair. In this example, the entire image is stored, so no observability problem exists and it is possible to observe the entire image at once. However, to improve computational efficiency, logical space is treated in the same way as physical space, in that the entire image is not dealt with at once and instead, smaller observations of portions of the image are made. In particular, a portion of the image plane is observed, for example, a portion including the chair leg. The size of the portion may be fixed or may be dependent on the size of the image. As with the fixed camera example in the physical space, the location of the agent is deemed to be a particular point in the portion of the image, for example, a particular pixel such as the central pixel of an image portion.

The ‘agent’ or virtual agent in this case, may then perform a displacement by ‘moving’ by a number of pixels across the image plane, before making a second observation. In reality, this involves merely acquiring a second portion of the image plane from memory, whereby the second portion is centred around the new location of the agent (the pixel the virtual agent has ‘moved’ to). Thus, in the logical space, the agent is a tool for selecting different portions of an image based on a fixed point in the image. Moving the virtual agent includes translating from the pixel at which the virtual agent was previously located to a different pixel.

When referring to an ‘agent’ it should therefore be understood that an agent can be three things. Firstly, an agent can be a physical device that can move, such that the agent physically moves to a location in physical space to make an observation at the location of the device. In this case, the agent performs displacements between observations by moving the physical device, and observation data corresponds to data captured by the agent at its present location. Secondly, the agent can be a projection of a physical device that is fixed. In this case, observations are made in different orientations of the fixed physical device, and the agent is a projection of a point in the field of view of the physical device related to the orientation of the physical device. For example, the agent is located at a centre point of a field of view of the fixed physical device. Displacements in this case are measured based on the distances between projections of the point in the field of view of the physical device caused by changes in orientation of the physical device. Thirdly, the agent may be a virtual agent, in a logical space. In this case, the agent is located at a point or pixel in the logical space. The point or pixel designates a portion of the space around it which is corresponds to observation data. For example, the agent may be located at a central pixel of a portion of space corresponding to observation data for an observation. Displacements are measured as the distances between pixels or points in the logical space.

Thus, when referring to an agent and particularly to the ‘location of the agent’ in the foregoing description, it is noted that any of the above definitions of an ‘agent’ may apply. The location of the agent is not required to be the location of a physical device. Similarly, when referring to an agent performing an action, such as moving, or making an observation, the above definitions apply, such that a physical device is not required to move, and an observation may be made by a physical device or computing device that is not necessarily the agent itself.

Returning to FIG. 2, the attribute of the space defined by identity formed by the series of displacements 202 and observations 201 may be an identification of the feature, which in this case, is the chair.

Thus, FIGS. 1 and 2 show that identities can be formed in both physical and logical space, in two or three dimensions, and for the purpose of identifying objects, such as a three-dimensional chair, identifying images or features of images, such as a two-dimensional chair, or for the purpose of navigating a three-dimensional space to reach a destination. It is to be understood that there are other uses for identities and object/image recognition and navigation are merely examples.

Several identities such as those in FIGS. 1 and 2 may be stored in a set of stored observations and displacements from previous experiences of one or more spaces. It is not necessary for the identities to be labelled, meaning in the above examples, it is not necessary that the identity corresponding to the chair is labelled as a chair or is even known to correspond to a chair. Rather, once the set of observations and displacements are stored as an identity, the agent is able to use this information to locate and identify matches to the identity in other areas of the space or in other spaces entirely. It is not necessary for the system or method to understand the real-world feature to which the identity relates.

In some examples described below, an identity may be labelled according to the feature or attribute of the space that it represents. In the above example, the identity corresponding to the chair may thus be labelled as a chair. The process of labelling identities within the set of stored observations and displacements may be performed as part of a general training process, wherein the training process is performed according to existing techniques as will be understood by the skilled person. For example, various machine-learning techniques may be used, including supervised and unsupervised learning processes, the use of neural networks, classifiers, and the like.

For example, the stored set of observations and displacements may be acquired from test spaces, such as test images, which include or show one or more known features. For example, a test image or images of a chair may be presented to the agent such that the identity formed from the image or images and stored in the set of stored observations and displacements is known to correspond to a chair and is labelled as such. The process of acquiring the set of stored observations is set out in more detail later.

Using a set of observations and displacements to effectively describe a feature of a space, rather than an entirety of a map or image of the space is computationally efficient, since the observations and displacements only include respective portions of the feature and thus require less memory and computation to identify it in a part of a space. In addition, the observations and displacements can be computed by using different data, such as a vector encoded from the output of a set of spatial filters applied to the visual data for observations, and the local temporal correlation of low level features in the case of displacements. This removes a common failure mode and thus enables the two parts of the system (the observations and the displacements) to compensate for weaknesses in the other, providing diversity. In the application area of 3D spatial SLAM the system also performs not just localisation and mapping, but additionally navigation and path planning intrinsically, removing the need for additional components to be added to achieve a full implementation in the real world.

Compared with standard SLAM, the methods and systems set out here are more robust to environmental factors and occlusions. The methods and systems set out here also have the advantage of storing the minimum set of measurements required to navigate and observe a particular space. Observations are made in a space according to the complexity and/or changes within a space, such that the methods and systems are adapted to perform optimally in any space. For example, in a wide-open field or area of little information and features, fewer observations will be made and stored when compared to a feature-rich environment. As the method does not involve the tracking of features or objects that subtend a small part of the visual field, but instead entirely uses the properties of a majority of the full sphere of solid angle, occlusions or changes to parts of the visual scene have less impact on the ability of the system to complete a task, when compared to traditional systems and approaches.

A destination in a space, such as a store or landmark, may be navigated to from a first known or previously visited location in the world from a stored set of observations and displacements linking the starting point to the destination. Additionally, the destination in a space may be navigated to from an unknown area in the world or an unknown starting point from the set of observations and displacements.

Identifying an attribute of a space in this way relies on making comparisons between the stored set of observations and displacements and current observations and displacements made in the particular space. The following part of the description sets this process out in more detail. In this following part of the description, stored observations and displacements are referred to as predicted observations and displacements, and target observations and displacements. It is to be understood that these terms define the same technical features, and are different simply to give context as to why or when they are being used. Similarly, current observations from the space are referred to as first, second and transitional observations. Again, these terms define the same technical feature, which is an observation made by the agent in the space in which the agent is residing, but are labelled differently to provide context as to why or when they are being made or used. The same terminology is applied to displacements.

A method in which this process of identifying/determining an attribute of a space is performed, using existing knowledge in the form of a stored set of observations and displacements, is explained in detail below with reference to FIG. 1. A benefit of this method is that only portions of the space are required, in terms of current observations and displacements, to identify the attribute.

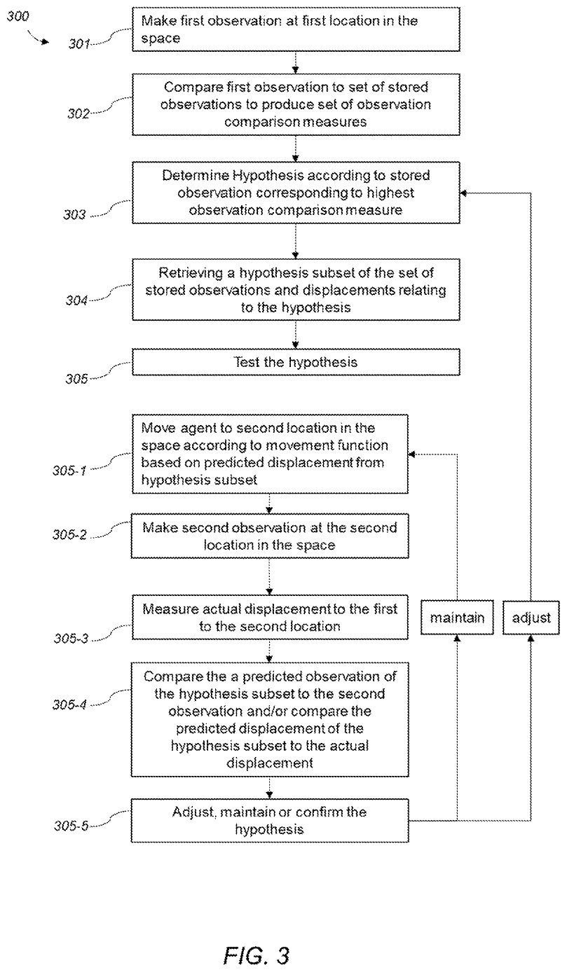

FIG. 3 shows a flow diagram of a method 300 of determining an attribute of a space in which an agent can explore or move, according to various examples.

In the initial conditions of the method 300, an agent is in a space, and is able to observe a portion of the space through a sensor, virtual sensor or the like. The space may be previously explored by the agent or entirely unknown to the agent. The starting position may be known to the agent, or may be entirely unknown to the agent.

In a first step 301, the agent makes an observation from its current location in the space of the agent in the space. The observation may be considered to be a current or first observation from a current or first location, although it is to be understood that it is not required that this observation is the very first observation in the space. Rather, ‘first’ is used here simply to disambiguate the current observation from later observations.

The first observation includes data descriptive of a first portion of the space in the local vicinity of the agent. For example, where the agent is a robot or vehicle, the first observation may be made using sensor data from a sensor such as a camera, radar, LIDAR or the like, wherein the sensor data is indicative of a view of the world from the robot's current location. The local vicinity of the agent is the local vicinity of the robot's current location. In a physical space, the extent of the local vicinity is determined by constraints of the sensor and the environment of the robot. For example, the sensor may have a limited range, such that data for the observation sensor data is only acquired for the environment of the space within that range. Similarly, the environment of the robot may include one or more features that limit the observable surroundings, such as a wall or other obstruction that occludes the field of view of the sensor. The vicinity of the agent is thus not fixed, but may have a maximum distance from the location of the agent based on the constraints of the sensor. In logical space, the local vicinity of the agent is a portion around the location of the agent, and is smaller than the entirety of the space. Since the entire space may be stored, for example, if the space is an image, it is not necessary to obtain data from a sensor to make an observation. Rather, the portion of the space around the location of the agent is retrieved from the stored entire space. This ‘virtual sensor’ simulates the same effect as using a sensor in the physical space, wherein the observation only considers a portion of the entire space rather than the whole. The vicinity of the agent in the logical space may therefore be set based on a distance from the location of the agent. In the example where the space is an image, and the agent is located at a pixel in the image, the vicinity may be set by a number of pixels away from the pixel of the agent, for example.

Once the first observation has been made in the first step 301, it is compared in a second step 302 to stored observations from a set of stored observations and displacements.

The comparison between the first observations and the stored observations produces an observation comparison measure, indicative of how similar each of the stored observations are to the first observation. The observation comparison measures for each stored observation are ranked; the highest observation comparison measure is identified, and the stored observation it corresponds to is retrieved. In this way, the stored observation that is most similar to the first observation is determined and selected. The process of comparing observations is set out in more detail later.

In a third step 303, a hypothesis is determined, relating to the stored observation that is most similar to the first observation. In particular, the stored set of observations and displacements include one or more identities, which form subsets of the stored set of observations and displacements. Each subset includes one or more observations and one or more displacements that are each associated with a particular attribute or feature to which the identity relates. In the third step 303, the attribute or feature to which the selected stored observation is associated, is determined. This attribute forms the basis of the hypothesis, which is effectively a prediction of what the agent is observing in the space. The prediction could be a two dimensional or three dimensional object or image, or a destination that can be navigated to, for example.

The stored set of observations and displacements may include several subsets of observations and displacements, wherein each subset is associated with a particular attribute, and thus a particular hypothesis. In an example, there is a subset related to the attribute ‘chair’, a subset related to the attribute ‘table’ and a subset related to the attribute ‘door’. The comparison in the second step 302 is performed with respect to all of the observations in the stored set of observations and displacements and may result in the observation comparison measure being highest or strongest for a particular observation, wherein the particular observation is part of the subset related to the attribute ‘door’. In the third step 303 the hypothesis thus becomes that the first observation is part of a door, or in other words, the attribute of the space that the agent has observed is a door in the space. The subset of stored observations and displacements relating to the attribute is referred to as a hypothesis subset.

In a fourth step 304, the observations and displacements of the hypothesis subset are retrieved. In particular, the stored observation that is most similar to the first observation is part of a hypothesis subset of stored observations and displacements as explained above. Furthermore, the observations and the displacements in the hypothesis subset are linked, such that they form a network of observations separated by displacements. The linkage between the observations and displacements in the hypothesis subset is stored in the set of stored observations and displacements, such that the network arrangement is preserved in memory. When retrieving the hypothesis subset of observations and displacements, the method includes retrieving an observation and a displacement that are connected to the stored observation that is most similar to the first observation. In other words, the neighbouring observation and the displacement required to reach it from the stored observation that is most similar to the first observation are retrieved from the hypothesis subset. This observation and the displacement become the predicted observation and predicted displacement, whereby, if the agent moves from its current location by the predicted displacement, it is expected, according to the hypothesis, that the agent will arrive at a location in the space where it can observe the predicted observation.

It is to be understood that the terms ‘predicted observation’ and ‘predicted displacement’ simply refer to the subset of observations and displacements related to the determined hypothesis. Each of these observations and displacements are predicted, according to the hypothesis, to be present in the space the agent currently occupies.

In a fifth step 305, the hypothesis is tested. To test the hypothesis, the agent is sequentially moved along the network of stored observations and displacements that form the hypothesis subset, or in other words, the predicted observations and predicted displacements. At each iteration in this sequential process of moving the agent along the network, the agent is configured to repeatedly perform new observations, compare the new observations to the predicted observations, and/or compare the predicted displacements to actual displacements, and determine whether to maintain the hypothesis, reject the hypothesis, or confirm the hypothesis. This hypothesis testing is explained below in more detail with reference to steps 305-1 to 305-5.

In a first step 305-1 of the hypothesis testing process, the agent moves from its current location, where it made the first observation, to a second location in the space based on a movement function. The movement function is dependent on a predicted displacement of the hypothesis subset. In particular, the movement function is dependent on the predicted displacement that is connected to the stored observation that is most similar to the first observation, identified from the linked network of observations and displacements that forms the subset. The second location is thus unknown to the agent until it has performed movement based on the movement function.

In a second step 305-2 of the hypothesis testing process, the agent makes a second observation from the second location of the agent in the space, wherein the second observation includes data descriptive of a second portion of the space in the local vicinity of the second location. For example, where the agent is a robot or vehicle, the second observation may be made in the same way as the first observation, using sensor data from a sensor such as a camera, radar, LIDAR or the like, wherein the sensor data is processed to become an observation indicative of a view of the world from the robot's position at the second location.

In a third step 305-3 of the hypothesis testing process, an actual displacement from the first location of the agent to the second location is determined. In physical space, the actual displacement may be estimated using odometry, for example. In logical space, the actual displacement may be measured according to known techniques, using vector or matrix calculations. For example, if the logical space is an image, the number of pixels between the first location and the second location may be determined as the distance. In a physical space, displacements are measured using an odometry system comprising visual inertial odometry combined with motoric odometry such as wheel odometry where applicable. The system provides interfaces for the input of visual inertial odometry and motoric odometry. Displacements indicate a physical or logical distance between pairs of observations. Odometry is stored in a coordinate system that is referenced to the rotation of a starting observation (the predicted observation that is most similar to the first observation). Additional data can be stored characterising other aspects of the displacement, such as, but not limited to, vibrations encountered transitioning the displacement or energy expended transitioning the displacement. displacement similarity is measured by the end-point error between pairs of displacements, where the displacements commence at the same location and the end-point error is the physical or logical Euclidean distance between the points located by transitioning along the two displacements.

In a fourth step 305-4 of the hypothesis testing process, a comparison is performed. The comparison compares observations, displacements, or both. The second observation may be compared to a predicted observation from the hypothesis subset, and in particular to the predicted observation linked to the predicted displacement on which the movement function was based. The comparison between the second observation and the predicted observation provides an observation comparison measure. Similarly, the predicted displacement on which the movement function was based when the agent moved from the first location to the second location in the space may be compared to the actual displacement between the first and second location, to obtain a displacement comparison measure. Thus, comparisons can be made to generate both an observation comparison measure and a displacement comparison measure. It is advantageous to use both of these measures, as will be set out in detail later. It is to be understood that the ordering of the above steps, after the moving of the agent, is interchangeable.

In a fifth step 305-5 of the hypothesis testing process, the hypothesis is adjusted, maintained, or confirmed based on the observation comparison measure and/or the displacement comparison measure from the fourth step of the hypothesis testing process 305-4.

In this step, the observation comparison measure and/or the displacement comparison measure are assessed to effectively determine whether the agent's perception of the space it occupies, in terms of the second observation and the actual displacement, match that of the attribute according to the hypothesis, in terms of the predicted observation and predicted displacement. The observation comparison measure and the displacement comparison measure are explained in more detail later, but generally, the stronger these measures are, the more likely that the hypothesis is correct and the agent is in fact observing the attribute according to the hypothesis, in the space it currently resides.

The observation and/or displacement comparison measure may be compared to one or more respective thresholds to determine whether to confirm, maintain, or reject the hypothesis.

Adjusting the hypothesis includes rejecting the hypothesis. This occurs when it is determined that the space being observed by the agent is unlikely to include or represent the attribute according to the hypothesis. This conclusion may be met in several different ways. Firstly, the hypothesis may be rejected when the observation and/or displacement comparison measure falls below a first observation threshold level and/or a first displacement threshold level. The first observation threshold level and the first displacement threshold level may be set globally as a minimum likeliness required to maintain the hypothesis and for the agent to test the hypothesis further. Alternatively, these thresholds may be adaptive and changeable based on environmental conditions of the space such as a brightness/darkness factor, for example. In particular, the lighting in the space may affect the observation comparison measure if the observations made by the agent are made at a different environmental brightness level to the brightness level at which the subset of stored observations relating to the hypothesis were captured and stored. The thresholds may also be adapted based on colour, contrast, and other image/sensor data properties.

Furthermore, different observation comparison measures may be used that address different additional aspects of the space, and when used in combination permit identification of specific dimensions of difference to the hypothesis. For example, changes in lighting affect a vector comparison measure more than they affect a measure of the spatial distribution of filtered elements around the agent location. Colour changes to an object will affect the colour filtered elements of an observation more than the luminance and orientation filtered elements. Consideration of a variety of observation comparison measures allows the nature of the dissimilarity to be observed. In the case of lighting condition changes, the use of a measure of the spatial distribution of filtered elements of the observation around the agent location can be used to adapt the thresholds, such that a strong match for that measure can be used to update the hypothesis prior and thus reduce the acceptance criteria (a second observation threshold level) for the ‘similarity’ observation comparison measure. The different types of observation comparison measures discussed here each come from a different method of comparing observations. This is explained in more detail later.

The first observation threshold level may be set according to the initial ranking of the observation comparison measures, for each stored observation, against the first observation made by the agent. In particular, the first observation threshold level may be set equal to the next-highest ranked observation comparison measure that corresponds to a stored observation of the stored set of observations and displacements that is not in the subset relating to the current hypothesis. This particular stored observation thus relates to a different hypothesis. In this way, the first observation threshold level is set according to the similarity of the first observation to a stored observation relating to a different hypothesis to the one currently being tested. This effectively allows the agent to consider a different hypothesis to the one being tested if the tested hypothesis produces a weaker observation comparison measure than originally found for the different hypothesis. The hypothesis being tested can thus be rejected and ultimately replaced with the different hypothesis that is associated with the first observation threshold level.

Ultimately, adjusting the hypothesis includes rejecting the current hypothesis and replacing it with a different hypothesis. This may involve the method returning to the second step 302 as illustrated in FIG. 3 and selecting next-best observation comparison measure in the ranked observation comparison measures to determine the next-best observation and the hypothesis to which it relates. The agent may also return, via an opposite displacement to the actual displacement made, to the location of the first observation in the space before selecting a new hypothesis. The replacement of the hypothesis is explained in more detail later.

Maintaining the hypothesis occurs when the hypothesis is neither adjusted nor confirmed. The hypothesis is thus maintained when the observation and/or displacement comparison measure matches or exceeds the first observation threshold level and/or the first displacement threshold level respectively. This means that the hypothesis does not require adjusting. According to the example introduced above, wherein the first observation threshold level is set according to the ‘next-highest observation comparison measure’, this means that the current hypothesis still provides the highest observation comparison measure with respect to the predicted observation out of any of the subsets of the stored set of observations and displacements, meaning the attribute according to the current hypothesis is still the most likely attribute to be found in the space in which the agent resides. Another condition that results in the hypothesis being maintained is that a hypothesis confirmation condition is not met. The hypothesis confirmation condition may be a second, higher observation threshold level and/or second, higher displacement threshold level. The hypothesis confirmation condition is indicative of a minimum confidence level that the hypothesis is correct and that the attribute of the space is the attribute according to the hypothesis.

In other words, the hypothesis is maintained when it is determined that the observation and/or displacement comparison measure with respect to the predicted observation and the predicted displacement matches or exceeds the first observation threshold level and/or the first displacement threshold level respectively, but does not match or exceed the second observation threshold level and/or the first displacement threshold level respectively.

When the hypothesis is maintained, a next predicted observation and a next predicted displacement, linking the current predicted observation to the next predicted observation, are retrieved from the subset of stored observations and displacements relating to the hypothesis. The process of testing the hypothesis as set out above then repeats as shown in FIG. 3 with respect to the next predicted observation and the next predicted displacement. In this way, the method 300 involves a sequential testing of a hypothesis subset of predicted observations and displacements until the hypothesis is either confirmed or adjusted.

At each observation the agent makes, for which the hypothesis is maintained, a historical observation and/or displacement comparison measure is updated, and the historical observation and/or displacement measure is then factored into future observation and/or displacement comparisons. The historical observation and/or displacement measure is stored in memory and acts to increase future observation and/or displacement comparison measures based on the number of consecutive times a hypothesis has been maintained. This effectively increases the confidence that the hypothesis can be confirmed, on the basis that the hypothesis has not been rejected for a plurality of consecutive observations and displacements. It also helps to prevent the agent from becoming stuck in a local minimum whereby the hypothesis is never rejected or confirmed. This process of utilising historical observations and/or displacement measure data may include a single hypothesis sequential probability ratio test against the null hypothesis (that the data do not match the identity) or as a multi-hypothesis sequential probability ratio test between alternative hypotheses including the null (that none of the hypotheses match).

Confirming the hypothesis comprises determining that the hypothesis confirmation condition is met and determining the attribute of the space based on the meeting of the hypothesis confirmation condition. As noted above, the hypothesis confirmation condition may be a second, higher observation threshold level and/or second, higher displacement threshold level which the observation comparison measure and/or displacement comparison measure must match or exceed.

Like the first observation threshold level, the second observation threshold level may be modified or adapted based on lighting conditions in the space, using the brightness/darkness factor.

When the hypothesis is confirmed, the method 300 may stop, as the agent identifies the attribute of the space. The identity of the attribute may be stored to memory, and the observations and displacements that were performed by the agent to identify the attribute may be stored in the memory and linked to the space in which the agent resides.

The method 300 advantageously uses observations and displacements to determine the attribute of the space, without having to consider the entirety of the space as a whole. This presents a much more computationally efficient method of parsing space. The method 300 is an example of how a space may be traversed. However, it is not necessary that both observations and displacements are used for navigating a space. In some embodiments, the use of displacements is optional and observations are primarily used.

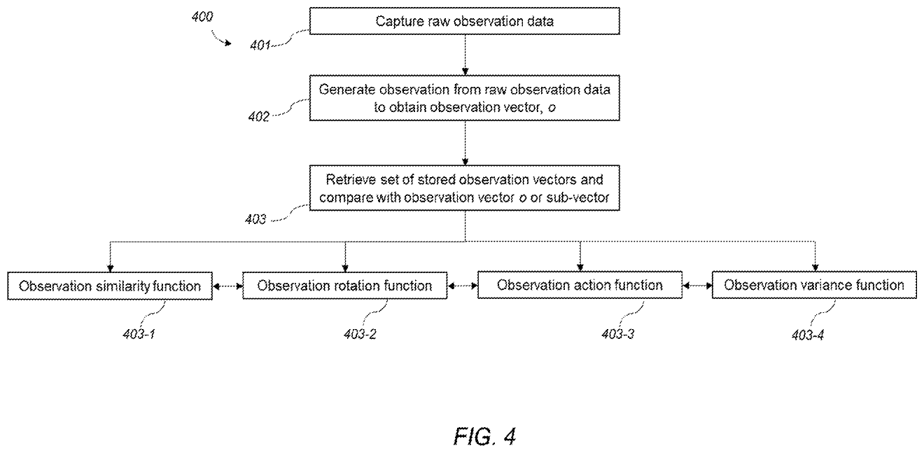

A method 400 of making and comparing an observation will be explained with reference to FIG. 4. Comparing observations is used in navigating the space, and may be performed without using displacements. Making and comparing observations occurs in the method 300 in at least two points. Firstly, in the first and second steps 301 and 302, wherein the agent makes an observation and compares it to the set of stored observations to ultimately determine a hypothesis, and secondly during the fifth step 105 when the hypothesis is tested. This process thus requires a minimum of two observations and two comparisons. However, it is to be understood that more observations can be performed, and that is it advantageous to make observations sequentially, not only in the two instances above, but also in transition between the first and second location, whilst the agent is moving from the location of the first observation to the location of the second. These transitional observations are discussed in more detail later. The process of making and comparing observations is described here.

In a first step 401, observation sensor data is captured. In the physical space, the observation data is input data that is captured using a sensor, such as a camera. In this example, the observation data is a captured image. The captured image and its content depend on the orientation of the camera. In particular, the camera may be at the same position, for example, attached to a robot at the same position in the world. However, if the orientation of the robot is modified, the content of the observation data may change even though the position of the robot has not changed.

For this reason, it is advantageous to make observations in physical space using a camera system or other sensor capable of capturing a triaxially stabilised cylindrical projection of three dimensional space, oriented with the main axis of the cylinder perpendicular to the direction of gravity. Fixing with respect to gravity in this manner allows observations to be made with the same roll and pitch (since these can also be fixed according to the gravity direction). The capture resolution of the image may be 256 columns by 64 rows of pixels, for example, but equally could be any resolution. This 256×64 pixel image represents input data for the observation that is then manipulated in a second step 402. In a non-physical or logical space, the observation data may be data taken from the logical space from around the location of the agent. The entirety of the logical space may be pre-stored. The observation data may be sourced from a portion within a predetermined distance of the location of the agent in the logical space. For example, where the logical space is an image or map, the observation data may be the pixels or points that are contained within a pixel/point distance of 5, 10, 50, 100, or any number of pixels from the location of the agent.

In the second step 402, the observation is generated from the input data captured by the sensor, virtual sensor, or retrieved from memory. The input data is encoded through a pipeline of stages into a set of vector/matrix representations.

The process of generating an observation to be stored, to form part of the stored set of observations and displacements, is very similar to the process of generating a current observation from input data for comparing to a stored observation. However, when making a current observation to compare with, the relative orientation between the agent in its current position and the orientation of the agent when it made the stored observation may not be the same, and may not be easily distinguished. To solve this problem, when making a current observation from input data, the process includes making observations for each possible permutation of the orientation of the agent. In reality, this means that a current observation is associated with a plurality of rotations, whereby each rotation represents the input data shifted or adjusted to represent a different orientation of the agent. How this affects the process in comparison to making a‘stored’ observation is referenced below.

The general process of generating an observation (current or stored) includes the following steps.

Firstly, low level features are extracted from input data. This may include the use of one or more filters and/or masks, for example, to pre-process the input data. The low-level features may be edges, colours, shapes or the like. The pre-processing may also include colour conversions and the like to provide a plurality of channels of the input data. The result of this first step is processed data, potentially including several channels.

Secondly, the resolution of the input data is reduced, using filters or the like, by extracting or deleting parts of the input data, such as rows of pixels, and/or by summing and averaging data over large areas of the input data.

Thirdly, further processing may be performed with one or more kernels to convolve the input data to obtain a useful result, for example, to identify regions of interest, edges, regions of greatest change and the like. If there are several channels this process is performed over all of the channels.

Fourthly, the resulting data forms a vector or matrix of processed and reduced input data. This is then concatenated across dimensions (columns, rows and channels) and normalised, to produce an observation vector o.

As noted above, when storing an observation, for the purposes of storing the set of observations, for an identity or map for example, only one observation vector o is required. When making a current observation for comparison purposes, this general process is performed for a number of rotation permutations of the input data. Where the resolution of the data is X×Y, this may mean including X permutations, each representing a shift of X+1 from a previous permutation. This results in X observation vectors for a current observation, each of which can then be compared to the one stored observation.

This encoding of input data to form one or more observation vectors o uses a computer device such as a Central Processing Unit (CPU), Graphical Processing Unit (GPU), Field-Programmable Gate Array (FPGA) or application-specific integrated circuit (ASIC), for example.

A detailed example of this process is provided below, for the above example of an image captured from a camera, wherein the image is a cylindrical projection. In this example, the resolution of the image is 256×64 pixels, so, for a current observation, there are 256 possible rotations of the projection, whereby the columns are rotated (shifted) from their originally captured position. As noted above, these rotations represent the different permutations of the original observation data. It is to be understood that there could be any number of permutations based on the input resolution of the image. The detailed process is as follows.

At a first stage, for each pixel, a colour conversion process may be performed, whereby colour channel data from the captured image is converted. For example, a red, green, and blue-channel data is converted into red, green and luma channels, where luma is ⅓(red+green+blue). It is to be understood that these colours and conversions are exemplary, and that the image may have different colour channels and may be converted into different colour channels.

At as second stage, the luma channel result of the first stage is convolved with a filter using a convolution kernel [1,−1;1,−1;1,−1] or similar vertical edge filter, for example a Sobel or other filter to create a luma vertical (luma_v) channel.

At a third stage, the luma channel result of the first stage is also convolved with a filter using a convolution kernel [1,1,1;−1,−1,−1] or similar horizontal edge filter, for example a Sobel or other filter to create a luma horizontal (luma_h) channel.

This processing results in a new image that contains pixels for four channels: red, green, luma_h and luma_v. It is to be understood that other choices of pixel filter could be used here, and for the set of filters chosen, all subpixels from all channels, (red, green, luma_h or luma_v) are passed into the next following pipeline of processing.

At a fourth stage, a series of box filters are computed and centred on a set number of evenly-spaced rows of the image for each channel, wrapping around the rows. It is to be understood that there may be more or fewer filters and the size of 19×19 is exemplary. The box filters smooth the image for each channel. Each pixel of each channel is modified by the box filter from the summation of pixels contained within each box filter, this provides a smoothed (or blurred) image. The box filters may overlap with each other.

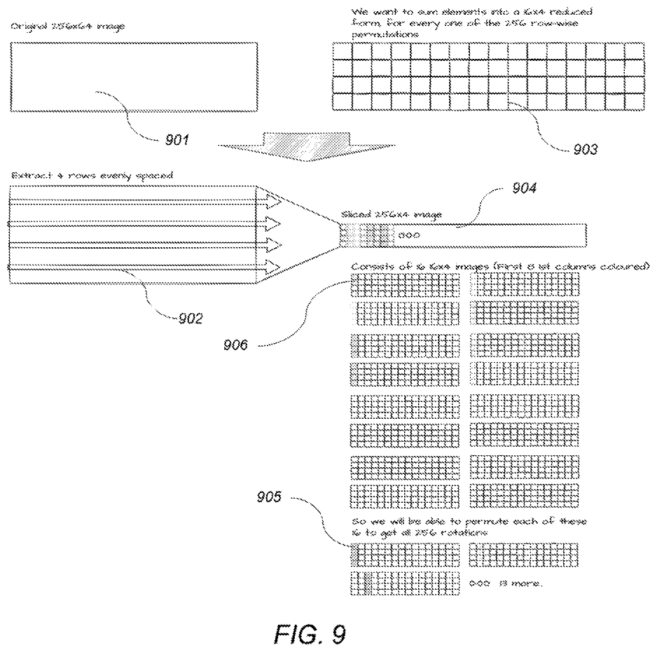

At a fifth stage, the blurred image is reduced to form a sliced image. In particular, the resolution of the blurred image is significantly reduced. This process is shown in FIG. 9. In particular, four evenly spaced rows 902 are extracted from a blurred Image (not shown) processed from an original image 901 (or other observation dataset), to produce the sliced image 904.

The sliced image thus includes 256 columns and 4 rows, in FIG. 9.

At a sixth stage, the columns of the sliced image formed from the fifth stage are separated into sets of evenly spaced columns. In an example, the 256 columns are separated into 256 sets, each set including images of 16 columns by 4 rows, where each has a different first column from the full set of 256 columns. As can be seen from FIG. 9, there are 16 sets of 16 (total 256 permutations) of the 16×4 images, whereby columns are shown in different colours to illustrate how data is divided from the 256-column sliced image 904 into the 16×16×16×4 sets. These sets represent every possible rotation position of the input data (by increments of a one column rotation for all possible 256 rotations. It is to be understood that FIG. 9 is an illustrative example and more or fewer rows, columns and permutations are possible, meaning there may be more or fewer than 256 possible rotations.

When an observation is to be stored to memory, to form part of the set of stored observations and displacements, it is only necessary to store one of the 16×4 images of a set formed in the fifth stage. For example, the first permutation 906 of the first set may be selected to be stored as an observation. It is only necessary to consider the rotations, (and thus the 256 possible permutations of a 16×4 image) when making an observation to compare with a previously stored observation. Thus, considering permutations is only required for current observations. When comparing, it is still not necessary to store each permutation of the 16×4 images to memory. Rather, each permutation is iteratively compared against a stored 16×4 observation vector to identify the best match, indicated by one or more observation comparison measures. Storing the permutations is not necessary. Comparing observations is explained in more detail later.

Returning to the detailed example of making an observation, at a seventh stage, the 16×4 image is convolved cyclically with an on-centre, off-surround (or the inverse) kernel. For example, where the element with a value of 1 is the kernel centre. For the first row the kernel may be: [−⅕,1,−⅕,−⅕,−⅕,−⅕], for the second and third rows it is [−⅛,−⅛,−⅛,−⅛,1,−⅛,−⅛,−⅛,−⅛,], and for the fourth row [−⅕,−⅕,−⅕,−⅕,1,−⅕], for example. An example of this is shown in FIG. 10, which shows an on-centre, off surround horizontally wrapping filter 1001 to 1003 for a 16×4 image. This kernel identifies the areas of greatest change in the image. As noted above, when storing an observation, this is only required for one 16×4 image. When making a current observation for comparing to the stored observation, this is done for each of the separated sets, (i.e., the 16×16 sets from the sixth stage).

Following this pipeline, a 16×4×4 image is produced, or in the case of comparison, 256 rotations of a 16×4×4 image. There are 16 columns, 4 rows, and 4 channels. The channels of the 16×4 image may be subdivided into two data subsets, one consisting of red and green, the other luma_h and luma_v. Each of these data subsets are normalised via vector normalisation such that the elements of each describe values on a set of orthogonal values, and the result is a unit vector. These normalised vectors are then concatenated into a single unit vector by scaling each by the square root of two. This provides, the Observation vector, o. This Observation vector in this example is concatenated from 16 columns, 4 rows and 4 channels to give a 256 element vector that is then stored. If being compared, 256 permutations of the vector o are compared against one stored vector.

As well as the observation vector o, the final vector can store additional data related to the Location of the Observation, such as, but not limited to, a user-defined label, the angular Locations and identities of objects, the data from additional sensory modalities such as, but not limited to, auditory or odour information, the passability of different directions in physical or logical space and the directions that have previously been explored.

The observation vector o is a coarse representation of the original observation data captured by the sensor, that provides a statistical summarisation of the environment in the vicinity of the agent in the physical or logical space. The coarseness of the vector in comparison to the original data allows the method to run more efficiently. Also, the observation data is filtered at high resolution to create the different channels prior to the coarsening process. Coarsening is also advantageous as it provides a representation of a location that is less sensitive to changes in the lighting or objects in the environment than the state-of-the-art, as information is integrated over large parts of the visual field.

It is to be understood that the observation vector o may be a vector or a matrix. The vector o may comprise a number of sub regions, each corresponding to a part of the whole vector. The sub-regions may be content/colour sub-regions split based on the channels used to form the vector (in an example, red, green, luma_h and luma_v), or may be spatial sub-regions corresponding to different directions around the agent. The sub-regions may be represented by sub-vectors, whereby the combination of sub-vectors together form the whole observation vector o. As noted, vectors representing rotation permutations are required when comparing observations, when a current observation is made and is required to be compared against a stored observation, it is not necessary to store all permutations.

It is to be understood that the numbers given above in terms of dimensions, filter and kernel sizes, row selections and rotations permutations can be more or fewer than the example values.

Returning to FIG. 4, in a third step 403, a current observation vector o is compared to stored observations from the stored set of observations. In other words, a current observation is compared to a target observation.

Observations may be compared using several functions. The comparison of the observations provides the observation comparison measure. The observation comparison measure may differ depending on the function used to compare the observations. In some examples, more than one observation comparison measure may be produced by comparing observations using more than one comparison functions. These comparison functions can be used alone or in combination in the method 300 for testing a hypothesis, and for other related methods such as map traversal as is explained later. Environmental features such as a scene brightness level may affect one observation comparison measure but not another. Thus, using a combination of the observation comparison functions and the resultant observation comparison measures allows the method 300 to be performed more accurately in a range of environmental conditions.

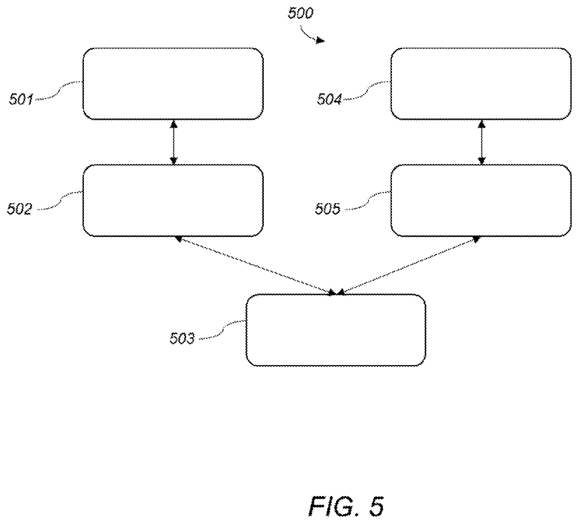

Functions for comparing observations include an observation similarity function 403-1, an observation rotation function 403-2, an observation action function 403-3 and an observation variance function 403-4. As illustrated in FIG. 4, any one or more of these functions can be performed with respect to a current observation and a stored target observation. The initial conditions and system required for each method of comparing observations are thus the same. This system is schematically shown in FIG. 5.

FIG. 5 shows a schematic functional diagram of a system or apparatus 500 including various modules involved in the comparison of observations. These modules may be implemented by a computer, computing device, or computer system. It is to be understood that the function of these modules may be separated into further modules and may be separated across components, or their function may be performed by one device or component. A first module of the device or system is a memory module 501. The memory module 501 stores the set of stored observations and displacements. These observations and displacements may be stored as vectors. The set of observations and displacements, with one or more hypotheses subsets, may be stored in a cyclic or acyclic graph and/or directed graph. Alternatively, the observations and displacements may be stored with metadata identifying the displacements and observations to which they are respectively connected, or may be organised in a look-up table or the like, which preserves the links between respective observations and displacements.

The memory module 501 is connected or otherwise capable of communicating with a stored observation processing module 502. The stored observation processing module 502 is configured to select the stored observation from the memory module 501 which is to be compared. The stored observation processing module 502 may also select one or more masks for the purpose of reducing the stored observation to a portion of the stored observation, for input to the comparison functions. The masks may include an observation mask, a user/system-selected mask, or a combination thereof. The masks mask certain regions of the selected stored observation vector whilst preserving other regions, known as regions of interest (ROI). The mask may be a binary mask, masking/preserving through values of 0s and 1s, or vice versa.

The stored observation processing module 502 is connected or otherwise capable of communicating with a comparison engine 503 that performs the comparison according to one or more of the comparison functions 403-1, 403-2, 403-3 and 403-4.

On a second side of the system or device, a sensor module 504 is provided. The sensor module 504 includes a sensor capable of deducing spatial information from its environment, and may thus include a camera, LIDAR sensor, tactile sensor or the like. The sensor module 504 also includes any necessary control circuitry and memory for recording sensor data. The sensor module 504 is configured to capture current observation data.

The sensor module 504 is connected with or is otherwise capable of communicating with a current observation processing module 505. The current observation processing module 505 processes the sensor data from the sensor module 504 to obtain a current observation, such as a current observation vector. This includes the total rotations possible for the sensor data according to the process set out above with respect to FIGS. 9 and 10. The current observation processing module 505 may also select a mask for masking the current observation vector.

The current observation processing module 505 is connected or otherwise capable of communicating with the comparison engine 503 that performs the comparison according to one or more of the methods of comparison 403-1, 403-2, 403-3 and 403-4.

The comparison engine 503 is configured to acquire or receive the stored observation from the stored observation processing module 502, and the current observation from the current observation processing module 505, and the respective masks, for the purposes of performing a comparison observation according to any of the methods of comparison 403-1, 403-2, 403-3 and 403-4. The comparison engine 503 may be implemented by a computing device, a server, a distributed computing system, or the like.

The system 500 further includes a movement module (not shown) configured to move the agent within the space. In the physical space, this could be a motor, engine or the like, configured to translate the agent by physically moving the position of the agent and/or by changing the orientation of the agent. In the logical space, the movement module may be implemented by a computer or the like.

Whilst the comparison methods are set out separately below, it is to be understood that they may be performed concurrently, or in the same overall process performed by the comparison engine 503. These methods can be performed in the same overall process because they each rely on the same fundamental data points and operations. In particular, each of the following methods compares the current observation with a stored target (predicted) observation. When the observations are represented by vectors for example, each method does this by taking the inner product between the vectors or sub-vectors thereof. The methods of comparison differ in additional pre/post-processing steps as set out below.

In the first method 403-1, observations are compared based on a similarity function, to obtain a first observation comparison measure component. The first observation comparison measure component is the ‘similarity’ observation comparison measure discussed above. This similarity function requires that the vectors of the observations to be compared are vector normalised. The similarity function includes calculating the vector inner product of the observation vectors to be compared. The inner product comprises the cosine of the angle between the two vectors. The similarity function thus returns a single value or score indicative of the similarity between the two vectors corresponding to the observations being compared. When the current observation includes a number of possible rotations, as is the case in the above example whereby there are 256 possible rotations, the vectors corresponding to each of the rotations are compared to the predicted observation. In this case, the inner product which provides the highest value is stored as the first observation comparison measure component. This single value may be used in the second step 302 of the method 300, for example, to produce the set of ranked observation comparison measures, corresponding to the set of stored observations, from which the stored observation that is most similar to the first observation is determined and selected to determine the hypothesis. In other words, this similarity function may be used to determine the similarity between the first observation and the set of stored observations to identify which of the stored observations is most similar to the first observation, and thus which hypothesis to test.

This similarity function may also be used in a similar way in the fifth step 305 when comparing the second observation and the predicted observation.

When the current observation is associated with a plurality of rotation positions, each corresponding to an observation vector, the similarity function is configured to find the highest inner product between the different observation vectors and the target observation. To do this, the similarity function keeps track of a ‘maximum inner product value’ as it iteratively takes the inner product for each of the rotated observation vectors with respect to the target observation. Once all rotations have been assessed, the maximum inner product value is retrieved as the first observation comparison measure component.

The advantages of using this similarity function are that it is relatively computationally-efficient to run, and the resultant first observation comparison measure component drops off very smoothly as a function of distance from the original observation location, (or from the location of the target observation to which the current observation is compared).

This function may however be affected by environmental conditions such as a brightness or darkness of the environment. For example, if the stored observation relates to observation data that was captured in low level light conditions, and the current observation relates to observation data captured in direct sunlight, the current observation data may be different from the stored observation data, resulting in different vectors, even if the features captured in each observation are spatially the same. In order to negate these effects, the first observation comparison component can be combined or used with a fourth observation comparison component formed from the fourth observation comparison function 403-4 set out below.

In the second observation comparison function, observations are compared using an observation rotation function, to obtain the second observation comparison measure component. This rotation function takes the rotations of a current observation o and compares each of these to a target observation, as above for the similarity function. For example, during the fifth step 305 of the method 300, wherein the hypothesis is tested, the observation rotation function may be used to compare the second observation (current observation) to the predicted observation (target observation). In the above example, there are 256 rotations, corresponding to the 256 different possible column positions from the original cylindrical observation data. Whilst the similarity function is configured to retrieve the inner product indicative of the best match between the rotated observation vectors and the target observation, the observation rotation function is configured to identify what specific rotation is responsible for this best match. The observation rotation function outputs the rotation direction of this best match as an offset value, which corresponds to the index of the rotation position of the observation. For example, the best match between the observation vector o and the predicted observation may be the 120^{th} of the 256 possible rotations. This corresponds to the vector formed from the observation data when it is rotated such that the 120^{th} column of the 256 is at the centre of the data, or at any other predefined rotation position. The rotation observation function may thus output an offset value corresponding to the index of the 120^{th} rotation position, which may be 120 for example.

In a physical space, when an inertial measurement unit (IMU) is used as part of or included in the sensor, for example, the offset value is indicative of how much yaw (roll and pitch can be fixed because of gravity) has drifted since the target observation was originally made (assuming that the stored observation that forms the target observation has been visited previously in the current space). Thus, the offset value of the observation rotation function provides an output that is indicative of IMU yaw drift. This IMU yaw drift can be discerned from the output and used to update the set of stored observations and displacements, as each of these are all relative to the original yaw in which they were made and stored. Thus, if there is a level of confidence from the first observation comparison measure component and/or the second observation comparison component, that indicates the current observation is the target observation, the offset value can be used to adjust the set of stored observations and displacements accordingly.

If the physical space in which the agent resides is not the same space from which the stored observation was captured, then the offset value is indicative of how the space in which the agent resides is oriented in comparison to the space in which the stored observation was captured.

In summary therefore, the second observation comparison measure component, produced by the observation rotation function, provides an offset result indicative of the strongest similarity between the target observation and a plurality or rotations of the current observation (e.g., 256 rotations). In addition, the index of the rotation indicative of the strongest similarity indicates the alignment between the current orientation of the agent (i.e., the x and y axes as they are currently understood by the agent) and the orientation of the target observation when it was made and stored. The offset can thus recover orientation information, such that target (predicted) observations and displacements can be remapped accordingly.

This rotation function may be used when comparing the first observation to the set of stored observations in the second step 302 of the method 300, and may also be used in the fifth step 305 when comparing the second observation and the predicted observation, to re-calculate predicted displacements and observations based on the relative orientation (frame of reference) of the agent.

The observation similarity function 403-1 and the observation rotation function 403-2 described above can be performed in the same process or independently. An example single process in which these functions can be performed together is set out below, in the form of example pseudo-code for running both the observation similarity function 403-1 and the observation rotation function 403-2. The pseudo code is as follows:
combined_function(cam_observation [16×4×4×256], cam_mask [16×4×4×256], memory_observation [16×4×4], memory_mask [16×4×4], user_mask [16×4×4])
   Initialise max_similarity to −1
   Initialise offset to 0
   For each of 256 rotations:
   Initialise cam_sum, mem_sum, match_sum to zero
   Combine cam_mask, memory_mask and user_mask using a logical binary OR (If 0 use element, if 1 do not)
   For each vector element of the 16×4×4 (256 total):
   If mask is 0:
   Add square of the element from cam_observation to cam_sum
   Add square of the element from memory_observation to mem_sum
   Add product of elements from cam_observation and memory_observation to match_sum
   else:
   Do nothing
   Renormalise by dividing match_sum by the product of the square roots of cam_sum and mem_sum
   This is the curr_similarity score for this rotation
   If similarity score greater than the max_similiarity:
   Set max_similarity to curr_similarity
   Set offset to rotation index
   else:
   Do nothing
   After all rotations are considered, max_similarity is the output similarity, the first observation comparison measure component
   After all rotations are considered offset is the output rotation, the second observation comparison measure component.

In the above pseudocode, ‘cam’ refers to the sensor, for example a camera, and thus the current observation. Similarly, ‘mem’ and ‘memory’ refers to the memory and thus the stored target observation to be compared.

The cam, memory and user masks function to include and/or disregard certain parts of the current and target observation vectors in the comparison functions. The cam and memory masks comprise information regarding the reliability of the information from parts of the visual scene that are in the observation vectors. For the memory mask, this refers to a single observation vector, and for the cam mask this refers to the set of observation vectors for the different rotations of the visual field. This can be used, for example, to exclude parts of a camera image where excessive contrast has led to saturated input data, where the data is of low quality. The user mask comprises information provided either by a function internal to the system that seeks to select a subset of the full observation vector elements, or an external function to perform the same. This can be used, for example, to determine the observation match for certain input features, or for different parts of the visual scene encoded into the observation.

The user mask is configured to remove outlier/erroneous data from the observation data.

The above pseudocode iterates for each of the possible rotations of the current observation to identify a maximum normalised similarity measure over all rotations (the first observation comparison measure component) and the rotation offset to which this maximum corresponds (the second observation comparison measure component).

In the above first and second observation comparison functions 403-1 and 403-2, and in the third comparison observation 403-3 explained below, the observation vector o may be created from an image of a physical space. The image has the property that the x axis is angle around the agent, and the y axis is some property perpendicular to the x axis, either distance radially, or elevation vertically. In the examples provided above, the vector comprises 4 channels with subpixels (which are red, green, luma_h and luma_v). There may be more or fewer channels, which make the observation vector larger or smaller. Furthermore, the image, and each channel thereof, comprise a series of rows and columns that provide spatial information of a portion of the space in which the agent resides.

The observation vector o may thus be relatively large, with spatial information in multiple directions and colour/edginess information from different channels. This relatively large vector may be manipulated or sliced to make a range of different comparisons. For example, if only the edge channels luma_h and luma_v are used, the comparison is less affected by colour variations. If only the green channel is used, changes in the distribution of, for example, plants can be determined. If all the channels are used, but only for a spatial sub-region of the input image, then only the corresponding part of the visual world will be compared. This enables partial comparisons to see how well certain parts/features of the world match.

To perform the slicing of the observation vector o, one or more masks are used. Each mask is a vector of the same number of elements as the observation vector o, which is configured to mask certain regions of the observation vector o whilst preserving other regions. For example, a binary mask of 0s and 1s may be used for such purposes. When there are 256 elements in the observation vector o, the mask comprises 256 elements, where a value of 1 indicates that the corresponding index from the observation vector o should be included/disregarded in a subset of the observation vector o to be compared, whilst a value of 0 in the mask indicates the corresponding element of the vector o should not be included/disregarded in the subset of the observation vector. The mask may additionally be used to filter areas of erroneous data as set out above.

In the third method of comparing observations, an observation action function 403-3 is used to obtain a third observation comparison measure component. The observation action function may be used to compare observations, and may also be used as part of the movement function to move the agent to the second location, whilst testing the hypothesis according to the fifth step 305 of the method 300. The observation action function may also be used to create an action vector field, which effectively maps the estimated directions in a space towards the estimated location of a particular target observation.

The observation action function relies on the same basic principles as the observation similarity function and the observation rotation function. The observation action function differs from the two previous functions in that a plurality of sub-regions of the observation vector o are evaluated, and an offset determined for each sub-region. Thus, instead of the entire observation vector o, a subset of the observation vector corresponding to a spatial sub-region is evaluated with the observation action function, from which it is possible to obtain an offset value for each sub-region corresponding to a subset of the vector relative to the target observation. To obtain the relevant sub-region, a mask is used. Each sub-region may overlap with one or more neighbouring sub-regions.

The use of sub-regions for this purpose originates from the concept that, as the agent moves away or towards the location of a predicted observation, not all parts of the visual field will change equally. This is distinct from classical triangulation as it considers not the movement of an identified object or signal source, but the distortion of the entire visual scene. As such, it is robust to occlusions of parts of the visual scene, making it more tolerant of environmental changes. Additionally, it does not require metric calculations to function, making it more robust to measurement noise. This property can be used to understand both how far the agent is from the location of the target observation, but also allows for a further vector to be calculated for the purposes of moving to that location. This further vector, calculated by the observation action function, uses the same principles as the observation similarity function, except the inner product is obtained for N spatial sub-regions, and these are compared to corresponding sub regions of the target observation. For example, where N=8, 8 spatial sub-regions have half the x axis extent of the full field of view of the whole observation vector o and are each centred on a different direction. In this example, the observation action function is thus effectively the observation similarity function combined with the observation rotation function, performed 8 times, once for each sub-region, to find 8 similarities and 8 offsets. The 8 similarities and 8 offsets are effectively the same as the first observation comparison measure component and the second observation comparison measure component respectively, except only in respect of a specific sub-region of the observation vector o.

In terms of the actual comparison that is performed therefore, the stored target observation vector is split into N sub-regions, and for each of the N sub-regions, corresponding sub-regions of the current observation vector are compared for all possible rotation permutations to identify which permutation is most similar to the stored target sub-region. The particular permutation that is most similar has an index, for example, the 120^{th} rotation, which is used to identify the offset. An offset is calculated for each sub-region of the stored observation vector and these offsets are used to obtain a movement vector required to reach the position of the target observation, and the similarities are used to evaluate confidence in the movement vector and to weight it when this movement vector is used in the movement function as explained later. The overall output of the observation action function 403-3, and the third observation comparison measure component, is thus this movement vector.

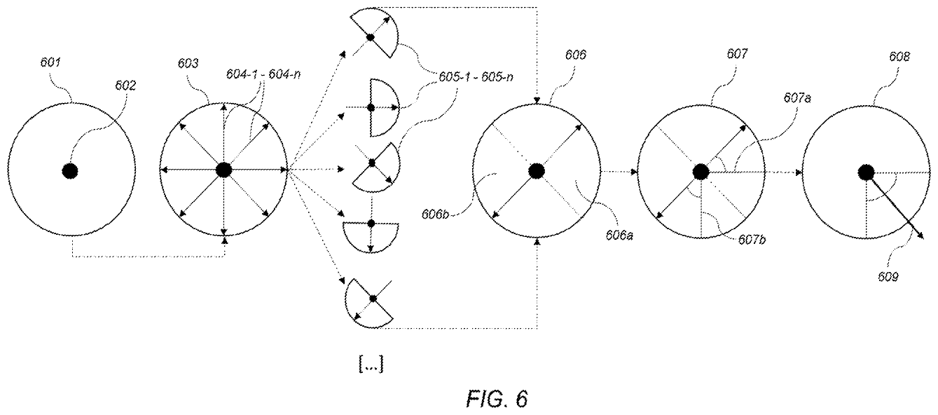

FIG. 6 shows a schematic diagram of observation data corresponding to the sub-regions of the observation vector that are produced for the purposes of performing the observation action function. FIG. 6 also shows the process that the sub-regions are subject to in the observation action function (with respect to the observation data for visualisation purposes).

As shown in FIG. 6, observation data is represented by a two-dimensional circle 601 of spatial data around the agent 602. It is to be understood that this is a representative example, and the observation data could be in three-dimensions, such as in a cylinder. The observation action function processes the observation vector o in a comparison with a target observation. According to the observation action function, a plurality of sub-vectors of the observation vector are processed, wherein each sub-vector is focused or centred on a different direction. In FIG. 6, these directions are illustrated as a plurality of directions 604-1 to 604-n in the corresponding observation data 603. In FIG. 6, there are 8 directions and 8 sub-regions. However, it is to be understood that there may be more or fewer directions selected for the process of creating subregions.

Each of the eight directions correspond to eight sub-regions 605-1 to 605-n of the observation data (not all shown). These sub-regions correspond to parts of the visual field (or sensor field if not a camera), each part being centred on one of the eight directions. The specific direction associated with the sub-region is referred to as a sub-region direction.

In the observation action function, as explained in more detail below, pairs of sub-regions 605-1 to 605-n are compared against corresponding portions of a stored observation. This is illustrated in the observation data 606, comprising the comparison of a first sub-region 606a and a second sub-region 606b with corresponding portions of the target observation (not shown).

The observation action function computes the offset between each sub region 606a and 606b and the corresponding portions of the target observation. This produces a pair of offsets 607a and 607b as shown in the observation data 607. From these offsets 607a and 607b, a resultant offset vector 609 is determined as shown in the observation data 608. The sub regions 606a and 606b used in this process are different sub-regions, and may be opposing sub-regions although this is not necessary.

The observation action function 403-3 will now be described in more detail, with reference to sub-regions of the observation data and the corresponding sub vectors of the observation vector as explained above and illustrated in FIG. 6.

As noted above, the observation action function uses the set of masked sub-vectors, each of which are a subset of the stored observation vector o and correspond to a contiguous sub-region of the visual field. The sub-regions of the stored observation vector are compared to corresponding sub-regions of a current observation vector arranged around the agent at equal angles. Following the previous example, the sub-regions of the stored vector may cover a set of contiguous columns in a stored 16×4 observation vector. An even number of overlapping sub-regions are extracted, where there are N pairs of sub-regions, and where the central column of each sub-region projects into the real world with an opposing vector as illustrated in FIG. 6. FIG. 6 includes 8 sub-regions. These opposing sub-regions are matched to the 256 rotations of the current observation, and the rotation where the best match occurs is extracted using the observation rotation function 403-2. In particular, an offset is determined for each opposing sub-region, corresponding to the rotation index of the best match between the sub-vector corresponding to the sub region and the rotated stored observation. The differences in the directions of the offset of opposing pairs of sub-sets of the observation vector are compared. This provides a vector indicating the direction and magnitude of the displacement required to get to the stored observation (which, in FIG. 6, is along the resultant offset vector 609 perpendicular to the line connecting the centres of the two opposing sub-regions 606a and 606b). This direction and magnitude is towards the location where the target Observation being compared was captured. A weighted average of the resultant offset vectors 609 from all the opposing sub-regions provides a single action vector that indicates a direction that moves closer to the location of the target Observation being compared from the location of the current observation. This vector is rotated from the stored observation rotation to the current observation rotation using the second observation comparison measure component, or another rotation measure, to align the direction of movement to the current world frame of the agent. It should be understood that an alternative implementation can be performed where the sub-regions are evaluated in the current observation world frame, whereupon no such rotation need be made, however this is more computationally intensive as the sub-region mask must be evaluated for each of the current observation rotations, and is less accurate as evaluating exact sub-regions in the stored observation is not possible.

The observation action function 403-3 can thus be considered to be a process that includes repeated use of the observation similarity function 403-1 and the observation rotation function 403-2 to obtain a vector in the direction of the location of the target observation. The observation action function 403-3, the observation rotation function 403-2 and the observation similarity function 403-1 described above can thus be performed in the same process, by the same comparison engine 503, or independently.

An example process for performing the observation action function 403-3 with the comparison engine 503 is provided below in the form of example pseudo-code:

### Action_function:

For the current observation vector:
Generate a mask to select a spatial sub-region of the observation by:
Given an observation: observation[16×4×4] where the first two dimensions are spatial (X,Y) and the third is different channels
For the spatial elements for each sub pixel:
Select a cyclically contiguous subset of the columns in the spatial elements, note that cyclically contiguous is such that for a 16 column dimension columns 2, 3, 4 and columns 15, 0, 1, 2 would represent contiguous subset examples, while 1, 3, 4 would not as it missed the intervening column 2. These subsets should have the same width, for example 8 columns, and should be evenly spaced across the columns: for example for 4 subsets of width 8 columns indices 0, 4, 8, 12 would comprise an example of even spacing when referring to the first, last or other determined column within each subset;
The determined subset is applied as a user_mask, where the elements in each column in the subset are set to 0 (they are used) and the elements of columns outside are 1 (not used);
For each subregion:
do combined_function (as above)
The max_similarity and offset is stored for the subregion
Given a set of max_similarity and offset where, for each of the subregions, there is a single max_similarity and offset:
For pairs of the offsets where the sub-regions correspond to opposing directions in the agent field of view (e.g. for 8 sub-regions this would be pairs comprising indices 0 and 4, 1 and 5, 2 and 6, 3 and 7) calculate the cyclical distance between the offsets first and second indices in the pair, minus 128. This corresponds to the angle between the offsets, and how the two sub-regions have moved across the field of view. The direction perpendicular to the sub-region direction pairs is the action direction. The offset difference is used to calculate the action magnitude. The action directions and magnitudes for all the pairs are vector averaged to form the final action function output—the action vector.
The action magnitude is that of the resultant of the vectors described by the offsets (where the second offset is incremented by 128, thus corresponding to a PI radian rotation).

Therefore, in the observation action function, opposing pairs of the N offsets are taken (N=8), and each pair represents a direction described by the perpendicular to the direction of the opposing offset's mask centres. This direction is combined with a magnitude calculated from the difference between the two offsets, such that if the offsets are both zero, (i.e. the centres of the sub-regions of the current observation vector are the same as the sub-regions of the stored observation), then the magnitude is zero. If the difference between the first and second of the offsets cyclically, such that if the first offset is 200 and second one is 10 (with 256 rotations) then the difference is −66, but if the first is 10 and the second 200 it is +190. This difference can then be converted into an angle and used to calculate the exact magnitude, or simply scaled down by a factor of, for example, 16, to provide a coarse magnitude for the purposes of the action vector. This can then be used in the movement function to relocalise the agent to a predicted observation, by rotating using the second comparison measure and combining as a vector average with the action vectors for all pairs. Vectors can be excluded from the average based on quality measures, such as a minimum similarity score of the sub-regions. It is understood that, as there is redundancy in the vectors produced by the pairs, this allows parts of the visual scene where there is high environmental difference to be weighted lower in comparison to those where there is low environmental difference.

In the fourth method of comparing observations, an observation variance function 403-4 is used to determine a fourth observation comparison measure component. The observation variance function uses similar properties to the similarity function and the action function. The observation variance function 403-4 includes calculating the circular variance or the circular standard deviation of offsets of sub regions around the agent. Effectively, this observation variance function identifies some measure of the spread of offsets on a circle around the agent.

The observation variance function 403-4 uses the same sub-regions of the stored vector as used for the observation action function 403-3, to determine offsets in the same way with respect to a rotation permutation of a sub-region of the current observation vector. For example, consider there are 8 sub regions providing 8 offsets. Because the 8 offsets describe how different parts of the field of view move differently as the agent moves towards/away from the location of the target observation, when the agent is at the target observation location they should all be identical and equal to the offset of the full vector match. As the agent moves away, they diverge and spread. By using a circular statistic, as in the observation variance function 403-4, it is possible to measure this spread, and it increases with distance from the observation location. The circular statistic, which may be circular variance of the eight offsets or circular standard deviation, provides a scalar value that forms the fourth observation comparison measure component. The circular statistic may be any measure of circular dispersion.

To perform the observation variance function 403-4, the observation action function 403-3 is initially performed, but to obtain N offsets. From this point, the cyclical circular variance of the offsets is calculated, after first converting from the offset index range (0->255) to a suitable angular range (e.g. radians (0->2*PI). From this point, any sub-region offsets that are more than a given angle from the circular mean angle (e.g. PI/2 radians) are identified, and the circular variance is recalculated excluding these sub-regions, as long as more than a given number of sub-regions remain (e.g. 4).

The observation variance function 403-4 is another way of determining a similarity between a current and stored observation. Unlike the observation similarity function 403-1, the observation action function is extremely robust to lighting environmental changes, because it relies on offsets of sub-regions rather than the entire observation vector. However it tends to have discontinuities as the sub-vectors used have lower dimensionality than the full observation vector o, and at larger distances can generate erroneous matches, which greatly affect the comparison. For this reason the observation similarity function and the first observation comparison measure component provided by the observation similarity function is a better at-distance measure of similarity.

The circular variance function 403-4 can be used to measure similarity in the same way as the similarity observation function 403-1, as it provides a scalar output indicative of similarity. Furthermore, the circular variance function 403-4 can be used to determine an environment adjustment factor that can then be used to weight or modify other comparison measure components, such as the first observation comparison measure component from the similarity function 403-1. In particular, if there is a high degree of confidence from another observation comparison function, such as the observation action function 403-3, that the agent is at the target observation, the circular variance function 403-4 should, in a perfect space, provide a high measure of similarity since each of the offsets between the stored vector and the current observation vector should be 0. Thus, the output of other functions can be weighted based on the deviation provided by the fourth observation comparison measure component of the circular variance function 403-4. When for example, the similarity function 403-1 is combined with the circular variance function 403-4, this means that the first observation comparison measure component from the similarity function 403-1 can be modified according to the fourth observation comparison measure component from the circular variance function 403-4, to reduce and quantify the effects of environmental conditions.

It is to be understood that, although examples are provided above for the observation comparison functions 403-1, 403-2, 403-3, and 403-4, including numerical examples, the functions may be performed with any choice of number of sub-regions, masks, channels, rotations, and array size.

The observation comparison measure may include any one or more of the first, second, third and fourth observation comparison measure components resultant from the observation similarity function, the observation rotation function, the observation action function and the observation variance function respectively. The observation comparison measure is produced each time an observation is compared, such as in the second step 302 of the method 300, when a first observation is compared with the set of stored observations, in the fourth step 305-4 of the hypothesis test, when a predicted observation is compared with a second observation, and when transitional observations are compared with the predicted observation, which will be explained in detail later.

It is to be understood that the observation similarity function, the observation rotation function, the observation action function and the observation variance function described above are examples of functions that may be used to compare a current observation to a target observation. Other functions or adaptations of the above functions may also be used. Generally, such functions are used for comparing observations to determine: how much a current observation looks like a stored observation, what the rotation/orientation of the current observation is in comparison to the stored observation; and when the agent is not at a location of the stored observation, what direction is the location of the stored observation from the current observation. These characteristics can be mapped with respect to a stored or target observation as will be explained later.

When navigating a map using observations or displacements, the movement of the agent is carried out according to a movement function. In particular, the movement function may depend on the predicted displacement required to reach the location of the predicted observation intended to be compared. Thus, the correct predicted displacement must be selected from the hypothesis subset, which may include a plurality of predicted displacements. In order to ensure that the correct predicted displacement is selected for the movement function, the predicted displacements and the predicted observations stored in the hypothesis subset are linked to each other, as explained previously, in a network of predicted observations connected by the predicted displacements. The linking of observations to one or more displacements in this network may be stored and preserved in any suitable way. For example, the stored set of observations and displacements, which include the hypothesis subset, may be stored in a cyclic or acyclic graph or directed graph. Alternatively, the observations and displacements may be stored with metadata identifying the displacements and observations to which they are respectively connected, or may be organised in a look-up table which preserves the links between respective observations and displacements.

As discussed with respect to FIG. 3, the determination of the hypothesis is based on the stored observation that is most similar to the first observation made by the agent. The predicted displacement selected for the purposes of the movement function is thus the displacement that is linked in the stored set of observations and displacements to the most similar observation to the first observation.

Once the predicted displacement from the hypothesis subset, which is expected to lead from the most similar observation to a next predicted observation of the hypothesis subset, is identified, the movement function is updated such that the movement is based on the particular predicted displacement.

It is to be understood that the predicted displacement has both a magnitude and direction.

The movement function may comprise one or more movement components. A first movement component of the movement function is dependent on the predicted displacement. In particular, the first movement component is a contribution to the movement function that decreases as the agent moves according to the predicted displacement. The first movement component is thus effectively weighted based on a magnitude of the predicted displacement. At the location of the first observation, the magnitude of the predicted displacement is relatively large, so the first movement component is correspondingly more strongly weighted. As the agent begins to move according to the movement function, the magnitude of the predicted displacement is updated based on an actual displacement the agent has already travelled. Thus, the magnitude of the predicted displacements decreases as the agent moves towards the end of the predicted displacement, and the first movement component is weighted such that it gradually becomes weaker. In an example, the first movement component is a function of the predicted displacement given as: predicted displacement-displacement travelled. The displacement travelled is the actual displacement, estimated using odometry, visual inertial odometry or the like. In this example, the weighting discussed above may simply be the factor provided by the subtraction of the distance travelled. As more distance is travelled, the first movement component reduces from an initial value equal to the predicted displacement. In other words, this can be considered as an ‘unravelling’ of the predicted displacement as the agent travels along the predicted displacement. The value of the first movement component at any given time is thus a function of a ‘displacement remaining’ of the predicted displacement. This provides a first value which is contributed to the movement function. It is to be understood that this first value may be scaled according to a scaling factor, such that the contribution of the first movement component to the movement function is suitable in view of any additional movement components.

The contribution of the predicted displacement to the movement function tends to zero as the agent approaches the end of the predicted displacement. In one example, when the actual displacement measured is equal to the predicted displacement, such that the entirety of the predicted displacement has been travelled, the first movement component based on the predicted displacement goes to zero such that it ceases to contribute to the movement function of the agent. When the first movement component is the only movement component of the movement function, such that the movement function only depends on the predicted displacement, then the position of the agent once the predicted displacement has been travelled becomes the second location, where the second observation is recorded.

Alternatively, the first movement component may cease to contribute to the movement function before the entirety of the predicted displacement has been travelled. In particular, the movement function may be configured to disregard the first movement component when the magnitude of the first movement component, or in other words, the distance remaining of the predicted displacement, is within a displacement-threshold-distance from the end of the predicted displacement. This is advantageous because it reduces the effects of drift on the movement of the agent. In particular, estimation of the actual displacement using odometry is subject to drift related error, such that it is possible the estimate of the actual displacement (actual distance travelled) is less than the true value. Thus, it is possible that the agent may have already travelled the entirety of the predicted displacement even though the estimated actual displacement is less than the predicted displacement. To avoid overshooting the end of the predicted displacement, the first movement component may be stopped before the end of the predicted displacement based on the displacement threshold distance. The displacement threshold distance may be set based on the particular environment or scenario in which the agent is used. In physical space, this may be 5 cm before the end of the predicted displacement, 10 cm, 1 m, 5 m, 10 m or any suitable value depending on the scenario.

A second movement component that may be included in the movement function is dependent on the observation action function described above with respect to observation comparisons. When this second movement component is used on the movement function, it is necessary to continuously, iteratively or sequentially make transitional observations between the first location in the space where the first observation is made and the second location in the space where the second observation is made. In other words, the transitional observations are made as the agent moves away from the first location.

As such, one or more transitional observations are made along the movement path of the agent. Each transitional observation is a type of ‘current’ observation that is compared to the predicted observation to which the predicted displacement is expected to lead, according to the hypothesis. From each comparison, using the observation action function explained above, an action vector is produced, which defines both an expected magnitude and direction towards a location at which the predicted observation may be found. The action vector forms the second movement component of the movement function. As with the first movement component of the movement function, the contribution of the second movement component may be scaled by a scaling factor, and may also be weighted. In particular, the second movement component may be weighted such that the closer the action vector of the second movement component indicates that the agent is to the location of the predicted observation, the stronger the contribution of the second movement component becomes to the movement function. For example, the magnitude of the vector of the second movement component, resultant from the observation action function, is configured to increase as the agent moves closer to the location of the predicted observation. This increase in magnitude may directly provide the weighting that makes the second movement component stronger as the agent approaches the location of the predicted observation.

The second movement component may be used alone as the sole contribution to the movement function, or may be used in combination with the first movement component. Advantageously, if both the first and the second movement components are included, such that both of these components provide contributions to the movement function, the movement of the agent depends on both the predicted displacement and transitional comparisons between the predicted observation and transitional observations. This means that there are two separate sources of data that are used to move to and find the predicted observation in the space. This is more reliable and accurate than using just one set of data, as it effectively provides redundancy. Furthermore, the first movement component and second movement component are advantageously complementary to each other, in that the relative weighting of the first movement component is such that the first movement component weakens in its contribution to the movement function, as the agent approaches the end of the predicted displacement, whilst the relative weighting of the second movement component is such that the second movement component strengthens its contribution to the movement function as it approaches the location of the predicted observation. The first movement component and the second movement component therefore behave in an opposite manner.

If the hypothesis is correct or at least partially correct or similar, such that the attribute relating to the hypothesis is at least similar to the attribute of the space the agent occupies, then the end of the predicted displacement should at least be in close proximity to the location at which the predicted observation is found. As such, having a first movement component dependent on the predicted displacement and a second movement component dependent on the predicted observation aids to move the agent, according to two mechanisms and dimensions, towards the location of the predicted observation.

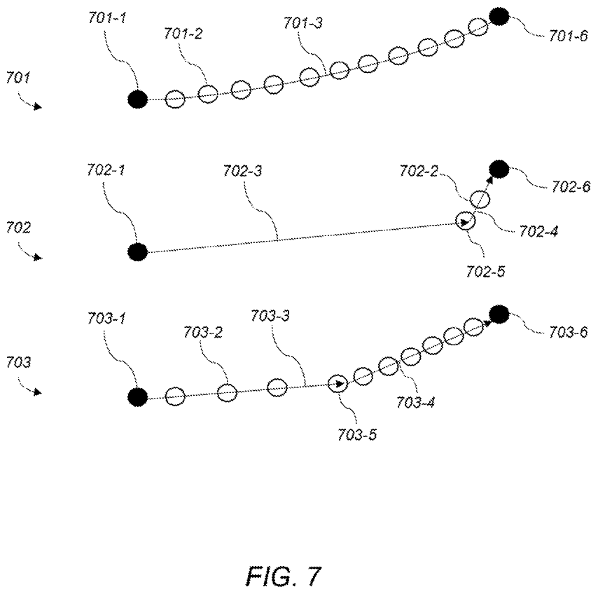

The relationship between the first movement component and the second movement component with respect to their contributions to the movement function of the agent can take any suitable form. Examples of the relationship between these two movement components are now described with respect to FIG. 7, which shows schematic maps of an agent moving between a first location and a second location in space.

In a first example of the relationship between the first movement component and the second movement component of the movement function, as illustrated by the first graph 701, the relationship is simple and depends only on the relative weighting of the first movement component and the second movement component. Since the relative weightings of the first movement component and the second movement component decrease and increase respectively as the agent moves away from the first location 701-1, the first movement component naturally dominates in terms of contribution to the movement function when the agent is nearer the first location 701-1. This is useful because, in general, the observation action function responsible for the second movement component only provides a weak indication of where the predicted observation may be in the space when the agent is at a position that is far from the predicted observation. This is because the transitional observation made for the purposes of the observation action function will generally be very different from the predicted observation, as the distance between the point of capture of these observations will likely be large, and the observations will thus be of different areas of the space. The observation action function depends on a comparison of, and identifying similarities between, observations, and thus is not as reliable when observations appear very different. Therefore, the fact that the first movement component dominates when the agent is closer to the first position 701-1 of the agent is advantageous, as it can use the predicted displacement to travel closer to where the predicted observation should be. This is more reliable than using the second movement component alone.

In the first graph 701, a series of transitional observations 701-2 are made as the agent travels, to regularly, continuously or iteratively update the second movement component and in particular the observation action function responsible for the second movement component. The agent travels a path 701-3 according to the movement function, to a second location 701-6 in the space. As the agent nears the end of the displacement from the first movement component, the second movement component from the observation action function becomes dominant and relocalises the agent to the second location 701-6. It is to be understood that the second location 701-6 is not known to the agent prior to moving, rather, the second location 701-6 represents the identical or best match in the space to the predicted observation (target observation) linked to the predicted displacement. The second location 701-6 is determined by the location at which the second movement component from the observation action function settles at a point in space, such that the magnitude and direction of the observation action function vector indicates that the second location 701-6 is the location of the predicted observation or a best match thereof.

In a second example of the relationship between the first movement component and the second movement component of the movement function, as illustrated by the second graph 702, the relationship is sequential, such that the movement function depends initially only on the first movement component, and upon expiry of the first movement component, depends only on the second movement component. This relationship usefully does not require transitional observations for a large portion of the journey of the agent between a first location 702-1 and a second location 702-6, since the first movement component depends on the predicted displacement and not the predicted observation. According to this relationship, the agent is configured to move from the first location 702-1 via a first path 702-3 corresponding to movement solely according to the first movement component based on the predicted displacement. When the predicted displacement is depleted, such that the agent reaches the end of the predicted displacement, or reaches a predetermined threshold from the end of the displacement, at an intermediary location 702-5, the movement function switches from using the first movement component to using the second movement component. At this point, the agent makes sequential or iterative transitional observations 702-2, and performs the observation action function to obtain the vector of magnitude and direction that points to the location of the predicted observation. Using this information, the agent follows a second path 702-4 to the second location 702-6. Thus, in the second relationship, the agent effectively travels by the first displacement before relocalising using the observation action function.

In a third example of the relationship between the first movement component and the second movement component of the movement function, as illustrated by the third graph 703, the relationship is a winner-takes-all type relationship, such that the movement function depends only on whichever of the first movement component and the second movement component has the highest weighting at any particular time and position in space along a path to the second location. As noted above, the first movement component dependent on the predicted displacement naturally has a higher weighting than the second movement component nearer to a first location 703-1. Thus, the agent travels according to a first path 703-3 based on the first movement component and thus the predicted displacement. During this movement along the first path 703-3, the agent makes a series of transitional observations 703-2 for the purpose of updating the second movement component. The purpose of this is to determine when the second movement component becomes more dominant than the first. The frequency of transitional observations made along the first path 703-3 is not as important when compared to the first relationship as set out in the first graph 701, because the transitional observations 703-2 of the first path 703-3 are only made to compare the first movement component to the second movement component, rather than to direct the agent itself. Increasing the frequency simply increases the precision at which it is determined that the ‘winner’ of the winner-takes-all relationship becomes the second movement component. At a point 703-5 along the path, this determination occurs, when the second movement component is determined to be more dominant than the first. At this point, the second movement component, depending on the observation action function, is used in the movement function to relocalise the agent to the second location 703-6. In this phase, the agent follows a second path 703-4 and makes more transitional observations 703-2 which are needed to obtain the vector from the observation action function to provide a direction and magnitude of travel for the agent to the second location 703-6.

The movement function thus uses two components to relocalise to the location of a predicted observation. The above three relationships between these two components are exemplary, and any suitable method or combination thereof may also be appropriate.

The ability of the movement function to relocalise the agent to the position of the predicted observation relies on the observation action function, which relies on similarities being found between the current observation and the predicted observation. Thus, if the similarity between observations are below a certain level, the action function will not relocalise. In this case, the agent may move according to the first movement component of the movement function, based on the predicted displacement. When it is determined that it is not possible to relocalise the agent due to a lack of similarity between the current observation (transitional observation) and the predicted observation, the hypothesis is rejected, since the predicted observation cannot be found at the end or near the end of the predicted displacement. In this case, the agent is moved back along the predicted displacement in an opposite manner, to arrive back at the location in space of the previous observation where the hypothesis was determined. The hypothesis is then adjusted to a different hypothesis related with a different hypothesis subset of the stored set of observations and displacements.

The movement function thus provides the agent with the capability of moving to a location where: the predicted observation is found; a location of a ‘best match’ to the predicted observation in the space, (if for example, the agent is relocalised to a position that does not provide an exact match with the predicted observation but is still similar); or to a location where the predicted observation is not found. Since the movement function may comprise two components, there may also be differences between the predicted displacement and the actual displacement travelled. For example, the agent may not be required to be relocalised using the second movement component if the best match or identical match of the predicted observation with a transitional observation is at the end of the predicted displacement. Alternatively, the agent may need to be relocalised by a minor further displacement, such that the actual displacement travelled is similar to the predicted displacement. Finally, the second movement component may relocalise the agent by a greater extent in comparison to the predicted displacement, in which case the predicted displacement is not similar to the actual displacement.

These possibilities ultimately provide the method with a way of determining, in two separate dimensions, how similar a set of observations and displacements performed by the agent relate to the attribute of the hypothesis. This ultimately informs the decision of whether the hypothesis is adjusted, maintained or confirmed as set out above. In particular, a first dimension is the similarity between the current observation (or observations where the method 300 is continued or repeated for more than two observations), and the hypothesis subset of stored observations. This similarity is determined by the observation comparison measure(s) and is termed ‘style’. A second dimension is the similarity between the current displacement (or displacements where the method 300 is continued or repeated for more than two displacements), and the hypothesis subset of stored displacements. This similarity is determined by the displacement comparison measure and is termed ‘composition’. The displacement comparison measure is determined by comparing the actual displacement with the predicted displacement.

In general, there are four combinations of style and composition. These are high style and high composition, high style and low composition, low style and high composition, and low style and low composition. Each of these possibilities are explained in more detail below with respect to what they mean for the hypothesis.

Firstly, a high style and high composition indicates that the observations made by the agent are very similar/identical to the predicted observations of the hypothesis subset, and that the actual displacements made by the agent are very similar/identical to the predicted displacements of the hypothesis subset. ‘Very similar’ means that the observation comparison measure and the displacement comparison measure are both above the second, higher observation threshold level and the second, higher displacement threshold level as explained above with respect to the fifth step of the hypothesis test 305-5. When both of these levels are matched or exceeded by the displacement and observation comparison measures, it is determined that the space in which the agent resides includes an attribute that matches the identity as defined by the hypothesis subset. As noted previously, it is not necessary that the identity is labelled, but it may be associated with a label defining the attribute associated with the identity. Confidence that the attribute in the space matches the identity increases if the attribute of the space matches the hypothesis subset for a plurality of consecutive predicted observations and displacements. Thus, the determination that the attribute of the space matches the identity may require a plurality of consecutive predicted observations and displacements to be compared and matched to the sufficient level.

Secondly, a high style and low composition indicates that the observations made by the agent are very similar/identical to the predicted observations of the hypothesis subset, but that the actual displacements made by the agent are not similar/identical to the predicted displacements of the hypothesis subset. ‘Very similar’ means that the observation comparison measure is above the second, higher observation threshold level, but that the displacement comparison measure is not above the second, higher displacement threshold with respect to the fifth step of the hypothesis test 305-5. In terms of the space the agent resides in, this means that the space ‘appears’, in terms of the sensor (observation) data, to be the same or very similar as the attribute defined by the hypothesis subset, but that at least one of the size, location, and/or distances between points of the attribute are not as predicted according to the hypothesis. This relationship is referred to as ‘context’. In the above examples as illustrated in FIGS. 1 and 2, context may be represented by a similar-looking room with similar furniture as that in FIG. 1, but perhaps a larger room or with furniture rearranged (for example, a central feature may be moved to one side). In FIG. 2, context may be found if the chair is imaged from the rear view or if the proportions of the chair are modified (e.g. shorter legs, longer back-rest).

Thirdly, a low style and high composition indicates that the observations made by the agent are not similar/identical to the predicted observations of the hypothesis subset, but that the actual displacements made by the agent are very similar/identical to the predicted displacements of the hypothesis subset. ‘Very similar’ means that the displacement comparison measure is above the second, higher displacement threshold level, but that the observation comparison measure is not above the second, higher observation threshold with respect to the fifth step of the hypothesis test 305-5. In terms of the space the agent resides in, this means that the space appears to have a very similar size, location, and/or distances between points according to the hypothesis, but does not appear to be/look like the same attribute defined by the hypothesis. This relationship is referred to as ‘class’. In the above examples as illustrated in FIGS. 1 and 2, class may be represented by a room of same size and structure, but perhaps of a different colour, with different furnishings. In FIG. 2, class may be found if the chair is coloured differently, or in a different style of detail while retaining the same proportions, such as some types of chairs designed for dining at a table. For navigation this may be different floors of a building, where the floorplan is identical, but different companies may have provided the decor. In order to determine a class relationship between an attribute in the space in which the agent resides and stored observation data, multiple observation comparison measures may be used. While there could be low similarity indicated by the first observation comparison measure component, from the observation similarity function 403-1, the second and/or third observation comparison measure components can be used. If the observation action function provides no convergence to a point, then there is no match and the basis of the comparison is invalid, in which case the hypothesis is rejected.

Finally, a low style and low composition indicates that the observations made by the agent are not similar/identical to the predicted observations of the hypothesis subset, and that the actual displacements made by the agent are not similar/identical to the predicted displacements of the hypothesis subset. In this case, the displacement comparison measure is not above the second, higher displacement threshold level, and the observation comparison measure is not above the second, higher observation threshold with respect to the fifth step of the hypothesis test 305-5. In terms of the space the agent resides in, this means that the space appears not to be related to the structure or appearance of the attribute related to the hypothesis. The hypothesis may be maintained for further comparison or rejected and adjusted as explained previously.

By comparing current observations and displacements against stored observations and displacements, for one or more hypothesis subsets, it is possible to identify characteristics of the space in terms of the two dimensions of composition and style, (structure and appearance). When a space is repeatedly or periodically assessed by an agent, it is also possible to use these dimensions to determine changes in the space. In this scenario, the stored hypothesis subsets may include observations and displacements taken directly from the same space in previous operations by the agent. Using this information the agent can detect what has changed in the space over time, in terms of structure and appearance. Identifying differences can help in path-planning applications, and finding alternative routes, for example. The agent may store a mean displacement to a particular stored observation that is updated each time the agent makes the displacement to the observation. This mean displacement provides a historical average of previous displacements made to a particular observation. Furthermore, the standard deviation of previous displacements made by the agent to the particular observation may also be stored. Using the mean displacement and the standard deviation, statistical analysis may be performed to determine the likelihood that the space has changed. For example, if a new displacement to the observation is significantly different from the mean displacement, and/or is different from the standard deviation of previous displacements, it is determined that there is a high likelihood that the space has changed. This could happen if for example, an attribute of the space has been moved. A historical record may be stored for each observation and displacement, including mean displacements, observations, and standard deviations for performing statistical analysis. This historical record may be updated with each exploration of the agent.

A second historical record may be stored and updated in a similar manner. The second historical record relates to the N most recent observations and displacements made by the agent, as the agent travels to a particular observation, and particularly a similarity or aggregate similarity score between these N most recent observations and displacements and the corresponding stored observations and displacements to which they have been compared. The second historical record thus represents a localisation confidence that indicates how confident the system is that the agent has localised to the stored observations and displacements on its way to a particular observation. If the second historical record indicates that the N most recent observations made by the agent are a very good match to the N most recent stored observations, this gives confidence that the agent is well-localised to the subset or path it is following, in terms of observations and displacements. Should the displacement made to the particular observation, or the particular observation itself, then be significantly different from the corresponding stored observation and displacement, then the second historical record can be used to show and determine with confidence that the space has changed in some respect for that particular observation and displacement. For example, if N=5, the five most recent displacements made by the agent may exactly match the stored displacements. If the 6^{th} displacement made is then different to the 6^{th} stored displacement, the fact that the second historical record indicates a high-level of matching (identical in this case) for the previous 5 displacements, means that it can be easily determined that the space has been changed with respect to the 6^{th} displacement. This could be due to moving an obstacle, a feature of the like.

Furthermore, although as described above, the hypothesis may be confirmed, maintained, or rejected on the basis of observations or displacements separately, it is advantageous to use both observations and displacements, and thus composition and style, in determining the outcome of the hypothesis. By combining the observation comparison measure and the displacement comparison measure to form a two-dimensional similarity measure, adjusting the hypothesis may include adjusting the hypothesis if the two-dimensional similarity measure falls below a first two-dimensional similarity measure threshold level. Maintaining the hypothesis may include maintaining the hypothesis if the two-dimensional similarity measure exceeds the first two-dimensional similarity measure threshold level, but does not exceed a higher second two-dimensional similarity measure threshold level. Confirming the hypothesis may then occur if this second two-dimensional similarity measure threshold level, also referred to as a hypothesis confirmation two-dimensional similarity measure threshold level, is exceeded. Where there is change in the visual identity of an observation encountered at a different time, the agent may, if confident that the current and past observation are captured of the same Identity, use the current observation information to update the stored observation. As both observations are represented by normalised vectors this could comprise averaging the two vectors with an optional weighting applied to each, such that the final observation would align more or less with the past or current observation vector. For example, if the past observation is multiplied by 5 and the current by 1, then the summed vector re-normalised, then the final observation vector would be more aligned to the past vector.

Adjusting the hypothesis includes rejecting the hypothesis and returning to a previous observation to identify a second hypothesis. In particular, if, at any observation, the current observation does not match the predicted observation to a suitable level of confidence, and/or the actual displacement does not match the predicted displacement to a suitable level of confidence, the hypothesis is rejected. The agent is then configured to return to a previous observation, by making an opposite displacement from the displacement made to get to the current observation. This may include returning to an initial observation although this is not necessary. The method 300 then repeats to test a different hypothesis, selected based on a comparison between the previous observation and each of several hypothesis subsets of predicted observations. Optionally, the agent may store observations and displacements even if such observations and displacements do not match the hypothesis, and the hypothesis is subsequently rejected. Storing these observations and displacements can be useful in generating a map of the space for future navigation and attribute identification purposes. Thus, before retreating to a previous observation, the agent may make and store one or more observations and displacements even if the hypothesis is rejected.

Confirming the observation includes identifying or finding an object, image or destination in the space, but is not limited to these examples. Once the attribute has been found, reference to it, including the observations and displacements made in the space by the agent, are stored to memory. These may form part of a map of the space in which the agent resides. If the hypothesis is associated with an identity or an attribute that is labelled, then the agent may also store reference to the label to memory, with the observations and displacements that it has made in the space. Where the hypothesis is based on previous visits to the same space, in that the hypothesis subset effectively defines an attribute as previously observed in the space, the hypothesis subset may be updated with the set of displacements and observations made by the agent most recently in testing the hypothesis. In this way, the hypothesis subsets may be kept up to date with respect to a particular space.

It is to be understood that the above methods may be performed by one agent or one or more agents working together. When one or more agent is included in the space, the one or more agents may communicate with each other, and/or have access to the same memory. For example, the plurality of agents may each be linked to the same server or computer system. The plurality of agents may simultaneously update a map of a space, or test one or more hypotheses simultaneously. Generation of the map is discussed in more detail below.

In the above description, a method 300 is described for the purposes of parsing space and identifying an attribute of the space. The attribute may be an object, or image, such that the method 300 is used for object or image recognition purposes, or a destination, such that the method 300 is used for navigation purposes. The method 300 relies on an agent making observations and displacements in the space and comparing these to stored observations and displacements. Thus, one principle of the method 300 is the ability of the agent to compare observations and displacements. This is set out in FIGS. 4 to 6 and the accompanying description above. Another principle is the ability of the agent to move, which is set out in FIG. 7 and the accompanying description above.

Further aspects will now be described that are complementary to the method 300, which may be incorporated in the method 300 or may alternatively be performed or implemented separately.

A first further aspect is the generation and storing of the linked observations and displacements that form identities and the hypothesis subsets. This may be considered a ‘training process’ as briefly mentioned previously. The process of forming identities may be performed specifically for the space in which the agent is intended to reside, or may be performed in a separate space. There are benefits for both of these implementations. Where identities are formed in the same space the agent is later configured to investigate, it becomes possible to identify how attributes of that space change over time after further explorations of that space. Where identities are formed in separate spaces, it is possible to identify recurrences of attributes of one space in another, and to identify similarities and differences between spaces.

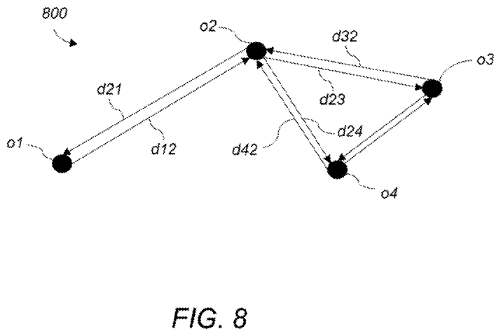

The process of forming and storing an identity is set out here with reference to FIG. 8. FIG. 8 shows a schematic diagram 800 of an identity. Consider that no observations or displacements have been stored. The agent is ‘dropped’ or otherwise activated in a previously unknown and unexplored space. An initial Observation o1 is made in the space. The initial observation o1 may be made based on low-level features detected in the space, although this is not compulsory. The use of low-level features is discussed separately later as a further complementary aspect. The choice of initial Observation can further be chosen at random, or based on a learned process. From the initial observation o1, an initial displacement is made from the location of o1 to make a new Observation o2, and the Displacement between o1 and o2 is stored to memory denoted as d12, as well as the inverse Displacement from o2 to o1 which is the negative of d12 denoted as d21.

Optionally, an additional effort value is stored which is a better measure of a property to be optimised in routing such as, but not limited to, energy usage, and/or vibrations encountered.

A sequential set of Observations Oi{oi,1 . . . oi,n} with a corresponding set of Displacements Di{di,1 . . . di,n−1} are then travelled by the agent and stored in the same way. This forms an Identity. The set of observations and displacements that form the identity describe a predicted path through space, along with the expected surroundings at points on the path. Travelling the path allows the agent to test the prediction (i.e. hypothesis), by comparing the measured displacements and observations on-by-one against the prediction. The sequential set of observations and displacements that form the identity are stored as set out above. In some examples, the identity can be stored as a subset of a larger stored set, wherein the larger stored set includes a plurality of subsets, and wherein each subset defines a pathway within the same or different space. It is thus possible that identities are linked to other identities, and for identities to share one or more common observations and/or displacements.

As shown in FIG. 8, a series of observations o1 to o4 and corresponding displacements can be captured in a closed loop to form the identity, and this can then be tested against further future observations and displacements sequentially for a contiguous subset or for the entire set in sequential order using the Style and Composition dimensions as set out above. The identity can be used for purposes including, but not limited to: Localisation or identification of specific objects; Extraction of general repeated Classes such as objects or navigational topographies such as, but not limited to, building corridors and rooms; and Extraction of Contexts, which are regions or objects with similar components or properties (e.g. forests/offices/streets or wheeled vehicles/flying objects).

During or once the identity has been stored as a subset of observations and displacements, a further, optional process may include the use of a separate system to determine the attribute to which the identity relates. For example, the identity could be related to a pathway, for navigation purposes to a destination in the space. Alternatively, the identity could be related to an object, such as a chair, or an image, such as a cartoon-chair or a painting of a chair. To correctly associate the identity with these attributes, a training process may be used. The training process may involve identifying the attribute via an established training algorithm, including the use of training data to train a classifier, for example. It is to be understood that any machine learning process may be used, and may include the use of neural networks or the like.

The above described methods and systems set out how an agent may identify, determine, or navigate a space using observations and/or displacements. Once an observation is made, and a space is thus at least partly explored, it is beneficial to store a record of the observation by generating a map. It is to be understood that generation of a map can be performed independently or in combination with identity generation and attribute determination/hypothesis testing as set out above.

The agent may generate a new map if the space is entirely unknown from previous explorations of the agent, or the agent may update an existing map in memory if the space has been previously visited by the agent.

To generate a map, the agent makes a first observation in the space. This could be the same observation as the first observation made in the first step 301 of the method 300 for testing a hypothesis described above. The first observation is stored to memory, indicative of a corresponding ‘first location’ of the map.

The agent is then configured to move away from the first location to make one or more further observations.

When the map is being made or updated in combination with the agent performing hypothesis testing, the agent moves according to the movement function as set out above. In this case, the agent is configured to make one or more new observations as it moves away from the first location. The new observations may be made whilst the agent moves according to the movement function (transitional), or may be made thereafter. In this respect, the agent may wait until it arrives at the second location of the second observation of the method 300 described above before making the ‘new’ observation, in which case the second observation is the new observation.

The new observation is compared with the first observation, using one or more observation comparison functions as set out above. This gives one or more observation comparison measures. The observations comparison measure is compared against a mapping threshold that defines a maximum likeliness that consecutive observations must fall below in order to be recorded on the map. In other words, the method of generating the map requires that observations stored on the map are not too similar. This avoids unnecessary points being added to the map, which keeps the map concise and the memory required to store and access it at a minimum. When the observation comparison between the first observation and the new observation results in an observation comparison measure that is lower than the mapping threshold, the new observation is stored to memory on the map, at a ‘new location’. A displacement between the first observation and the new observation may be measured and/or retrieved from the movement function and is also stored to the map, together with the inverse displacement from the new observation to the first observation. When the map is generated when hypothesis testing is also happening, this means that the agent performs two comparisons—a first between the current observation and a predicted observation (to test the hypothesis), and a second between the current observation and a previous observation (such as the first observation), to determine whether these observations are non-similar enough to both be included on the map. Thus, even when the hypothesis is rejected, and the current observation does not match well enough to the predicted observation, the agent can still usefully make an observation or use the current observation for the purposes of adding to or updating the map, by comparing it to the previous observation.

If the mapping threshold is exceeded, the new observation is not stored on the map, and instead, the agent is configured to move again by a further displacement before making a further observation, until the mapping threshold is not exceeded.

Once the new observation is stored on the map with the displacement between the first observation and the new observation, the new observation effectively becomes the first observation (or a previous observation), and the process repeats for a further displacement and a further observation. This process iteratively builds a connected network of observations that form a map descriptive of the space in which the agent resides.

The map of a space can also be generated separately from identifying an attribute of a space. The method of generating a map in this case is largely the same. The agent makes a first observation, and stores this in memory as the first location in a map. The agent then moves away from the first location of the first observation in a direction that is unexplored and physically or logically passable. The movement of the agent is recorded as a first displacement. As above, the agent then makes one or more new observations away from the first location, and compares the first observation to the new observation to determine whether the mapping threshold is exceeded. If the mapping threshold is not exceeded, the new observation is stored on the map, with the first displacement and an inverse first displacement linking the first observation with the new observation. The relative directions between the first and the new observations are marked as ‘explored’. The process then repeats for further displacements and observations from the location of the new observation, in an unexplored direction. The use of the mapping threshold means the number and density of observations made in a particular space is dependent on the complexity and features of that space. For feature-rich environments, more observations are made, as similarity between observations drops below the mapping threshold faster and in less distance. In feature-poor environments, whereby the space is not as complex, fewer observations are required. Thus, the method of mapping and/or identifying an attribute is performed in a manner that means it is automatically adapted to the constraints of the space being observed or travelled by the agent. The methods are thus sensitive to the complexity of the environment.

Multiple agents may contribute to the same map. In particular, a plurality of agents may each contribute and have access to a shared database or memory, and are configured to update the shared database with sets of observations and displacements to generate a map. Where hypotheses are tested and attributes identified, identities relating to the attributes may be stored on the map and where possible labelled as such. Thus, the map may include multiple identified attributes and stored labels for these attributes. Agents can contribute to the generation of the map in real or near-real time, and are each communicatively coupled to the shared database, via any suitable means. For example, in a physical space, the plurality of agents may be a fleet of drones, robots, vehicles or the like, each of which is able to communicate with a computer system or distributed computer systems such as a plurality of servers.

The map can be used for navigation of the space thereafter. In particular, a destination on the map can be selected for moving the agent to. This destination is represented by an observation that forms part of the map.

Navigation of the map works in a similar way to the method 300 for testing a hypothesis and determining an attribute of the space. When navigating the map, the attribute is effectively the destination. The process of navigation is described in more detail here.

The map is generated and stored in memory as noted above, and forms a set of stored observations and displacements, wherein at least a subset of the stored observations and displacements are connected to or form a network with the observation associated with the destination. The map is thus similar to a hypothesis subset as explained above.

In some embodiments, the map does not include displacement data. In some embodiments, the map may include data relating to characteristics associated with observations, such as action vectors and similarity magnitudes. These characteristics may form vector or scalar fields that function as maps for the purpose of navigation.

The agent may be configured to make a first observation in the space to identify which of the stored observations of the stored map the agent is closest to. In particular, the first observation is compared to each of the observations connected to the destination in the stored map. From these comparisons, a closest matching observation to the first observation is identified. The agent is then moved so as to relocalise to the position of the closest matching observation.

From the position of the closest matching observation on the map, a route is planned using a routing algorithm. Any suitable routing algorithm may be used, such as Dijkstra's algorithm that determines the route that minimises a measure that may be distance, effort, vibration or some other measure that can be retrieved from the displacements stored in the map.

Once the route is planned, the agent moves along the route in a sequential manner, wherein a process is repeated as the agent moves from observation to observation on the map. The agent starts this process from the ‘closest matching observation’ and the route may, for example, include a plurality of observations between the closest matching observation and the destination. The observation at which the agent is currently at is the current observation, and the next observation in the route to the destination, from the map, is referred to as the target observation.

The repeated process includes using the stored displacement vector between the current and target observations to move the agent in the direction of the target observation. This is analogous to moving the agent according to the movement function, dependent on the predicted displacement, as explained above with reference to the method 300 for hypothesis testing. As with hypothesis testing, the process also includes using one or more observation comparisons using one or more of the observation similarity function, the observation rotation function, and the observation action function. For example, the stored displacement to reach the target observation may be used in combination with the observation action function to move the agent from the current observation to the target observation. The agent may thus make a plurality of transitional observations whilst travelling between the current observation and the target observation, to use the observation action function to relocalise to the position of the target observation. This is analogous to the movement function comprising the first movement component and the second movement component as described above, and allows the direction of travel to be modified and account for odometrical drift and uncertainty when recapitulating the displacement between the current observation and the target observation.

Once the observation comparison measure (or measures) is above a predetermined threshold value, or a continuously calculated threshold value, it is determined that the agent has reached the target observation. This is analogous to determining a match between the second observation and the predicted observation in the hypothesis testing method 300. Once it is determined that the agent has reached the target observation, the process is repeated for the next observation in the route to the destination, until the destination is reached. Thus, the target observation becomes the current observation, a next observation becomes the target observation, and the displacement to be travelled is the displacement between the current observation and the target observation. Once the agent reaches the observation associated with the destination, the agent is configured to wait at that position unless instructed otherwise.

Thus, the use of observations, displacements, and a movement function can be used to identify attributes and features of a space, generate a map of the space, and navigate the space. It is to be understood that one or more or all of these processes can take place concurrently. For example, the agent can be instructed to follow an existing route to a destination, identify attributes or features en-route to the destination, and add to the existing map using transitional observations. The agent is thus capable of learning and navigating its environment concurrently.

In the above described methods and systems for parsing logical or physical space, including identifying an attribute/feature of the space, generating a map of the space, and navigating the map of the space, the agent is configured to make and compare observations, and move between these observations. As noted previously, it is not necessary that the logical or physical space is known to, or has been previously visited by the agent. There are thus several sets of initial conditions that the agent may encounter when being put into the space.

In a first instance, the agent may be put in a space whereby the space has been previously visited, and wherein the agent has access to a stored map or stored subsets including observations and displacements made in the space. In this instance, when making the first observation, the first observation may be identical or otherwise match with a stored observation (such as a predicted observation of a hypothesis subset and/or an observation in a path to a destination). In this case, it is not necessary to relocalise the agent before performing the method 300 to test the hypothesis, or to navigate a route to a stored destination.

In a second instance, the agent may be put in a space whereby the space has been previously visited and wherein the agent has access to a stored map or stored subsets including observations and displacements made in the space. In this instance, when making the first observation, the first observation may not be identical to any of the stored observations of the map or stored subsets. Since the location of the agent is thus unknown, it is not possible to use stored displacements to relocalise the agent onto a stored observation. Rather, the agent must first relocalise to a stored observation without the use of predicted displacements, in order to understand its position on the map or with respect to the stored subset of observations and displacements. To do this, the first observation is compared with each of the stored observations, and the observation action function is used to determine a vector towards one of the stored observations, referred to here as the target observation. The agent then moves along this vector, iteratively or continuously updating it with further transitional observations to relocalise onto the target observation.

The choice of which stored observation becomes the target observation may be decided in any reasonable manner. In one example, the stored observations may each be compared, for all rotations, against the first rotation, using the observation similarity function. The most similar stored observation may then be selected for the purposes of comparing to the first observation for determining the action vector from the observation action function.

Alternatively, the action vector for each stored observation may be determined, and the strongest of these is then selected for relocalising the agent to a stored observation. The action vector is determined from the observation action function as explained above, and is weighted, and thus becomes stronger, based on the similarities between sub-regions of a stored observation vector and corresponding dub-regions of a current observation vector, or based on the overall similarity measure.

In a third instance, the agent may be put in a space whereby the space has not been previously visited, but wherein the agent has access to stored subsets including observations and displacements from a different space or spaces. In this instance, when making the first observation, the first observation may not be identical to any of the stored observations of the stored subsets. Since the location of the agent is thus unknown, it is not possible to use stored displacements to relocalise the agent onto a stored observation. Rather, the agent must first relocalise to a stored observation without the use of predicted displacements, in order to understand its position in the space with respect to the stored subset of observations and displacements. To do this, the first observation is compared with each of the stored observations, and the observation action function is used to determine a vector towards one of the stored observations, referred to here as the target observation. The agent then moves along this vector, iteratively or continuously updating it with further transitional observations to relocalise onto the target observation.

The choice of which stored observation becomes the target observation may be decided in any reasonable manner. In one example, the stored observations may each be compared, for all rotations, against the first rotation, using the observation similarity function. The most similar stored observation may then be selected for the purposes of comparing to the first observation for determining the action vector from the observation action function.

Alternatively, the action vector for each stored observation may be determined, and the strongest of these is then selected for relocalising the agent to a stored observation.

However, unlike the first and second instances above, in this third instance, the stored subset of observations and displacements are from a different space to the space in which the agent currently resides. It is thus possible that none of the stored observations exist in the space in which the agent resides. In this instance, the agent may not be able to relocalise to a stored observation. If the agent is testing a hypothesis, such that the stored subset of observations and displacements is a hypothesis subset, the agent may reject the hypothesis relating to the hypothesis subset if the agent cannot localise onto a stored observation of the hypothesis subset. The agent may then return, by a negative displacement, to the location in the space of the first observation. From here, the agent may select a different hypothesis and a corresponding hypothesis subset to test. The agent may repeat this process as necessary for all stored hypotheses and hypotheses subsets. If all of the hypotheses are rejected, meaning that the space does not include any recognisable features or attributes corresponding to the stored subsets of observations and displacements, the agent may enter an exploration mode whereby the agent makes observations and displacements to generate a map of the space as explained above.

In a fourth instance, the agent may be put in a space whereby the space has not been previously visited and wherein the agent does not have access to any stored subsets including observations and displacements. In this instance, the agent enters the exploration mode as above, to map out the unknown space in which it resides, and ultimately store a set of observations and displacements to describe the space.

The above description focuses on an agent making sequential observations and displacements to perform one or more of generating a map, navigating a route through a space, or identifying a feature of the space. Whilst it is possible to perform these methods using observations and displacements alone, additional factors may be incorporated to provide further efficiency and accuracy benefits.

In particular, low-level features of the space may be identified or detected and used to inform the process of making observations and moving between observations within the space. In particular, observations made by the agent include spatial information indicative of the environment of the space within the vicinity of the agent. It is thus possible to extract features from the observations or the observation data to obtain even more information regarding the vicinity of the agent. For example, environmental cues such as high-contrast lines, colours, edges and shapes may be extracted to determine further information regarding the environment, which can be used to inform decisions and behaviours. In map generation for example, wherein the agent is configured to explore a space by sequentially making observations and displacements, the selection of direction in which to move the agent after each observation may be driven by low-level features. Specifically, after making each observation, the selection of the next direction of movement of the agent may be weighted based on low level features and/or directions previously navigated. For example, a first weighting may be applied to directions that, if traversed by the agent, would move the agent closer to a previous observation. Since the objective in map generation is for the agent to explore and map a space, it is beneficial to encourage the agent to move away from previous observations, and this first weighting achieves this. A second weighting may be applied to directions based on low-level features. For example, if an edge or high-contrast line appears to lead in a specific direction, that direction may be weighted higher than a direction where there are no low-level features. In a physical space, the agent may be a vehicle. The low-level features extracted may include roads (from edge detection or the like). The directions in which the roads appear and/or lead, from the current observation, may be weighted higher than a direction from the current observation with no roads. This second weighting based on low level features thus encourages the agent to follow or move closer to potential features of the environment. By following roads for example, the space is more likely to be explorable and the agent is more likely to make observations that are easily traversed and connected. While roads are artefacts that have been added to the environment by humans, it is understood that in natural environments features that can provide a similar benefit exist, such as the banks of water courses, the edges of woodlands with grasslands, and trails left by foraging animals wearing paths in vegetation. By following such features as part of both the exploration and navigation stages of movement the agent can ensure that there are additional guides that can ensure reliable traversal, even in cases of high environmental difference, such as thick mist. It should also be noted, that such features aid when the agent is recognising an identity for an object, such as a chair. Following the string edges formed by the legs, seat and back of the chair can guide the movement of the point of observation to ensure high robustness in recapitulating an identity, even in the presence of 3D rotations.

It is to be understood that the first and second direction weightings discussed here may be used separately (without the other) or in combination.

The low-level features identified or detected in observations or observation data may also be linked to a set of behaviours to be performed by the agent. These behaviours allow the agent to approach features in similar ways when first encountering a new part of space or object to when it reencounters the same part of space or object. For example, when a high-contrast line is identified or detected, the agent may be configured to travel along the high contrast line. The agent may be configured to follow consistent lines in the environment to their vanishing points, such that the agent can move along roads, pavements or paths. These types of structured actions simplify the problem of robust navigation. The agent may move in another predetermined direction with respect to a low-level feature, such as perpendicular, parallel, clockwise or counter-clockwise with respect to the low-level feature.

Observations may also be made according to the presence of low-level features in the environment. Distinctive low level visual statistics which can include but are not limited to, spatial frequency distribution, luminance distribution, colour distribution may be used to determine when and where the agent should make an initial observation.

The use of low-level features is not limited to map generation. In particular, low-level features can be used in any of the methods described above. In hypothesis testing for example, according to the method 300 described above, low-level features or cues can be used in the movement function when determining how to move the agent from a current observation to a predicted observation. The movement function is dependent on the predicted displacement required to move the agent to the predicted displacement, but may also be dependent on low level features such as high-contrast lines or edges. In a physical space, the agent may be configured to follow such low level features, such as a road, even if the road is not directly aligned with the direction of the predicted displacement. A road may be identified by, for example, presenting as a single colour extending from the bottom of the field of view, where the agent is located, upwards towards the top of the field of view, which largely contains more distant locations. Alternatively, the road may be identified as a region extending as previously described, but comprising strong vertical edges in the absence of strong horizontal edges. If for example, the road is within a threshold angle from the direction of the predicted displacement, the agent may be configured to follow the road rather than follow the predicted displacement. This can improve the system if the predicted displacement is for whatever reason inaccurate. The agent may then routinely make transitional observations whilst on the road to ensure that the movement of the agent is acceptably towards the predicted observation. The agent may leave the road if the predicted observation is not reached or appears, from the observation action function for example, to be moving further away relative to the agent. The agent may also move to the conclusion of the low level feature (for example the end of the road or the next junction in the road). If the agent does not find the predicted observation at this point, the agent may nevertheless make observations and store them to generate a map or otherwise further populate the map with new knowledge of the space, before rejecting the hypothesis and returning to the previous observation.

Following low-level features or otherwise using them advantageously simplifies the process of testing a hypothesis and navigating a space, since back-tracking from a point in space to a previous observation is easier, and simply requires the following for the low-level feature in a reverse manner. Additionally, robustness to highly visually impactful environmental changes, such as thick fog, is improved as the agent can follow the feature, even in the absence of more distant descriptive information.

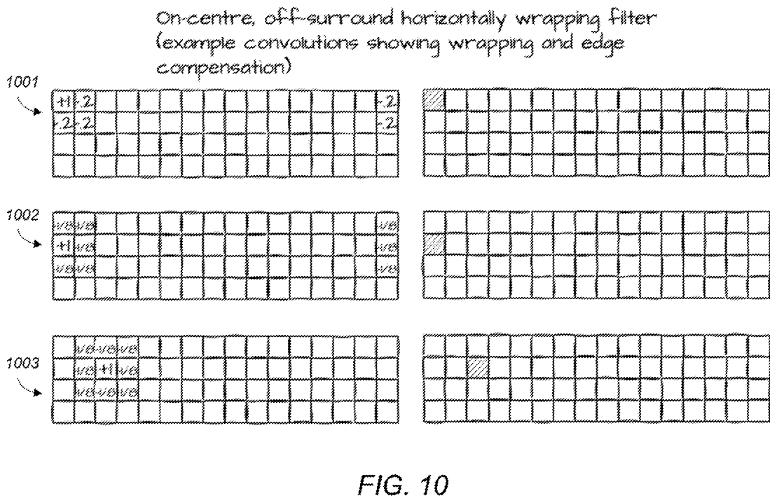

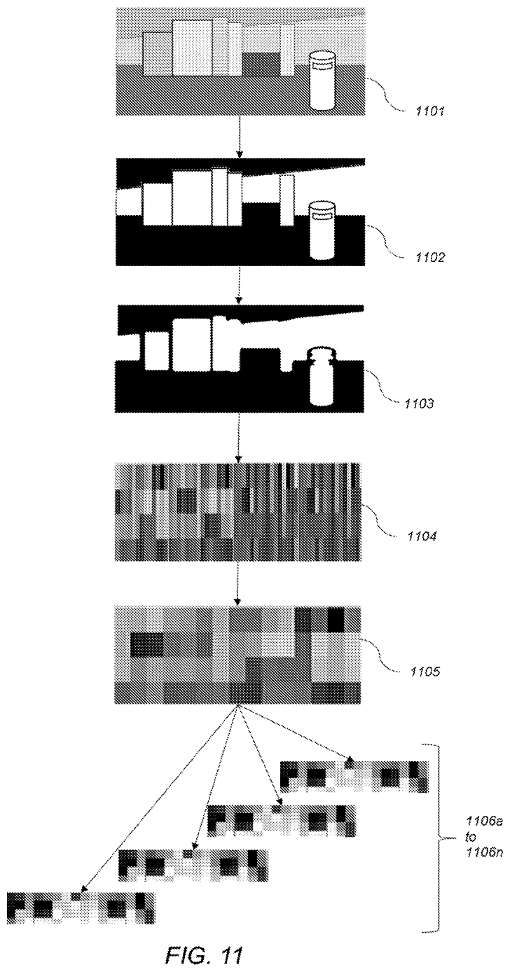

The above description introduces a variety of concepts. One such concept is the use of the action function to compare a stored observation to a current or new observation, to effectively determine a similarity between the stored observation and the new observation and to provide a vector from the new observation to the stored observation, whereby the vector may be used by an agent when determining how to move to arrive at a location corresponding to the stored observation. The action vectors may be used, as briefly outlined above, to generate a vector field map of a space with respect to a stored observation. The process of generating an action vector will now be described in more detail, with reference to FIGS. 11 to 15, as well as FIGS. 6 and 9 as set out above.

As discussed above, the observation action function compares sub-regions of a current observation against sub-regions of a stored observation. The sub-regions for each of the current observation and stored observation are parts of the whole current observation and the whole stored observation.

The use of sub-regions for this purpose originates from the concept that, as the agent moves away or towards the location from which stored observation was captured, not all parts of the visual field will change equally. This is distinct from classical triangulation as it considers not the movement of an identified object or signal source, but the distortion of the entire visual scene. As such, it is robust to occlusions of parts of the visual scene, making it more tolerant of environmental changes. Additionally, it does not require metric calculations to function, making it more robust to measurement noise. This property can be used to understand both how far the agent is from the location corresponding to the stored observation, but also allows for a further vector to be calculated for the purposes of moving to that location. This further vector, calculated by the observation action function, uses the same principles as the observation similarity function, except the inner product is obtained for N spatial sub-regions of a current observation and N corresponding sub regions of the stored observation.

To obtain the sub-regions, the process as set out above with respect to FIGS. 6, 9 and 10 is performed. This process is explained in detail here, with reference to FIG. 11.

FIG. 11 shows a schematic diagram of the results of a number of processes that are performed on original observation data to obtain an observation vector or matrix o, from which a plurality of sub-regions may be obtained. In FIG. 11, the original observation data is captured in a first step, to capture an original image 1101. The original image 1101 may be a 360 degree view of the environment of an agent, captured from a first location, whereby the first location is that of the agent. In this case, the original image 1101 forms first or current observation data, also referred to as first sensor data. Equally, the original image 1101 may be historic or stored data. The process of forming sub-regions is the same for stored observation data as it is for current observation data. However, with respect to stored observation data, also referred to as second sensor data, it is not necessary to store the original image, and instead, only a single observation vector or matrix corresponding to the original image (a sliced or reduced size format image) is required to be stored. This is explained in more detail below. To obtain the original observation data such as the original image 1101, a process of capturing sensor data by the agent is undertaken. It is to be understood that any sensor or virtual sensor capable of recording spatial information may be used. In the case of the original image 1101, a camera may be used.

In a second step, the original image 1101 is divided into separate feature channels, to provide, for example, four feature channels. These feature channels may include Red, Green, Luminance Vertical Edges and Luminance Horizontal Edges, for example. The resolution may be the same as that of the original image 1101, for example, at 256×64 pixels. In FIG. 11, the red feature channel 1102 is shown. Other types of channels are possible. Edges may be obtained by convolution with 1×2 kernels.

In a third step, for each feature channel of the original image 1101, such as the red channel 1102, the images are processed, such as by a box filter with a 17×17 square (or any other sized square, such as a 19×19 square) to blur the information of each channel to produce a filtered image 1103, for each channel. It is noted that other types of image processing are possible, as would be well-understood.

In a fourth step, a reduction process is performed on the filtered images 1103. This reduction process includes reducing the dimensions of the filtered image 1103 by performing slicing operations. In particular, the filtered 1103 is sliced to remove a portion of the rows of the filtered image 1103 and a portion of the columns of the filtered image 1103. A first reduced format image 1104 is shown in FIG. 11. This first reduced format image 1104 is the result of performing slicing of a predetermined number of rows from the filtered image 1103. In FIG. 11, 4 rows are ‘sliced’ from the filtered image 1103 (discarding the remaining rows) to obtain the 256×4 first reduced format image 1104. The choice of rows to slice out and use is arbitrary but it is advantageous to use rows that are not adjacent to each other, for example, rows 8, 24, 40 and 56, or rows 6, 22, 38 and 54. A second reduced format image 1105 is also shown in FIG. 11. This second reduced format image 1105 is the result of performing slicing of predetermined number of columns from the filtered image 1103 (in addition to the slicing operation performed to obtain the first reduced format image 1104). In FIG. 11, 16 columns are ‘sliced’ from the filtered image 1103 (discarding the remaining columns) to obtain the 16×4 second reduced format image 1105. The choice of columns to slice out and use is arbitrary but it is advantageous to use columns that are not adjacent to each other, for example, columns 1, 17, 33, 49, 65, 81, 97, 113, 129, 145, 161, 177, 193, 209, 225, 241. It is further advantageous to select evenly spaced columns, to obtain an even distribution of data from around the agent.

When both slicing operations are performed, (to obtain the second reduced format image 1105 as shown in FIG. 11), the observation vector o may then be obtained. The observation vector or matrix is effectively a coarse representation of the 360 degree environment of the agent, according to the original sensor data 1101. This observation vector, in the instance of FIG. 11, is formed from the second reduced format image 1105, which is itself a 16×4 matrix that represents a reduced and simplified version of the original data 1101. Other dimensions are possible and would be understood. Selecting the rows and columns to keep from the filtered image 1103 in the slicing operations in an evenly distributed manner ensures that the observation vector or matrix is a good representation of the entire field of view associated with the original image 1101. In other words, it is advantageous if the columns and rows of the filtered image 1103 that survive slicing to form the observation vector or matrix are evenly distributed throughout the filtered image 1103.

To obtain the observation vector such that it is in a suitable format for performing comparisons, additional processing may be performed. In particular, the 16×4 second reduced format image 1105 is convolved cyclically with an on-centre, off-surround (or the inverse) kernel. The channels of the 16×4 second reduced format image 1105 may be subdivided into two data subsets, one consisting of red and green, or otherwise, a ‘colours’ vector, and the other luma_h and luma_v, or otherwise, an ‘edges’ vector. Each of these data subsets are normalised via vector normalisation (by division by the respective Euclidean norm) such that the elements of each of the colours vector and the edges vector describe values on a set of orthogonal values, and the result is a unit vector. These normalised vectors are then concatenated into a single unit vector by scaling each by the square root of two. This provides the observation vector, o relating to the second reduced format image 1105 and the original image 1101. This Observation vector in this example is concatenated from 16 columns, 4 rows and 4 channels to give a 256 element vector. Although these processes are performed to the 16×4 second reduced format image 1105 to produce a one dimensional vector suitable for comparison computations, it is to be understood that reference to the second reduced format image 1105 (a 16×4 matrix) below is synonymous with the observation vector. The observation vector is effectively the same information as the second reduced format image 1105, merely in a different format and in a normalised form. As such, the second reduced format image 1105 may be referred to as the observation vector.

The above first to fourth steps are applicable to either first (current) sensor data or second (stored) sensor data, meaning the process of forming an observation vector or matrix for each of these is entirely the same.

In some embodiments, wherein the observation action function is performed, an additional fifth step is performed to obtain sub-regions from the observation vector.

In this fifth step, the observation vector or matrix 1105 is sub-sampled to obtain the sub-regions 1106a to 1106n for the sensor data. In FIG. 11, the sub-regions 1106a to 1106n for the red feature channel are shown. Sub-regions 1106a to 1106n are effectively portions of the field of view that is coarsely represented by the 16×4 observation vector or matrix. This fifth step involves the application of a mask to the observation vector or matrix 1105 to obtain each subregion. The mask is overlaid on the observation vector or matrix 1105 and the output of this operation is the reproduction of the cells or pixels of the observation vector or matrix 1105 which are overlaid by the mask. The mask is smaller than the dimensions of the observation vector or matrix 1105, and, as such, only a fraction of the pixels of the observation vector or matrix 1105 are reproduced by the mask. This fraction that is reproduced forms the sub-region. In an example, the mask is 8×4 pixels, and is overlaid on the 16×4 observation vector or matrix. This means that 8 columns of pixels are discarded by the mask, accounting for half of the field of view of the original image 1101. To obtain the multiple sub-regions 1106a to 1106n, either the mask is permuted iteratively over different columns of the observation vector or matrix 1105, or alternatively, the observation vector or matrix 1105 is permuted by a column each time across the mask. These two operations are effectively the same. It is to be understood that, since the observation vector or matrix 1105 is a coarse representation of a complete view (e.g. 360 degree view) corresponding to the original image 1101, the last column of the observation vector or matrix 1105 is effectively next to the first column, meaning that the mask can be permuted cyclically past the last column and onto the first column.

The size of the mask and the number of columns the mask is moved relative to the observation vector or matrix 1105 are changeable, and changing these variables can have different effects. In the above example, the mask is 8 columns wide, meaning it is half as wide as the observation vector or matrix 1105. The result of this arrangement is that the sub regions 1106a to 1106n produced by the mask effectively equate to half the field of view of the observation vector or matrix 1105. Increasing the size of the mask increases the portion of the field of view that is preserved in the sub-regions 1106a to 1106n, whilst decreasing the size of the mask decreases the portion of the field of view that is preserved in the sub-regions 1106a to 1106n. Comparisons made between larger sub-regions are more reliable, since there are more pixels in each sub-region on which the comparison can be based. Having smaller sub-regions however has the benefit of allowing for comparison of relatively more restricted details of a scene captured in the original image 1101. In other words, smaller sub-regions may be less affected by wider changes in the environment. For this reason, smaller sub-regions may be used to improve the effective range at which comparisons between stored data and current data may be made. In particular, as an agent moves away from an object or other attribute, the object appears smaller, and ultimately is found in a smaller area of pixels in the original image 1101 when compared to when the object is close to the agent. Similarly, the surroundings of the object may appear to change relatively drastically in the original image 1101 as the agent moves away. Using smaller sub-regions (for example, tuned to the expected size of such an object at a certain distance), would allow for comparisons to be made between sub-regions to find said object, even if the neighbouring pixels of the observation vector or matrix 1105 change considerably due to distance from the object. This example illustrates that there is a balance between selecting a large sub-region relative to the size of the observation vector or matrix 1105, or selecting a small sub-region. Benefits exist for both of these options. Even when larger sub-regions are used, methods of comparison such as the observation action function are still robust in terms of changes in the distance from a target/specific object.

As explained above, the movement of the mask at each iteration of obtaining a subregion, relative to the observation vector or matrix 1105, is also changeable. This is synonymous with determining the number of sub-regions that are to be obtained. In one example, the mask may move by one column per iteration, meaning each sub-region obtained is only permuted by one column compared to the previous sub-region. This is the finest difference possible between sub-regions. In the above example of a 16×4 observation matrix, it is possible to obtain 16 sub-regions in this way (the maximum possible number of sub-regions for a 16×4 matrix). However, one could decide to permute the mask by 8 columns, to obtain two sub-regions, or by 2 columns at each iteration, to obtain 8 sub-regions. The number of sub-regions to be obtained is arbitrary, but it is advantageous to obtain four or more, to increase the reliability of the action vector formed from the comparison of sub-regions, as is explained later. Again, with this variable, there is a balance between reliability (more sub-regions in the comparison), and computational burden (comparing more sub-regions requires more computations). The choice of the number of sub-regions is thus dependent on the needs and requirements of specific use cases.

When the normalised observation vector is subjected to the mask to obtain the sub-regions (which are effectively sub-vectors), the normalisation of the vector is lost. As such, in addition to the above processes, the sub-regions (and in particular, the sub-vectors corresponding to these sub-regions) are renormalised.

Before the comparison of the sub-regions of current (first) sensor data and sub-regions of stored (second) sensor data is explained in more detail with respect to the action function, firstly, recording and storage of the observation vector or matrix 1105 is explained here.

It is to be understood that sub-regions are not required to be stored and held by the agent or a memory associated with the agent, and rather, are only required when a comparison is computed, using the observation action function for example. The sub-regions can thus be produced from an observation vector or matrix 1105 when needed.

In terms of recording and storing observation vectors or matrices, several options are possible. As explained in the fourth step above, the observation vector or matrix 1105 is a coarse representation of the original image 1101, providing information from the entire field of view represented in the original image 1101 but with a reduced size. As part of the process of forming the observation vector or matrix 1105, slicing is performed to effectively discard rows and columns of the filtered image 1103, to reduce its size. However, for the purposes of performing a comparison between a current and a stored observation vector, it is advantageous if the information excised by these slicing operations is not lost. Different options for storing this data are possible, for stored (second) sensor data and current (first) sensor data.

In a first option, when storing an observation using the above process, from an original image 1101, multiple observation vectors or matrices 1105 are stored for each original image 1101. The multiple observation vectors or matrices 1105 are obtained by slicing out different columns in the fourth step set out above. In the example set out above, the original image 1101 is a 256×64 pixel image. This image is filtered and sliced to provide a 16×4 observation vector. Assuming that the columns that survive the slicing operation are evenly distributed in the original image 1101, this means that there are 16 possible 16×4 observation vectors, for each channel in which the original image 1101 is captured (256/16=16). These different observation vectors are obtained by permuting the columns in the slicing operation by one column each time. At the 17^{th} permutation, the observation vector is the same as the 1^{st} permutation. For example, if a first observation vector is produced from columns 1, 17, 33, 49, 65, 81, 97, 113, 129, 145, 161, 177, 193, 209, 225, and 241 in the original image 1101, a second observation vector can be produced from columns 2, 18, 34, 50, 66, 82, 98, 114, 130, 146, 162, 178, 194, 210, 226, and 242. This process is repeatable until the first column in the observation vector corresponds to column 17 of the original image 1101, in which case this observation vector is simply a rotation of the first observation vector. Thus, in this example, a set of 16 observation vectors are required to ensure that every column of the original image 1101 is preserved.

Additionally, each of the 16 observation vectors (obtained from slicing from different respective columns), may themselves each be permuted up to 16 times, to move the data in the observation vector through different columns. This is effectively a rotation of the observation vector (e.g. whereby the data originally in column 1 is permuted to column 2, and so on, with the data in column 16 being permuted to column 1). There are therefore 16 possible rotations of each observation vector, and 16 different observation vectors formable from modifying the slicing operation. Therefore, in total, there are 256 possible observation vectors from the 256×64 original image 1101.

In the first option as set out above, the set of 256 observation vectors or matrices are stored for stored sensor data. When comparing to a current observation (from current sensor data), a corresponding set of 256 current observation vectors may be compared against the stored set of observation vectors. Using the same process of finding the set of observation vectors for a current original image and a stored original image, this would mean, for example, comparing the set of 256 16×4 stored observation vectors with a set of 256 16×4 current observation vectors. Whilst this may provide higher comparative accuracy, it is computationally inefficient, since a high number of vector dot products are required to be computed. Storing and comparing against a full set of stored observation vectors also means that, when comparisons are performed against current observation vectors, a further step of selecting the best comparison result from the full set of stored observation vectors is required. Thus, comparing against the full set of stored observation vectors introduces an additional layer or step in the comparison process, which further increases computational burden. However, obtaining the best comparison in terms of one of the full set of stored observation vectors may provide more accurate and useful outcomes.

In a second option, when storing an observation vector, only one observation vector or matrix is required to be stored. This stored observation vector may be referred to as the zeroth observation vector, and in the above example, may be the observation vector obtained from columns 1, 17, 33, 49, 65, 81, 97, 113, 129, 145, 161, 177, 193, 209, 225, and 241 in the original image, for example. The image itself, and the other possible observation vectors are not stored. This means that the detail from the original image 1101 is effectively lost, and the only data available to the agent concerning the original image 1101 is the coarse representation of it, provided by the zeroth 16×4×4 observation vector. The reason that this is acceptable is that, when comparing to a current observation (which may not be stored in permanent memory, and may instead be recorded on the fly or in volatile memory for example), the stored zeroth observation vector is still compared to each possible permutation (e.g. a set of 256) of the current observation vector. Thus, the stored observation vector is compared against the set of 256 16×4×4 current observation vectors. In other words, the stored zeroth observation vector is stored against all the data obtained in a current observation (all of the data provided by the 256×64 current original image). This ensures that, if any of data of the current observation is similar to the zeroth stored observation vector, such similarity should be found by the comparisons of the zeroth stored observation vector with the full set of current observation vectors.

The second option is computationally efficient when compared to the first option set out above, as only one observation vector is required to be stored for a given original image, for comparison against new current data. Furthermore, it is not necessary in the second option to perform the additional step of determining which stored observation vector to use (from a full set) when performing comparisons against current observation vectors. This is particularly advantageous when an agent or computer associated with the agent may have to store several hundred/thousand etc. observation vectors relating to different locations, stored objects, or other attributes.

According to the second option, when comparing observations, a stored observation vector is compared against a set of current observation vectors, which are each possible permutation of a current original image. When using the observation action function, as is explained in more detail below, this involves comparing sub-regions of the stored observation vector (or in other words, stored sub-vectors), with sub-regions of the set of current observation vectors (or in other words, current sub-vectors). In the example where the stored observation vector and the current observation vector is formed from a 16×4 second reduced format image 1105 as illustrated in FIG. 11 (per each of 4 channels), there are 256 possible 16×4 current observation vectors, wherein each current observation vector may be used to form a sub-region (or current sub-vector), by processing each current observation vector through the mask used to generate the sub-regions.

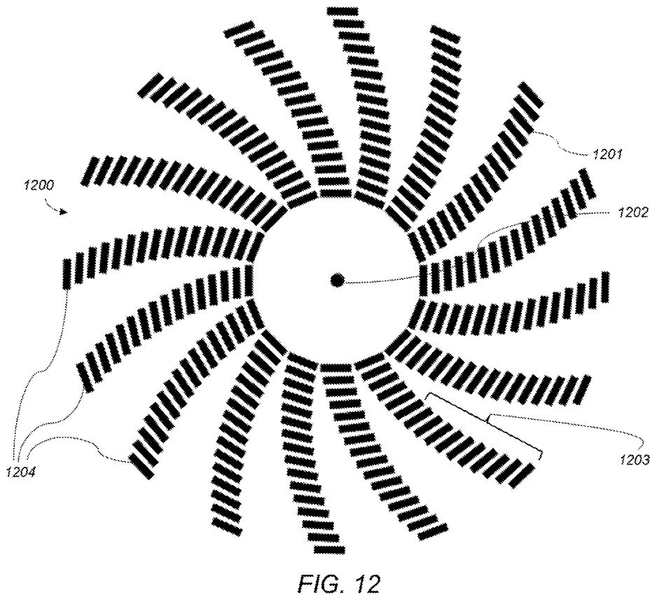

This means that, in total, there are 256 possible sub-regions for the current observation vectors, to compare against the 16 possible sub-regions of the stored observation vector. FIG. 12 illustrates this possibility, whereby a spatial graph 1200 indicates the number and arrangement of sub-regions 1201 around an agent 1202. It is to be understood that FIG. 12 is not to scale and is for illustrative purposes only. Each arm 1203 of the graph 1200 represents a sub-region obtained from the same mask position relative to the current observation vector. Each sub-region 1201 moving down each arm 1203 comes from a different one of the set of (differently sliced) current observations. Each concentric set 1204 of sub-regions on the graph 1200 is from the same current observation vector, but corresponds to different directions in space because the position of the mask used to produce the sub-region is different (or is permuted) for each sub-region in the concentric set 1204, or because the current observation vector itself has been rotated prior to extraction of the sub-region. Although illustrated as rectangles in FIG. 12, it is to be understood that each sub-region includes a portion of the 360 degree view around the agent, the portion being dependent on the size of the mask as explained above. In an example, each sub-region equates to a portion that is half of the field of view corresponding to the current original image to which this data relates. The sub-regions overlap each other.

In the observation action function, the current sub-regions (from current, first sensor data) are compared to the set of sub-regions derived from a stored observation vector. A best match for each of the ‘stored’ sub-regions is found from the set of current sub-regions, and for each best match an offset angle and magnitude is determined. This process, with respect to the observation action function, is described here in more detail.

As indicated above, the stored observation vector is split into N sub-regions, (also referred to as ‘stored’ sub-regions) and for each of the N stored sub-regions, comparisons are performed with a full set of sub-regions of the current observation vector (also referred to as ‘current’ sub-regions) for all possible rotation and slicing permutations (e.g. 256 permutations for the 16×4 observation vector) to identify which permutation is most similar to the stored subregion, also referred to as the current sub-region of best match. The particular permutation that is most similar has an index, for example, the 120^{th} rotation, which is used to identify the offset relative to the stored sub-region. An offset is calculated with respect to each stored sub-region, and optionally a similarity magnitude, wherein the magnitude indicates a similarity between the stored sub-region and the current sub-region of best match. The similarity magnitude is determined by performing the comparison itself, whereby the comparison is the combined observation similarity function and rotation function explained above. In particular, the scalar products of a stored sub-region and each of the set of current sub-regions are computed to determine the current sub-region of best match. Due to the normalisation of the sub-regions, the scalar product is maximal (1) when the vectors are aligned (that is when the relative differences between the pixels are the same), zero (0) when the vectors are orthogonal, and minimal (−1) when the vectors are exactly opposite. This comparison thus returns a value in the range of [−1,1] and the index of the position of the current sub-region which provides the best match. From this an offset and magnitude are associated with the current sub-region and/or the stored subregion.

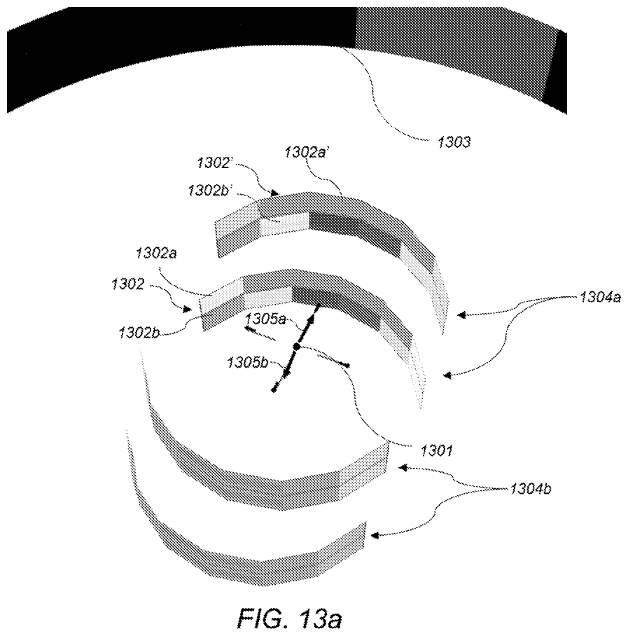

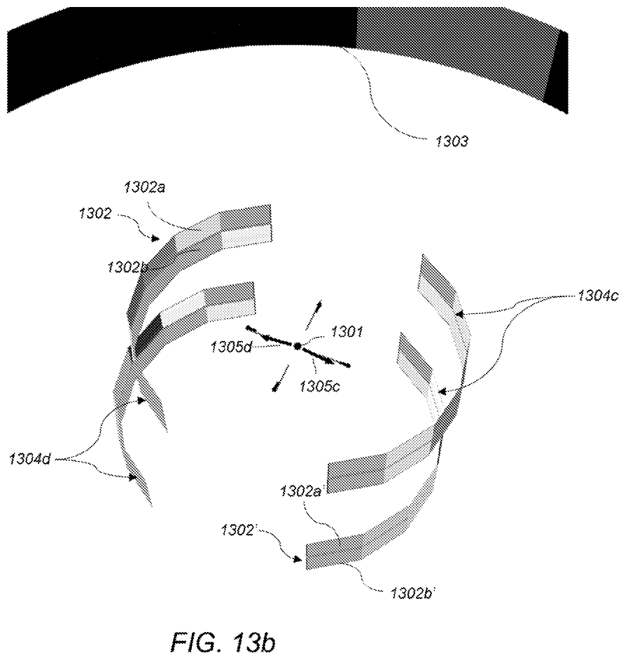

FIG. 13A shows a schematic diagram of the comparison of sub-regions. FIG. 13A shows an agent 1301. The agent 1301 is centred in a ‘current observation’ cylindrical projection 1302 including a green feature channel projection 1302a and a red feature channel projection 1302b. The current cylindrical projection 1302 is an illustrative spatial projection of a current observation vector, and shows how the current observation vector describes the environment around a first location of the agent 1301. In particular, the current observation vector describes in sensor data how a real scene 1303 (i.e. the world) around the agent 1301 at the first location appears. Also shown in FIG. 13A is a similar depiction of a ‘stored observation’ cylindrical projection 1302′ around the agent, including a green feature channel projection 1302a′ and a red feature channel projection 1302b′. The cylindrical projection 1302′ is an illustrative spatial projection of a stored observation vector, and shows how the stored observation vector describes the environment around a second location of the agent 1301. In FIG. 13A the projections of the stored and current observation vectors are split into sub-regions. In particular, FIG. 13A shows a first (front) sub-region 1304a for each of the ‘current observation’ cylindrical projection 1302 and the ‘stored observation’ cylindrical projection 1302, and a second (back) sub-region 1304b for each of the ‘current observation’ cylindrical projection 1302 and the ‘stored observation’ cylindrical projection 1302. In other words, FIG. 13A shows front stored and current sub-regions 1304a and back stored and current sub-regions 1304b. It is to be understood that this is illustrative, and in reality, the current sub-regions 1304a and 1304b are samples of a set of all possible permutations of the current sub-regions used in the comparisons.

The front stored and the set of current sub-regions 1304a are compared with each other using the observation similarity function and rotation function to obtain a scalar product and offset. The back stored and the set of the set of current sub-regions 1304a are also compared with each other using the observation similarity function and rotation function to obtain a scalar product and offset. These operations provide the sub-region offset angles 1305a and 1305b respectively. These operations also provide a magnitude M_{F} indicative of the similarity between the front stored and current sub-regions 1304a, and a magnitude M_{B} indicative of the similarity between the back stored and current sub-regions 1304b.

FIG. 13B shows the same arrangement of the agent 1301. The only difference in FIG. 13B is that the stored and current sub-regions being compared are not front and back sub-regions, but are instead right hand side current and stored sub-regions 1304c and left hand side current and stored sub-regions 1304d. The comparison process is otherwise the same, in that the right hand side stored and full set of current sub-regions 1304c are compared with each other using the observation similarity function and rotation function to obtain a scalar product and offset. The left hand side stored and full set of current sub-regions 1304d are also compared with each other using the observation similarity function and rotation function to obtain a scalar product and offset. These operations provide the sub-region offset angles 1305c and 1305d respectively. These operations also provide a magnitude M_{R} indicative of the similarity between the right stored sub-region 1304c and the current sub-region of best match, and a magnitude M_{L} indicative of the similarity between the left hand side stored sub-region 1304d and the current sub-region of best match.

It is to be understood that, whilst FIGS. 13A and 13B show respective front, back, right hand side and left hand side stored and current sub-regions, and the offset angles determined from comparisons between them, there may be any number of stored sub-regions, corresponding to any portion, and thus direction, of the entire stored observation vector. FIGS. 13A and 13B show sub-regions that are effectively half the size of the observation vectors and thus include sensor data indicative of half of the field of view associated with the observation vectors. In the above example of a 16×4×4 originating observation vector, these sub-regions would therefore be equivalent to a 8×4×4 field of view, centred on different directions (front, back, right, left). The sub-regions overlap each other. In alternative embodiments, the sub-regions may represent a smaller or larger portion of the observation vector.

The sub-region offset angles 1304a, 1304b, 1304c and 1304d are measured with respect to an axis that corresponds to an overall best matching current observation vector. It is to be understood that determination of the overall best matching current observation vector may be determined by a similar comparison process, performed with, before or after the comparison of sub-regions as set out above.

The overall best matching current observation vector is determined in the same way as a comparison between a stored sub-region and the set of current sub-regions. The only difference is that, instead of a comparison of sub-regions being performed, comparisons of the entire stored observation vector are made against the set of permutations (including rotation and slicing permutations) of the current observation vector. The full stored observation vector (e.g. a 16×4×4 vector) is compared to each permutation of the current observation vector using the observation similarity function and the observation rotation function to determine the best matching current observation vector. These functions, as explained above, provide an index (e.g. the 120^{th} rotation permutation), which corresponds to a best-matching observation vector offset angle, and an associated magnitude, indicating a similarity between the stored observation vector and the best matching observation vector.

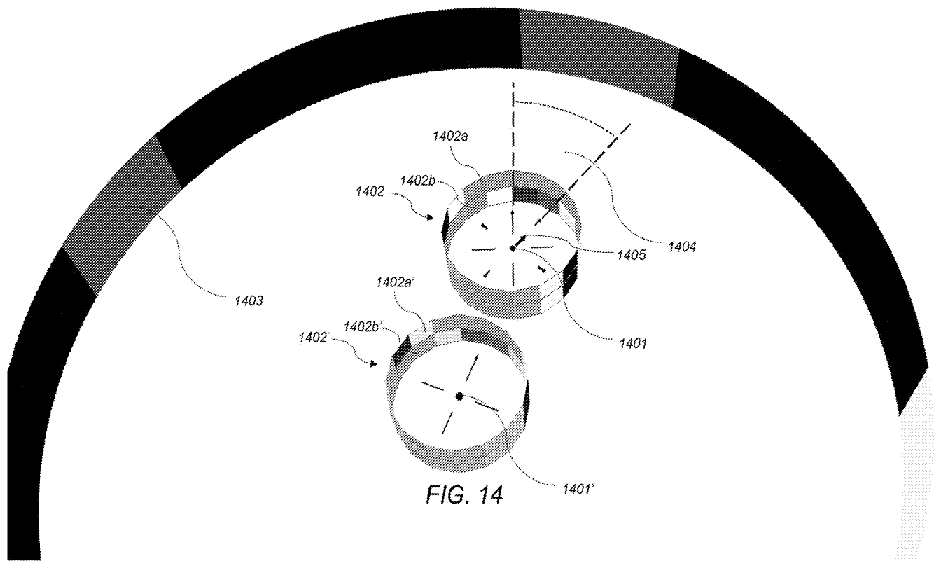

FIG. 14 shows a schematic diagram of the comparison of the complete stored observation vector with each of the set of current observation vectors for the purpose of determining the best matching current observation vector. FIG. 14 shows an agent 1401 at a first location. The agent 1401 is centred in a cylindrical projection 1402 including a green feature channel projection 1402a and a red feature channel projection 1402b. The cylindrical projection 1402 is an illustrative spatial projection of the current observation vector, and shows how the current observation vector describes the environment around a first location of the agent 1401. In particular, the current observation vector describes how a real scene 1403 (i.e. the world) around the agent 1401 at the first location appears. It is to be understood that, although one current observation vector projection is shown, in reality the comparison is performed against an entire set of current observation vectors. Also shown in FIG. 14 is a similar depiction of the agent 1401′ at a second location, together with a cylindrical projection 1402′ including a green feature channel projection 1402a′ and a red feature channel projection 1402b′. The cylindrical projection 1402′ is an illustrative spatial projection of a stored observation vector, and shows how the stored observation vector describes the environment around a second location of the agent 1401′. Although both the current and stored observation vector in this example are only illustrated as comprising two channels, it is to be understood there may be more, such as four channels as exemplified above.

The stored observation vector, indicated by the stored cylindrical projection 1402′ is compared against each possible rotation and slicing permutation of the current observation vector, to find the best match using the observation similarity function and the observation rotation function as discussed above. The observation similarity function returns a magnitude indicating the similarity between a particular current observation vector and the stored observation vector. The magnitude that is indicative of the highest similarity between a specific current observation vector and the stored observation vector (out of the set of current observation vectors) is recorded, and the index of the associated specific current observation vector is also recorded. This index provides a direction of best match 1405. From this, the best matching observation vector offset angle 1404 may be determined with respect to the stored observation vector and the best matching current observation vector. In other words, the best match of the stored observation vector in the set of current observation vectors is determined by comparing, using the scalar product, the stored observation vector to each current observation vector. The index of the best match is recorded and from this the best matching observation offset angle 1404 is deduced.

This best matching observation vector offset angle 1404 indicates a rotation which the agent 1401 may perform at the first location to align itself with the best match with respect to the stored observation vector. Assuming, in the case of FIG. 14, that the stored observation vector was recorded at the co-ordinates (0,0), and that the agent 1401 has moved forwards from its second (original) position when it was at 1401′, the current observation vector represented by the projection 1402 has rotated to the left with the result that its current observation vector at the best matching observation vector offset angle 1404 (measured as an anti-clockwise positive rotation from the forward heading) is the best match to the stored observation vector.

It is to be understood that, since the agent 1401 is capable of recording observations of a wide field of view (e.g. 360 degrees), it is not essential to perform a rotation at this point. Instead, a simple realignment in terms of the axis of the agent (frame of reference) may occur by the best matching observation vector offset angle 1404, such that the direction of best match 1405 is aligned with the axes of the agent for the purposes of comparing sub-regions. This may be done before, during or after sub-region comparison operations. Since sub-regions are generated based on specific directions (they are not representative of the entire field of view), the alignment of the axes of the agent is important to ensure that the sub-regions of the stored observation vector (e.g. front direction, back direction) are appropriately directed (by adjusting the axis by the best matching observation vector offset angle 1404), such that, when the action vector is determined, it is done so based on the sub-region offsets with respect to the adjusted axis.

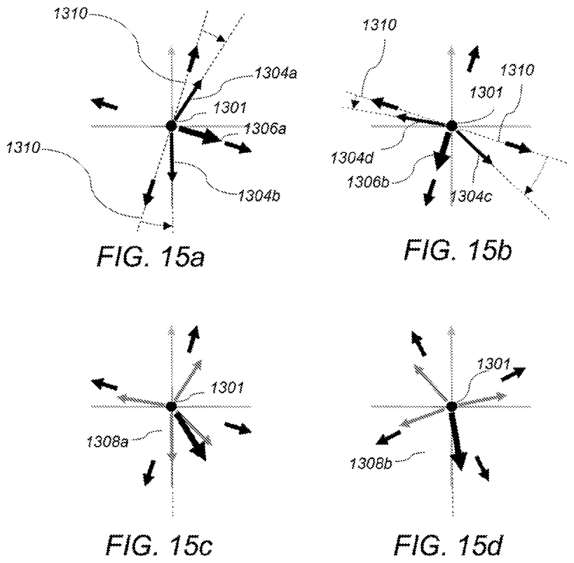

FIGS. 15A to 15D show each of the sub-region offset angles with respect to the axis of the agent 1301. In each of FIG. 15A to 15B, an axis 1310 is illustrated with respect to the agent 1301. The axis 1310 represents the realigned axis, whereby the axis 1310 is realigned based on the best matching observation vector offset angle 1404 resultant from the comparison of the stored observation vector with the best matching current observation vector. FIG. 15A also shows the sub-region offset angles 1304a and 1304b relating to the front and back sub-region comparisons respectively. Similarly, FIG. 15B shows the sub-region offset angles 1304c and 1304d relating to the right hand side and left hand side sub-region comparisons respectively. Once the offsets for each sub-region have been determined in this manner, the direction of the action vector is determined. To determine the action vector direction, a resultant vector is calculated. This process is shown in FIGS. 15A and 15B. In FIG. 15A, the opposing pair of front and back sub-region offsets 1304a and 1304b are used to calculate the front/back resultant vector 1306a. In FIG. 15B, the opposing pair of right and left sub-region offsets 1304c and 1304d are used to calculate the right/left resultant vector 1306b.

The front/back resultant vector 1306a and the right/left resultant vector 1306b are then aggregated to form the final action vector 1308a as shown in FIG. 15C.

It is to be understood that the FIGS. 15A and 15B are intended to illustrate the process of using opposing pairs of sub-regions comparisons to define the front/back and right/left resultant vectors, but in reality, it is not essential to form the resultant vectors and instead the action vector 1308a may be calculated directly from aggregation of all sub-region offset angles 1304a to 1304d. Furthermore, additional sub-regions may be used, centring on different directions with respect to the aligned axis of the agent 1301. For example, FIG. 15D shows a similar diagram to FIG. 15C, but with respect to sub-regions comparisons taken at a 45 degree angle to the front/back and left/right directions. Aggregation of the sub-region offset angles for these different sub-regions provides the action vector 1308b. It is to be understood that these processes provide the direction component of the action vector 1308a and 1308b.

The action vector 1308a direction determined from the front/back and left/right direction sub-region comparisons may be aggregated with the action vector 1308b direction determined from the additional sub-regions comparisons. In the example of a 16×4×4 observation vector, there may be as many as 16 sub-regions that contribute to the determination of the action vector in this way. The action vector 1308a direction and the action vector 1308b direction may be aggregated in any suitable manner to provide the final action vector. In one example, a vector average is calculated to determine the final action vector. Alternatively, the final action vector may be selected as one of the action vector 1308a or 1308b depending on one or more parameters.

The magnitude of the final action vector is determined separately from the magnitudes calculated in the process of performing the observation similarity function for the purposes of identifying the best matching observation vector and the current sub-regions of best match. The final action vector has a magnitude based on the size and direction of the offset angles 1304a to 1304d. As explained above, the offset angles 1304a to 1304d are determined with respect to the axes 1310, which are aligned with the direction of best match 1405. The magnitude of the action vector is determined in components. In particular, a first component is the front/back resultant vector 1306a. This resultant vector 1306a is the component of the action vector in the direction orthogonal to the front/back directions of the axis 1310 as shown in FIG. 15A. The magnitude of this resultant vector 1306a is determined based on the size of the offset angles 1304a and 3014b. The offset angles 1304a and 1304b may be measured in discrete steps, based on the rotation index (e.g., index 4 of 256). The magnitude may be determined by averaging the size of the offset angles 1304a and 1304b, (taking the mean offset angle, in discrete 1/256 steps). This magnitude may be multiplied by a constant, k, that may be modified based on specific scenario requirements. k may be a positive number such as 2, 4, 6, 8, 10 or any other number.

A further aspect of the magnitude determination may include using an additional constant to define an upper limit of use for a particular offset angle pair. In some cases, a large offset angle may be indicative of an erroneous match, or a match between sub-regions that otherwise is unreliable. To prevent such matches being use in the determination of the action vector, the constant j may be set such that, if the mean offset angle between opposing pairs is greater than j, then the magnitude is set to 0. The constant j may be modified and take any value, such as 2, 5, 10, 20, 50 or the like.

The magnitude of the resultant vector 1306b, is calculated in the same way with respect to the offset angles 1304c and 1304d. This provides a further orthogonal component of the action vector, as shown in FIG. 15b. The resultant vectors 1306a and 1306b may then be added to determine the action vector.

If the offset angles for the front/back or left/right directions are both zero, (i.e. the centres of the sub-regions of best match of the current observation vector are the same as the sub-regions of the stored observation), then the magnitude for the relevant orthogonal component is zero. The magnitude follows a relationship wherein greater offsets from the stored sub-regions equate to a higher magnitude. Such a magnitude is found for each opposing pair of sub-region offsets such as the pair of offset angles including the front offset angle 1304a and the back offset angle 1304b, or the pair including the right hand side offset angle 1304c and the left hand side offset angle 1304d. The magnitudes are then combined accordingly as part of a vector average determination when forming the action vectors 1308a and 1308b and the final action vector. The magnitudes of each opposing sub-region offset pair thus provide a weighting to the final action vector based on the size of the offset angles in comparison to the stored subregions. This essentially means that the action vector is weighted more from resultant vectors 1306a and 1306b that originate from larger offsets (offset angles further apart from the aligned axis). This in turn provides a final action vector that points in the direction in which the location in the space at which the stored observation was made is likely to be found, with a magnitude that is indicative of a distance, or effort required to reach this location. The magnitude is also inversely proportional to a confidence level indicative of a confidence that the location associated with the stored observation is in the direction indicated by the final action vector. Larger magnitudes of final action vectors thus indicate a greater effort is required to reach the location, and equally indicate that there is lower certainty that the location is in the direction indicated. Conversely, lower magnitudes indicate less effort is required to reach the location, and that there is a higher certainty that the location is in the direction indicated.

Whilst the magnitude of the action vector is determined based on the offsets of opposing pairs of sub-regions of best match, the similarity magnitudes M_{L}, M_{R}, M_{F}, M_{B} obtained in the comparison of the stored sub-regions with the current sub-regions may still be used in the process. In particular, a weighting may be applied to the action vector magnitude based on the similarity magnitudes of the opposing sub-region pair used to calculate the action vector. Opposing sub-regions with high similarity magnitudes may be weighted so as to increase the action vector magnitude contribution from the particular opposing sub-regions, whereas those sub-regions with low similarity magnitudes may be weighted so as to decrease their action vector magnitude contribution.

Furthermore, the similarity magnitudes M_{L}, M_{R}, M_{F}, M_{B} may also be used in a thresholding operation prior to determining the action vector, to remove or discount any sub-regions from the determination of the action vector. In particular, the similarity magnitude for each sub-region comparison may be compared to a definable confidence threshold, which may be, for example, 0, 0.1, 0.5 or any other number. If the similarity magnitude does not match or exceed the confidence threshold, then the sub-region comparison to which it corresponds is not used in the determination of the action vector. As above, it is to be understood that there may be more similarity magnitudes and sub-region directions used in the determination of the action vector than the similarity magnitudes M_{L}, M_{R}, M_{F}, M_{B}.

The final action vector may be used either in isolation or with any other function or method described above to determine how to move the agent towards the stored observation corresponding to the stored observation vector. For example, the action vector may be used in the movement function to relocalise the agent to a predicted observation, and may be use in addition to displacement data or relocalisation techniques as shown in FIG. 7.

The observation action function is a useful tool for navigation, as it provides an action vector, along which the agent may move to reach a destination indicated by the stored observation vector. By storing multiple observations of a particular space, an agent is able to navigate the space using the action function iteratively for a plurality of stored observations associated with that space. The action function is relatively resilient to minor environmental changes, since multiple sub-regions are used in the determination of the action vector, and the sub-regions themselves are pre-processed to reduce the sensor data information to its most fundamental components (edges, distinct features etc.).

As briefly outlined above, the action vector with respect to a stored observation, determined from comparison with a current observation, may be used to generate a map or a part thereof. The map may include data regarding action vectors and/or data regarding similarity magnitudes for stored observations. The map may be generated as a connected series of observations (nodes), and may include displacements linking observations. The map may be stored as an array or series of arrays that spatially correspond to each other, whereby each array comprises a different dataset. Each array may form its own map, or may contribute as part of an overall map.

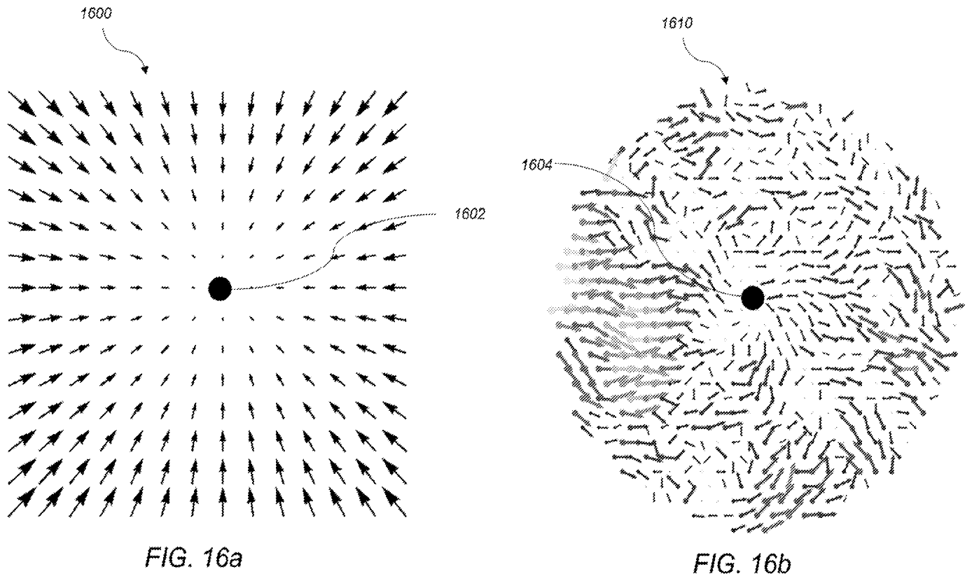

FIGS. 16a and 16b show first and second vector field 1600 and 1610 respectively, formed from action vectors calculated with respect to a stored observation at locations 1602 and 1604 respectively. FIG. 16a represents a theoretical vector field for action vectors with respect to the stored observation at the central location 1602. The vectors, represented by arrows, each point in the direction of the stored observation and with a magnitude that is proportional to the distance from stored observation location 1602. FIG. 16b is a realistic vector field for action vectors with respect to the stored observation at the central location 1604. In this example, many action vectors still point in the direction of the stored observation, but some point in other directions and with varying magnitudes. The realistic vector field 1610 may form a first part of a map, and may be stored in an array, for example.

Each action vector is determined from a comparison between a current observation, at a location in space, and the stored observation, at the specific position 1602 and 1604 as illustrated in FIGS. 16a and 16b. To populate the vector field, when a comparison is made between a current observation and the stored observation (to obtain the action vector), the action vector is added to the vector field at the current location (the location corresponding to the current observation being compared). Although the global location corresponding to the current observation may not be known, the local position of each current observation and corresponding action vector may be determined with respect to the other current observations and action vectors already present on the vector field 1610. In particular, as explained above with reference to displacements, odometry, such as visual or inertial odometry, may be used to determine the relative positions of consecutively made current observations. By mapping consecutive current observations over distances over which are small relative to the precision/accuracy of the method of odometry, the inherent drift in odometry is not problematic. This means that the action vectors may be used to populate a map (vector field) whereby the distances between vectors is substantially accurate. To increase the accuracy of the map in terms of the locations of action vectors, the distances travelled by the agent between current observations should be reduced.

Since each of the action vectors corresponds to a particular stored observation, the resulting vector field map is effectively made in the coordinate frame of the particular stored observation. In this manner it is not necessary for the absolute locations (in the world reference frame) of the stored observation, or of the current observations, to be known.

When enough comparisons have been made to the stored observation at the location 1602, 1604, the vector field is capable of being used by an agent to navigate towards the stored observation. However, the action vectors may not be uniform or accurate, as shown in the vector field 1610, and when a vector field is comprised of vectors of random length and orientation, then the agent may have to perform a randomised walk around the location 1604 to find an action vector that points to it. If, instead, the vector field comprises vectors pointing directly at the target location 1604 with high accuracy, the agent would be able to navigate by the shortest path. It is thus beneficial, when using the action vector as the characteristic to generate a map, to have a vector field that is uniform and reliable. Since the vector field depends on comparisons between the stored observation and several current observations, the reliability of the vector field is synonymous with reliability of the stored observation.

A reliable stored observation is considered as one which has an effective action vector field whose vectors always direct the agent along a path leading towards the target.

The map may be used to test the reliability of a stored observation thereon. When the map includes data regarding action vectors, such as a map including the action vector field, the reliability of a stored observation may be tested according to several methods.

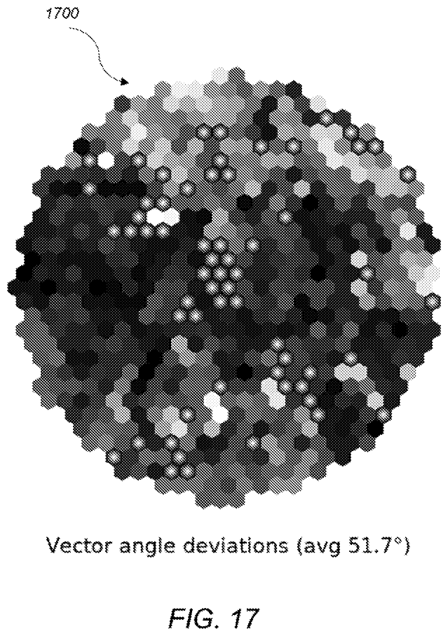

In a first method, the angular deviation between each action vector in the action vector field and vectors in a radially converging field (such as that shown in FIG. 16a) are summed and averaged to give a scalar measure which is inversely proportional to the reliability of the stored observation. FIG. 17 shows a visual representation 1700 of the vector angle deviations for each action vector, with black hexes corresponding to low deviation from the ideal radial field and white hexes corresponding to maximum possible deviation (pi radians/180 degrees). “Starred” hexes correspond to locations where the action vector is zero. The example in FIG. 17 gives an average deviation of 51.7 degrees. A larger average deviation is indicative of a less reliable stored observation, whilst a lower average deviation is indicative of a more reliable stored observation.

In a second method, a calculation is performed to determine the number of locations in the action vector field at which it is impossible to compute an action vector divided by number of locations at which this is possible. In an example scenario, it may not be possible to calculate an action vector when the offsets that are used to compute the action vector all cancel out during the computation of determining the action vector. The division of the number of locations in the action vector field at which it is impossible to compute an action vector by number of locations at which this is possible is a measure which is inversely proportional to the reliability of the stored observation. In the example of FIG. 16b, 10% of the locations in the vector field 1610 corresponded to places where it was not possible to calculate an action vector. In this instance, the measure is equal to 1/9 (10%/90%), which may indicate a reasonably reliable stored observation. A larger number means that the stored observation may be less reliable.

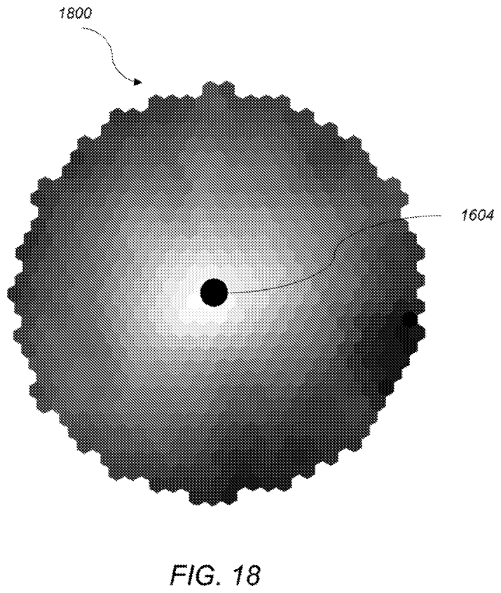

The map may additionally or alternatively include data regarding similarity magnitudes with a stored observation vector, such as a map including a similarity magnitude field, obtained from using the observation similarity function as described above. This data may be stored in an additional array. FIG. 18 shows an example of a realistic similarity magnitude field 1800. This is a scalar field, and each of the data points represent the magnitude returned from applying the observation similarity function to find the similarity between a particular current observation vector and the stored observation vector. As with the vector field described above, the location corresponding to each current observation is determined using odometry. The similarity magnitude value between a current observation and the stored observation may be determined at the same time, or during the same process as determining the action vector, such that the current observations are the same.

FIG. 18 shows the scalar field around the location 1602 of the stored observation (the same stored observation as FIG. 16b). The lighter coloured hexes in this scalar field indicate higher magnitude values returned from performing the observation similarity function for current observations that are closer and thus more similar to the stored observation at the location 1602. The darker regions indicate lower magnitudes. As can be seen from FIG. 18, generally, the scalar magnitude values in the scalar field are greater in the vicinity of the location 1602 of the stored observation. The magnitude similarity scalar field spatially corresponds to the action vector field, such that both of these datasets or arrays can be combined to together in an overall map.

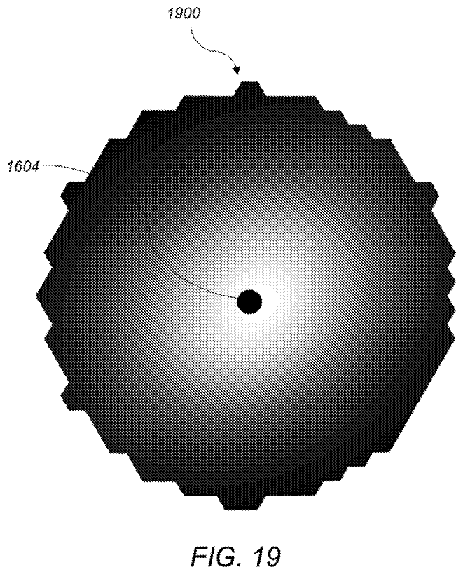

The scalar similarity magnitude field 1800 may be used to form a parameterised model 1900 of the scalar similarity magnitude field. The parameterised model 1900 is a smooth approximation of the real field 1800, and is fitted according to one or more characteristics of the real field 1800. An example parameterised model of the scalar similarity magnitude field 1800 is shown in FIG. 19. In particular, FIG. 19 shows a model field 1900 for similarity magnitude, which exhibits a smooth and consistent change as the field approaches the stored observation location 1604 at the centre of the field. As with FIG. 18, white indicates a high similarity magnitude, and darker regions indicate a lower similarity magnitude. The parameterised field 1900 usefully allows data from the real field 1800 to be extended without the need to take additional measurements or additional current observations.

Parameters for the model of the similarity magnitude field may include the maximum similarity, the shape or form of the slope measured with respect to distance from the location and the circular or elliptical form of the field. An example of a parameterisable model is a centred, rotated, two dimensional elliptical Gaussian, g(x, y), where:

$$g ( x , y ) = O + M exp ( - {ax}^{2} + 2 bxy + {cy}^{2} ) \\ a = \frac{{cos}^{2} θ}{2 {σ}_{x}^{2}} + \frac{{sin}^{2} θ}{2 {σ}_{y}^{2}} \\ b = \frac{sin 2 θ}{4 {σ}_{y}^{2}} - \frac{sin 2 θ}{4 {σ}_{x}^{2}} \\ c = \frac{{sin}^{2} θ}{2 {σ}_{x}^{2}} + \frac{{cos}^{2} θ}{2 {σ}_{y}^{2}}$$

Here, the fiver parameters are: O, a scalar offset; M, a multiplier on the Gaussian hill which has standard deviations; σₓ; σ_{y}; and an angle of rotation θ.

Any standard optimization method may be used to find the parameters that fit the model g(x,y) to the data f(x,y) minimising an objective function o, of the form:

$$o = {\sum }_{i} {[ f ( {x}_{i} , {y}_{i} ) - g ( {x}_{i} , {y}_{i} ) ]}^{2}$$

In the example illustrated in FIG. 19, the Nelder Mead Simplex method was used.

For a stored observation, the map may comprise one or both of the action vector field and the scalar similarity magnitude field.

In terms of the similarity magnitude field, a reliable stored observation is considered as one which has a consistent scalar field which, on repeated approaches, will allow the agent to identify that it has arrived (for example by testing to see if the magnitude has exceeded a threshold).

The reliability of a stored observation on a map including the similarity magnitude field may be tested according to some additional methods.

A third method of testing the reliability of the map and the stored observation thereon includes computing the modelled maximum similarity magnitude, divided by the mean similarity magnitude of the parameterised model of the similarity magnitude field. A large value of computation indicates that the stored observation can be unambiguously recognised, (as it is distinct from the mean similarity magnitude of the modelled field). As such, the measure provided by this computation is proportional to the reliability of the stored observation. In the example of FIG. 18, this measure is calculated as 1.32. This third method may thus also be applied to the real field 1800 or the parameterised field 1900.

A fourth method of testing the reliability of the stored observation includes determining the cumulative deviation from the similarity magnitude scalar field with the parametrised model of the similarity magnitude field. This requires the determination of the variability in the similarity magnitude and the comparison of this variability with the best fitting parameterised model. A more variable, less smooth surface makes the probability of recognising a false location as the location of the stored observation more likely. This value maybe be used as an objective function in optimisations to find the best model fit when improving or updating the parameterised model. As with the third method above, this fourth method can be performed on either the parameterised model 1900 or the real field 1800.

Each of the above four methods of testing the reliability of the stored observation in a map may be used individually or in combination. In some example, one or more of the first or second method (with respect to the action vector field) are used in combination with one or more of the third and fourth methods (with respect to the similarity magnitude field). Combining measures determined from these two fields provides a more reliable determination of the reliability of the stored observation. The measures from the methods of determining reliability may be combined in any suitable manner, and contributions from each method to an overall measure may be weighted according to application-specific requirements.

The measure of reliability of the stored observation may be recorded and associated with the stored observation in a map. The map may include one or more of the action vector field and the similarity magnitude field, or data therefrom. For example, a map of multiple stored observations may include the vector field in a limited vicinity around each stored observation, and optionally data points or contour lines in the vicinity of each stored observation corresponding to the similarity magnitude data or the parameterised model thereof.

The measures of reliability may be used to determine whether it is necessary to discount a certain stored observation from the map (if the stored observation is unreliable), or if a repeat measurement/recording of the stored observation is required to improve its reliability. This may be done using one or more reliability thresholds. The reliability thresholds may be compared against one or more of the measures determined form the first to fourth methods of testing reliability set out above. For example, the second method above, which returned a value in the example provided of 1/9, may be compared to a reliability threshold. The reliability threshold may be adjusted, and may be 1 in this example, meaning any stored observation for which a vector field only includes ½ or fewer action vectors of the total possible action vectors will be deemed unreliable.

The unreliable stored observations may be removed from the map, or an agent may be instructed to recapture and store the observation in order to obtain a more reliable observation.

Once the reliability of a stored observation, in terms of the similarity magnitude field and/or the vector field associated with that stored observation is confirmed, this stored observation and the associated fields may be used to improve the determination of the location of an agent. It is also to be understood that the vector field and the similarity magnitude field may be used to determine the location of the agent even if the reliability is not pre-checked.

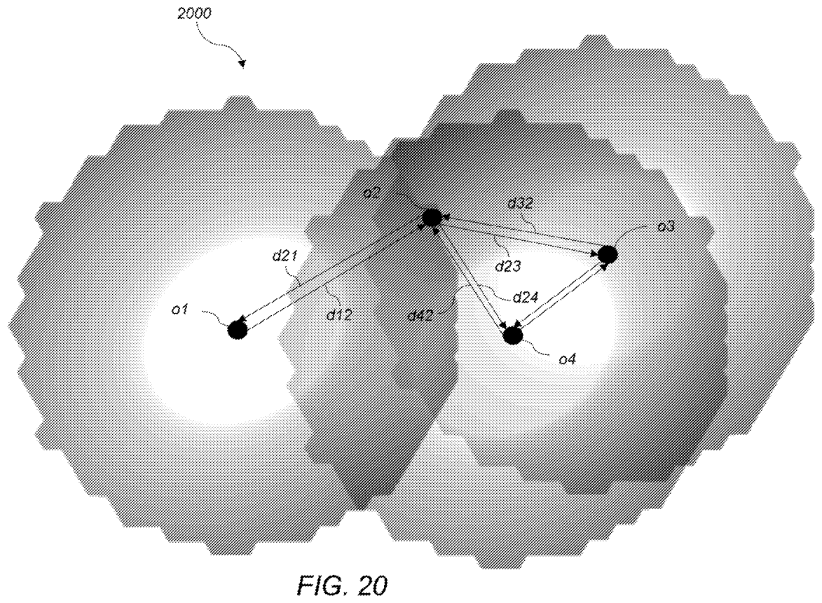

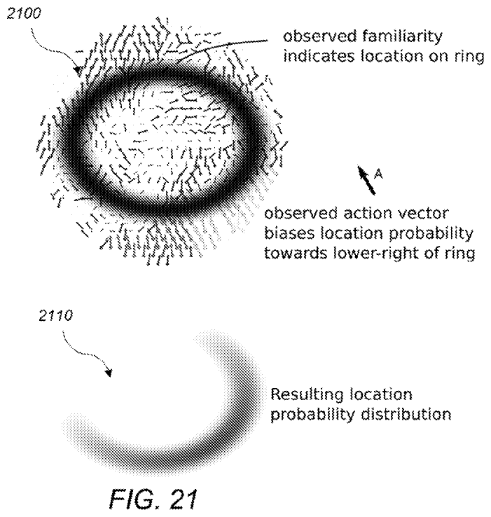

The action vector field and the similarity magnitude field form two of several modalities that may be used to determine the location of the agent. Specifically, these modalities may include one or more of: action vectors or action vector fields with respect to stored observations; similarity magnitudes or similarity magnitude fields with respect to stored observations; displacements between stored observations and data regarding the stored observations themselves. The map may combine these different data sets. For example, the map may comprise data regarding a series of observations and displacements such as those illustrated in the identity 800 of FIG. 8, a vector field for each stored observation such as the vector field 1610 shown in FIG. 16b, and a scalar similarity magnitude field for each stored observation such as the field 1800 of FIG. 18 or the parameterised field 1900 of FIG. 19. An example of this is shown in FIG. 20, which shows a map 2000 including displacement data and observation data from FIG. 8 and similarity magnitude field data from FIG. 19. It is to be understood that action vector field data may also be present in the map in the vicinity of stored observations o1 to o4. The stored observations in the map may be referred to as ‘nodes’. For each node, a surrounding magnitude similarity field is illustrated. These magnitude similarity fields overlap each other. It is to be understood that the magnitude similarity fields may be extrapolated according to parameterised model to lesser or greater distances from the node than illustrated in FIG. 20. The map 2000 is built such that it is a topographically correct map, meaning the relationship between nodes is correct. It is not necessary for the exact angles and distances between nodes to be completely accurate. The map 2000 may be constructed using the one or more modalities/datasets by generating a probability distribution for each dataset, evaluated at discrete locations on a grid representing the local area of an agent. The local area may be defined depending on the scenario, and may thus be in the range of 1 square meter, 10 square metres, or 100 square metres, for example. The map 2000 may thus be considered as an array or grid, whereby each cell or grid square comprises data corresponding to each of the datasets used to form the map.

The following discussion of improving the determination of the location of an agent refers to ‘modes’. These are synonymous with methods or processes but are named as such to avoid confusion with the various methods set out above. The following discussion also refers to several modalities, including similarity magnitude values, ratios, action vectors and odometry values. Each of these may be referred to as ‘location measures’.

The following discussion also refers to locations, which are synonymous with positions. Similarly, locations in each of the following arrays may be referred to as ‘field positions’.

It is further to be understood that each of the following modes may be applied to more than one stored observation. In this case, a location of an agent may be determined from a plurality of stored observations, wherein each stored observation is associated with the performance of one or more modes (and one or more of their associated arrays). Thus, each stored observation may correspond to a respective set of arrays, and the set of arrays from multiple stored observations may be combined to determine the location of the agent.

A first mode of improving the determination of the location of an agent in a space according to the generated map of the space uses the similarity magnitudes and thus the similarity magnitude scalar field for one or more stored observations. In this first method, a first array is generated from the parameterised model of the similarity magnitude field. The measured similarity magnitude with respect to a particular stored observation can be used to narrow down the distribution of possible locations of the agent, by using a model of how the similarity magnitude changes as a function of distance, and to a lesser extent angle, from the stored observation. For example, consider the case wherein the similarity magnitude declines linearly from 1 to 0.5 over a distance of 1 meter from the stored observation location, the similarity magnitude is radially symmetric, and the agent observes a similarity magnitude of, for example, 0.75 with respect to that particular stored observation. In this case, it may be determined that the agent is a radial distance of 0.5 m from the location of the stored observation. Thus, the similarity magnitude with respect to a stored observation can locate the agent to be on some contour (in this example, a circle) around stored observation. The first array thus may be used in a similar way to an elevation model. Connected cells or entries in the array that are within a specific range of values of each other are considered to be on the same ‘contour’. The specific range may be 0.01, 0.05. 0.1 or the like, in terms of the similarity magnitude value. Alternatively, only cells having the exact same similarity magnitude value are considered p[art of the same contour line. Each contour line may be determined and labelled as such, using any suitable algorithm. For example, a clustering algorithm may be used. In this manner, the first array may represent a series of contours, each corresponding to equally spaced ranges of similarity magnitude values, whereby the contours surround the stored observation. When a new current observation is compared to the stored observation, and a new similarity magnitude value is determined, the first array may be used to narrow down the possible locations of the agent to somewhere on the contour in the first array which has a range including the new similarity magnitude value.

If the agent is also close enough to other nodes (other stored observations) to compute a similarity magnitude (i.e. it is within the radial scalar field of other stored observations), then it can also perform the same operation with respect to those nodes. With determinations with respect to two nodes (a first and a second stored observation), a new similarity magnitude value can be used to determine the possible locations with respect to a first contour for the first of the two nodes, and a second contour with respect to the second of the two nodes. In this case, the possible locations can be narrowed down further to the areas or locations where the first and second contours intersect. If the models of the similarity magnitude fields are perfect, the two contours representing the possible locations with respect to each of two nodes may meet at a single point, and as such precise localisation can be achieved using only two nodes. However, this is unlikely to be the case. If the model of the similarity magnitudes fields is imprecise, the two contours will either not meet at all or overlap, yielding two possible locations.

If the agent is within the similarity magnitude field of three nodes, the agent can locate itself more precisely, effectively using three contours, since the intersection of three rings yields a single point in space. In an example, this may be done using a parametrised conical model of the similarity magnitude field for each of the three nodes. However, it is to be understood that any arbitrarily complex parametrised model of the real similarity field may be used as required; a 2D Gaussian with covariance for example, or a discretised sampling approach combined with interpolation, if the field is more varied. Moreover, the real similarity magnitude fields may be used.

The first mode includes building the first array which may be used in the map 2000, using the similarity magnitude as an input dataset. To build the first array, firstly, a predicted similarity magnitude landscape/the real fields are created for each node.

The first array, which may include the real fields for multiple nodes, may be used to obtain a further estimate of the agent's location. In particular, at each of the discretised locations in the local area, a parameterised model of the node's similarity magnitude field may be used to predict what the similarity magnitude contribution would be at that location. Using this estimate, which may be extended at locations further than those directly sampled, for instance, when forming the similarity magnitude scalar field for each node, the method then determines, at every discrete location, the absolute value of the difference between the observed similarity magnitude and the estimate of the similarity magnitude at that location. This difference is recorded and the process repeated at each of the discrete locations by the agent. Each of the recorded differences are recorded in an array which yields a landscape in which the agent's most likely locations are those for which this difference is nearest to zero. The difference may be inverted by performing the sum: 1−difference, such that the agent's most likely location is where the difference(s) are closest to 1. As explained above, this method may be repeated for more than one node (the nodes visible to the agent). As such, multiple first arrays may be generated for corresponding multiple stored observations, and combined thereafter.

This localisation method relies on the accuracy of the agent's model of the similarity magnitude fields of nearby nodes. Since this model is unlikely to be precisely accurate, a probabilistic approach is taken, and puts each value in the generated array through a sigmoid function, asymptoting to zero at low values and plateauing at one at higher values (those closer to one). This has the effect of spreading out the area containing the most likely locations of the agent given the model.

This array, altered by the sigmoid function, is then finally turned into a probability distribution by normalising the area under the landscape to one by dividing each element of the array by the sum of all elements.

A second mode of improving the determination of the location of an agent in a space according to the generated map of the space also uses the similarity magnitudes and thus the similarity magnitude scalar field for one or more stored observations. In this second mode, a second array is generated from the parameterised model of the similarity magnitude field, but may also be generated from the real fields themselves.

The similarity magnitudes around any given node may alter as the environment changes. For example, changes in global luminance may reduce the maximum observed similarity magnitude of all nodes. If the observed similarity magnitude is low because the luminance has changed, the localisation procedure according to the first mode and first array described above will predict that the agent is further from the node than it in fact is.

To partially mitigate the risk of global changes in the similarity magnitude, the ratio between the observed similarity magnitudes with respect to pairs of nodes may be used. For a given observed value of the ratio between two similarity magnitudes, corresponding to two nodes, the agent could be on a front somewhere between the two nodes. For a pair of nodes that both have identical radially symmetric similarity magnitude fields, this front will be a straight line perpendicular to the straight line joining the two nodes. However, the front could be more complex if the similarity magnitude fields of the nodes are more complex.

To build the second array, firstly, a single estimated similarity magnitude ratio landscape is created for each pair of nodes. At each of the discretised locations in the local area of the map, the estimated similarity magnitude of the first node (obtained from the first mode above) is divided by the estimated similarity magnitude of the second node. Then, at every discrete location, the absolute value of the difference between the observed similarity magnitude ratio and the estimated similarity magnitude ratio at that location is calculated. This yields a landscape in which the agent's most likely locations are those for which this computation is nearest to zero. As with the first mode above, computing one minus this array, element-wise, modifies the array such that the most likely locations are now those closest to one.

As with the first mode set out above, this localisation method also relies on the accuracy of the agent's model of the similarity magnitude fields of its nearby nodes. Since this model is unlikely to be precisely accurate, the second mode takes a probabilistic approach and puts each value in the input array through a sigmoid function, asymptoting to zero at low values and plateauing at one at higher values (those closer to one). This has the effect of spreading out the area of most likely locations of the agent given the model.

Lastly this is turned into a probability distribution by normalising the area under the landscape to one by dividing each element of the array by the sum of all elements.

This second mode is thus similar to the first, but uses the ratio of similarity magnitude values rather than the values themselves, as the ratio between nodes should stay largely constant regardless of global luminance changes and other global environmental changes.

A third mode of improving the determination of the location of an agent in a space according to the generated map of the space uses the action vector field. Observations of action vector fields have shown that they point inwards towards the node with high probability. In other words, the angle between the radius emanating from the node and the action vector is typically in the interval [−90, 90]. Whilst, on its own, this fact does not provide a hard constraint on location, it can be used to effectively halve the number of possible locations identified by the similarity magnitude field, which only constrains the location to a ring surrounding the node. By using a combination of the action vector field and the similarity magnitude field, the possible locations of the agent may thus be reduced. This process according to the third mode is illustrated in FIG. 21.

FIG. 21 shows a first visual representation 2100 of an action vector field overlaid with a ring corresponding to an observed similarity magnitude contour. The similarity magnitude contour is obtained by enacting the first mode above with respect to a single node. Without the presence of the action vector field, the agent may be at any location on the contour ring. A second visual representation 2110 shows the result of combining the observed similarity magnitude with the observed action vector. The observed action vector indicates a direction A. Combining the direction A with the ring of the observed similarity magnitude can provide a location probability distribution which indicates that the location of the agent is most likely to be in the lower-right of the contour ring as illustrated, due to the direction A of the action vector. Moreover, the location is less likely to be in the top left of the ring as illustrated, because action vectors usually point towards the node, which in this case is in the centre of the ring.

The above first, second and third modes may be combined to determine a most likely location of the agent. This location is represented by the summation of the first second and third arrays above, namely; the difference between the observed similarity score and the predicted similarity score for each of the nodes in agent's current view; the ratios of the similarity scores between each pair of nodes in the current view of the agent; and the action vectors with respect to each of the nodes. The most likely location of the agent is given by summing up the contributions from each of the above modes at each of the discretised locations. This array is then normalised by dividing each element by the sum of all elements. This is hereafter referred to as the “likely location array”.

A fourth mode of improving the determination of the location of an agent in a space according to the generated map of the space uses odometrical information. This may be in the form of physical odometry recorded by an odometer, virtual odometry in terms of pixels or data cells, or visual odometry. The odometrical information may be determined from or be the same as the displacements determined according to the methods previously described above. The odometrical information may be stored together with any of the other datasets in the map and may be used to localise the agent to a nearest observation as explained above with reference to FIG. 7. When odometrical information becomes available to the agent, the likely location of the agent may be updated to account for this new information. This is done as follows.

The use of odometrical information may be used to form a fourth array. In the case where there is no displacement data (as described previously), the fourth array is generated using odometrical data. This fourth array is generated by augmenting the above first, second, third or the ‘likely location’ array. The use of odometrical information effectively updates the estimate of the location of the agent.

The odometrical information is obtained using any suitable technique, over a time-step from a previously determined position. In particular, velocity components over the time step are integrated to obtain a distance travelled in two or three dimensions as appropriate. The first, second, third or ‘likely location’ array above, (e.g., the second visual representation 2110 providing a location probability distribution, or the probability distribution of the first or second arrays, or a combination thereof) are then modified according to the odometrical information (the distance travelled) to model the uncertainty in the possible locations of the agent.

The fourth array is an augmented array that is created by populating cells, for each non-zero element of the particular array that is to be augmented, with values computed from a two-dimensional Gaussian wherein the mean is the previous location plus the change in location computed from the odometry data, and the covariance is that given by the odometry data. This entire array is multiplied element-wise by the value of the original element of the array to be augmented. This results in each element of the original first, second or third or ‘likely location’ array being translated into a full array of values describing a 2D Gaussian hump, based on the odometrical values. Alternatively, the contributions of each of the elements from the first, second or third arrays (i.e. the ‘likely location’ array) are summed with the corresponding odometrical data to create a new array that has now been updated according to the odometry data. The single hump is shifted in two dimensions by the distance travelled and warped according to the covariance. This provides the fourth array, which is effectively any combination of the first to third array modified to account for the probability of the location of the agent given its odometry. Although a gaussian distribution is exemplified above, any suitable distribution for the odometrical data may be used.

The fourth array may be referred to as an ‘odom updated array’, and represents the agent's best estimate of its current location. When the agent later receives new information regarding the similarity magnitudes and action vectors with respect to all the nodes within its view, it recomputes the likely location array in the manner described above. This is then multiplied by the odom updated array to yield an updated estimate of the agent's location based on a combination of the new observations (expressed in the likely location array) as well as its previous estimate of its location (expressed in the odom updated array).

The above first to fourth arrays may be used in any combination. It is however to be understood that, since the third array (using action vectors) effectively adjusts one of the first or second arrays, the third array should be used with at least one of the first or second array. Similarly, the fourth array is an augmentation of the first, second, third or fourth arrays, and as such, the fourth array may be used with at least one of the first to third arrays.

In an example combination method of improving the determination of the location of an agent in a space according to the generated map of the space, each of the first, second, third and fourth arrays outlined above may be used.

In a first step of the combination method, the agent identifies all nearby nodes, by measuring similarity magnitude values and identifying nodes as ‘visible’ if these values are above a baseline value. If the list of visible nodes has changed since the previous iteration the agent computes similarity magnitude fields for the newly visible nodes, and similarity magnitude ratio fields for the new pairs of visible nodes. An array is generated for each of the visible nodes according to the first mode above. More arrays are generated, one for each pair of visible nodes according to the second mode above. A further set of arrays are generated according to the third mode.

This may include the making of a plurality of current observations and recording the locations of the current observations using odometry, and the associated action vector and/or similarity magnitude values.

In a second step, all of the arrays are summed element-wise and the resulting array is normalised. Each element is then compared to a low threshold. All elements below a low threshold are set to zero. This reduces the number of computations in the odometry step described in the section above, since only non-zero elements are considered. If the position is known with high accuracy, the number of non-zero elements should be small, thus the number of elements whose positions need to be updated is small, which is computationally efficient.

This produces a ‘resultant’ array, which is then renormalised in a third step by dividing each element by the array sum. This results in a discretised landscape (representing the probability of the agent being in each of the locations in the discretised field the likely location array). This landscape can be arbitrarily complex. A benefit of this method is that no assumptions need to be made about the statistical structure of the inputs.

In a third step the likely location array is transformed according to new odometrical data using the method described in the fourth mode above (the odom updated array). Thus the agent's belief about its location is continuously updated in an iterative fashion, with its prior belief about its location being multiplied by new measurements as they are observed.

The likely location array or the odom updated array can be used as they are for localisation in certain circumstances, however it is useful to compute a summary statistic of the agent's most likely location along with a measure of position uncertainty. This can be achieved by fitting a 2D Gaussian to the output array, with the peak of the Gaussian being the position estimate and its covariance giving the uncertainty in the estimate.

An alternative approach includes taking the centroid of the output array, where the weight contributed by each location is simply the value of the output array at that location. The measure of confidence in the location is then given by the value of the output array at the centroid location. Broad and flat output arrays result in a low peak at the centroid, whereas high certainty in location results in a sharp and tall output array with a high maximum value. This approach works well if the output array is a single contiguous hump, but is less accurate if it is more complex (for example, the centroid of a doughnut-shaped landscape is the centre of the doughnut, where the probability is very low).

In a second alternative, an estimate of the location can be arrived at by using the output array as an input to a “neural field” of the same dimensions, in which each neural element inhibits all the other elements in proportion to its value. As such, high valued elements impose large amounts of inhibition on their neighbours and drive their values towards zero, until only one or two elements remain. The location of these remaining, active elements is the best estimate of the agent's location. This approach avoids the pitfalls in the centroid method but is slightly more computationally expensive.

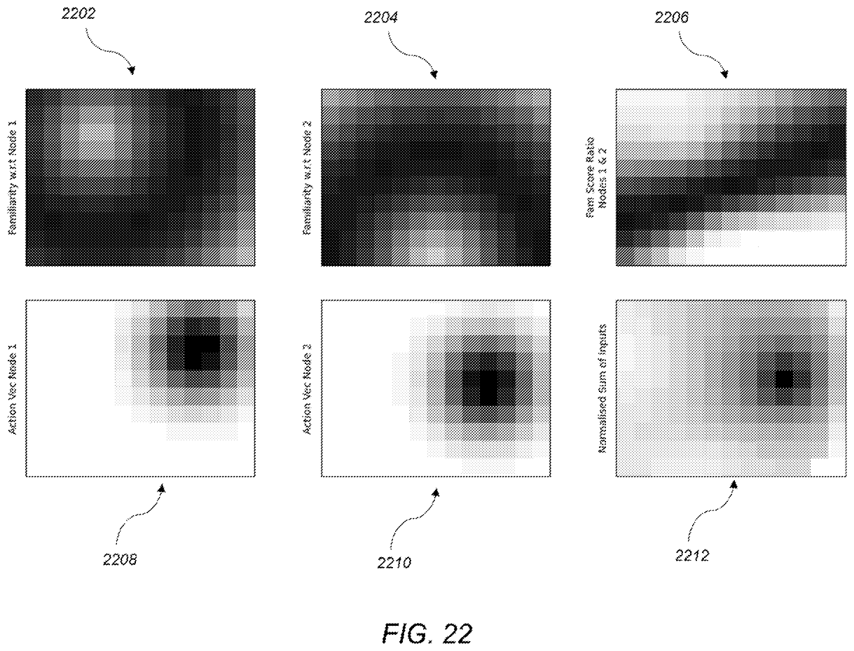

FIG. 22 shows a visual representation of the formation of the output array, from the first and second arrays as inputs.

In an upper-left array 2202 (as illustrated in FIG. 22), the similarity magnitude field is used to create a first array according to the first mode outlined above. The upper-left array 2202 is a discretised probability density function of the agent's location given the similarity with ‘node 1’—which is the node seen by the agent as being above the baseline. Dark pixels indicate regions of higher probability.

Similarly, in an upper-middle array 2204, the similarity magnitude field is used to create a first array according to the first mode outlined above. The upper-middle array 2204 is a discretised probability density function of the agent's location given the similarity with ‘node 2’—which is another node seen by the agent as being above the baseline. Dark pixels indicate regions of higher probability.

An upper-right array 2206 indicates a second array generated according to the second mode as set out above. Given the ratio of the similarity magnitudes between node 1 and node 2, the agent can localise itself to somewhere on a front between the two nodes, as is shown by the dark pixels in the upper-right array 2206.

A bottom left array 2208 is generated with respect to the third mode above, and shows how action vectors provide a noisy estimate of the agent's location with a wide variance. The bottom left array 2208 is generated with respect to node 1.

A bottom middle array 2210 is generated with respect to the third mode above, and shows how action vectors provide a noisy estimate of the agent's location with a wide variance. The bottom middle array is generated with respect to node 2.

A bottom right array 2212 shows the element-wise sum of all the input arrays 2202 to 2210. The resultant array is normalised such that the volume under the landscape is one. Thus, the bottom right array 2212 represented in FIG. 22 is the probability density function of the agent's location, referred to as the likely location array above. This likely location array can then be translated according to the velocity components from an odometry signal as outlined in the odometry section above.

In an example of the process of forming the likely location array, assuming that there are parameterised similarity magnitude field models for two or more observations at different locations, fᵢ(x) is a model parameterised by a parameter set pᵢ which predicts the similarity at a location x with respect to an ith observation. fᵢ⁰(x) is the observed similarity at x with respect to observation i. Using these models for i=1, . . . , N, where N is the number of observations, the following fields can be derived:

$${h}_{i} ( x ) = S ( 1 - \vert {f}_{i}^{o} ( x ) - {f}_{i} ( x ) \vert )$$

Where S is a squashing function with a sigmoid-like shape and an output in the range [0, 1]. The squashing function incorporates knowledge about the uncertainty in the model (it ‘blurs’ the function). h_i(x) is the function shown in the upper-left array 2202 and upper-middle array 2204 of FIG. 22.

$${g}_{i , j} ( x ) = S ( 1 - \vert \frac{{f}_{i}^{o} ( x )}{{f}_{j}^{o} ( x )} - \frac{{f}_{i} ( x )}{{f}_{j} ( x )} \vert )$$

is the function shown in the upper-right array 2206 of FIG. 22.

The functions shown in the bottom left array 2208 and the bottom middle array 2210 of FIG. 22 are named kᵢ(x) and relate to action vectors aᵢ(x), which are assumed to be a prediction of the location of the observation i from location x:

$${k}_{i} ( x ) = \frac{- det ( C )}{2} - \frac{{( - {a}_{i} ( x ) )}^{T} C ( - {a}_{i} ( x ) )}{2}$$

The covariance matrix, C, specifies the estimated uncertainty in the action vector a. Here, it is assumed that uncertainties in the action vector's components are normally distributed. The normalised sum of inputs is then the probability distribution of the location based on the available evidence:

$$Φ = \frac{{\sum }_{i , j} {h}_{i} + {g}_{i , j} + {k}_{i}}{\int {\sum }_{i , j} ( {h}_{i} + {g}_{i , j} + {k}_{i} ) dx}$$

Although the above combination method involves combining the first to fourth modes above, it is to be understood that improving the determination of the location of an agent in a space according to the generated map of the space may involve using one or more of any of the first to fourth modes set out above for improving the determination of the location of an agent.

The utility of the above methods and modes concerning of improving the determination of the location of an agent in a space according to the generated map of the space depends on the accuracy of the first, second, third and fourth modes, and the arrays (i.e., parts of the map) that are generated. As such, it is beneficial for the agent to regularly update the arrays for each node as it visits them by sampling the magnitude similarity scalar field and the action vector field and tracking local position changes using odometry.

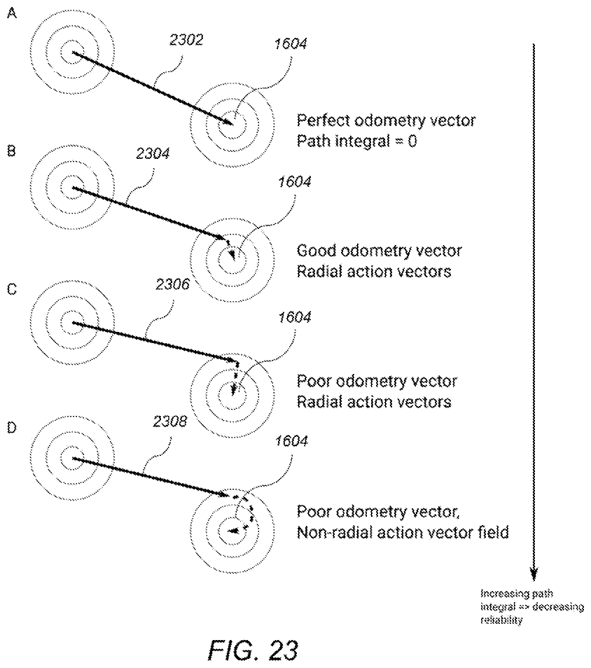

The map 2000, or any one or more the first to fourth arrays generated as set out above may also be used to perform reliable edge traversal. A reliable edge traversal combines the displacement (or other odometry vector) and optionally any suitable navigation algorithm for edge traversal. A perfect traversal between two nodes would see the agent follow the displacement or odometry vector and at its end it would be at the peak/centre of the magnitude similarity field and the action vector field. This is illustrated in FIG. 23, part A, which shows a schematic of a map of an area comprising a target observation 1604 and a displacement 2302 from an original position of the agent to the target observation 1604. In FIG. 23 part A, the odometry vector/stored displacement is perfect, meaning that no further action is required by the agent after following the displacement to reach the target observation.

FIG. 23, part B, illustrates the case of a slightly degraded match at the origin node and how this can result in positional or rotational error in the starting position, even with a good odometry vector 2304/displacement. In this case, the agent will arrive at a location which is not at the centre of the target node 1604. However, the arrival of the agent after travelling along the odometry vector 2304 is close enough to the target node 1604 that it is within the target node's action vector field. The target node's action vectors will then draw the agent to the target location 1604. If these action vectors point radially inward, towards the target location 1604, then the path taken under the guidance of the action vectors will be optimal (i.e., as straight and as short as possible).

FIG. 23, part C, illustrates the case of an inaccurate odometry vector 2306/displacement. In this case, the agent travels from the origin node in a direction that is not in the direction of the stored observation and thus target location 1604. At the end of the odometry vector, the length of the path that is followed under the guidance of action vectors is likely to be larger. In FIG. 23 part C, the end of the odometry vector 2306 is still within the radial action vector field of the target observation, and as such, the path taken under guidance of the action vectors is still efficient, and straight to the target location 1604.

FIG. 23, part D, illustrates that case of an inaccurate odometry vector 2308/displacement. In this case, the agent travels from the origin node in a direction that is not in the direction of the stored observation and thus target location 1604. At the end of the odometry vector, the length of the path that is followed under the guidance of action vectors is likely to be larger. In FIG. 23 part C, the end of the odometry vector 2306 is within a non-radial vector field of the target observation, and as such, the path taken under guidance of the action vectors becomes even longer because it is not straight. In this case, imperfect source and destination observation reliabilities both contribute to a reduction in the edge traversal reliability.

For any of the possible paths taken according to FIG. 23 parts A to D, the inverse of the length of the action vector guided path (dashed lines), averaged over multiple visits, provides a combined metric of edge traversal reliability, with contributions from the quality of the source and destination observations. In practice, the mean squared distance travelled by the agent on multiple visits to the target node 1604, starting from the origin node gives the edge traversal metric. The edge traversal metric is recorded as a value upon every navigation to a particular stored observation by an agent. After several navigations, it is possible to compute a mean and variance for the edge traversal metric. If, upon navigating the agent to the stored observation thereafter, an edge traversal metric value is recorded which is significantly poorer than the computed mean, the particular path (edge) navigated may be marked as ‘unreliable’.

Thus, the edge traversal metric is metric which allows an agent to compare one path against a series of historical visits to an observation location. By comparing the individual path to the historical mean, the agent is able to effectively update, maintain, or delete paths to observations based on whether they continue to provide an acceptable edge traversal metric.

This gives the advantage that the agent may be able to: i) avoid the low reliability edge, if an alternative route can be used to navigate to the target stored observation; ii) find a correction to the originally recorded odometry vector by attempting the traversal with a slightly modified angle for the odometry vector, effectively performing an optimisation process attempting to maximise the edge traversal metric; iii) enhance the edge traversal by introducing an intermediate stored observation. In this case, if the metric is low, and the edge is deemed unreliable, the agent may be instructed to store a new observation on the unreliable edge. For example, the agent may advance halfway along the original odometry vector, and record a new stored observation at that location. It then estimates the odometry vector from the new stored observation to the original target observation (for which the edge was unreliable) and refines this by adjusting the angle and maximising the edge traversal metric as in (ii), above; iv) notify an operator that the edge traversal metric is poor; and similarly v) the edge traversal metric values could be returned to an operator upon completion of a graph creation process (by manually controlling the agent along a path, during which the agent would record observations). These edge traversal metric values indicate to the operator whether the graph that had just been created are likely to be reliable, allowing them to re-create the graph if necessary.

In the examples described above, the system or method may be implemented using a server. The server may comprise a single server or network of servers. In some examples, the functionality of the server may be provided by a network of servers distributed across a geographical area, such as a worldwide distributed network of servers, and an agent may be connected to an appropriate one of the network servers based upon, for example, an agent location.

The above description discusses embodiments of the invention with reference to a single agent for clarity. It will be understood that in practice the system may be shared by a plurality of agents, and possibly by a very large number of agents simultaneously.

The examples described above are fully automatic and may be carried out by an agent autonomously. In some examples a user or operator of the system may manually instruct some steps of the method to be carried out.

In the described examples, the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system, or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile, or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray® disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device in some examples, it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one example or may relate to several examples. The examples are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred example is given by way of example only and that various modifications may be made by those skilled in the art. What has been described above includes examples. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A computer-implemented method of navigating an agent in a multidimensional space, the method comprising:
generating a data field that spatially corresponds to a multidimensional space in which an agent resides, wherein the data field is populated with observation comparison measure data with respect to a stored observation, the stored observation including second sensor data describing an environment of a first position in the multidimensional space,
wherein the generating the data field comprises:
obtaining a plurality of current observations made by the agent at different respective positions of the agent in the multidimensional space, the current observations including first sensor data describing an environment of each of the different respective positions of the agent in the multidimensional space;
comparing each of the current observations with the stored observation to obtain respective observation comparison measure data for the different respective positions of the agent in the multidimensional space; and
populating the data field with the observation comparison measure data according to the different respective positions of the agent in the multidimensional space;
the method further comprising:
determining a reliability measure associated with the stored observation by performing a reliability check of the data field; and
managing a digital map of the multidimensional space by maintaining, updating, or deleting information in the digital map regarding the stored observation based on the reliability measure.

2. The method of claim 1, wherein the first sensor data and the second sensor data are first and second image data respectively, wherein the first and second sensor data are arranged in a first vector and a second vector extracted from the first and second image data respectively.

3. The method of claim 2, further comprising obtaining the first sensor data and the second sensor data, wherein obtaining the first sensor data comprises:
obtaining original first sensor data of the environment of the agent at each of the different respective positions of the agent in the multidimensional space;
processing the original first sensor data to reduce the size of the original first sensor data to obtain the first sensor data, such that the first sensor data is in a reduced-size format relative to the original first sensor data;
wherein obtaining the second sensor data comprises:
obtaining original second sensor data of the environment of the agent at the first location; and
processing the original second sensor data to reduce the size of the original second sensor data to obtain the second sensor data, such that the second sensor data is in a reduced-size format relative to the original second sensor data; and
storing the second sensor data in the reduced-size format.

4. The method of claim 3, wherein processing the original first and original second sensor data comprises applying one or more filters and/or masks to the original first and original second sensor data to reduce the size of each dimension of the original first and original second sensor data respectively.

5. The method of claim 1, further comprising navigating the agent to the stored observation according to the digital map.

6. The method of claim 5, wherein the digital map comprises information regarding a series of stored observations and displacement vectors linking the series of observations; and wherein navigating includes using the digital map information to navigate the agent to one of the series of stored observations.

7. The method of claim 1, wherein the data field includes an action vector field, the action vector field comprising a plurality of action vectors, wherein the observation comparison measure data is the plurality of action vectors, and wherein each of the plurality of action vectors originates at one of the different respective positions of the agent in the vector field and is directed in an estimated direction of the first position in the vector field,
wherein the comparing each of the current observations with the stored observation to obtain respective observation comparison measure data for the different respective positions in the multidimensional space comprises, for each different respective position of the agent:
obtaining a plurality of first sub-regions of the first sensor data, each first sub-region describing a respective first portion of the environment around the agent at the one of the different respective positions, each first portion being associated with a respective first direction from the one of the different respective positions;
obtaining a plurality of second sub-regions of the second sensor data, each second sub-region describing a respective second portion of the environment around the first position, each second portion being associated with a respective second direction from the first position;
for each second sub-region:
comparing the second sub-region against each first sub-region using a similarity comparison measure to determine a most similar first sub-region to the second sub-region; and determining a relative rotation between the second direction associated with the second sub-region and the first direction associated with the most similar first sub-region; and
aggregating the relative rotations for the plurality of second sub-regions to obtain the action vector originating at the respective position of the agent, the action vector indicating the estimated direction from the position of the agent to the first position.

8. (canceled)

9. The method of claim 7, wherein the determining a reliability measure associated with the stored observation by performing a reliability check of the data field comprises:
obtaining a model action vector field spatially corresponding to the action vector field, wherein the model action vector field comprises a plurality of model action vectors, each of which are directed directly to the first position, such that the model vector field is radially convergent on the first position;
comparing the plurality of action vectors of the action vector field to the spatially corresponding model action vectors of the model action vector field to determine an angular deviation between each action vector and corresponding model action vector;
aggregating or averaging the angular deviations between the plurality of action vectors and the plurality of model action vectors to determine a first scalar measure, wherein the reliability measure is inversely proportional to the first scalar measure.

10. The method of claim 7, wherein the determining a reliability measure associated with the stored observation by performing a reliability check of the data field comprises:
determining a first number of the different respective positions of the agent for which it is not possible to obtain an action vector, wherein it is not possible to calculate an action vector for a position of the agent when the relative rotations for the plurality of second sub-regions all cancel out for the position;
determining a second number of the different respective positions for which it is possible to obtain an action vector;
dividing the first number by the second number to determine a second scalar measure, wherein the reliability measure is inversely proportional to the second scalar measure.

11. The method of claim 9, wherein managing a digital map of the multidimensional space by maintaining, updating, or deleting information in the digital map regarding the stored observation based on the reliability measure comprises:
comparing the reliability measure to one or more thresholds to determine whether to update, delete or maintain the information in the digital map; wherein: deleting the information in the digital map comprises deleting information regarding the stored observation in the digital map and adjusting the digital map to account for the deleted information; and/or
updating the information in the digital map comprises:
obtaining replacement second sensor data at the first position in the multidimensional space to form a replacement stored observation; and
regenerating the data field according to the replacement stored observation.

12. (canceled)

13. The method of claim 1, wherein the data field includes a similarity magnitude scalar field, the similarity magnitude scalar field comprising a plurality of similarity magnitude values indicative of a similarity between the stored observation and respective current observations at each of the different respective positions of the agent, wherein the observation comparison measure data is the plurality of similarity magnitude values.

14. The method of claim 13, wherein comparing each of the current observations with the stored observation to obtain respective observation comparison measure data for the different respective positions of the agent in the multidimensional space comprises:
comparing each current observation with the stored observation using a similarity comparison measure to determine a similarity magnitude value for each of different respective positions of the agent,
wherein the observation comparison measure data includes the similarity magnitude values.

15. The method of claim 14 wherein the current observation and the stored observation are arranged as vectors and the similarity comparison measure is the inner product of these vectors.

16. The method of claim 13, wherein the determining a reliability measure associated with the stored observation by performing a reliability check of the data field comprises:
determining a maximum similarity magnitude value of the plurality of similarity magnitude values of the similarity magnitude scalar field,
dividing the maximum similarity magnitude value by the mean of the plurality of the similarity magnitude values to determine a third scalar value, wherein the reliability measure is proportional to the third scalar measure.

17. The method of claim 13, further comprising:
generating a parameterised model of the similarity magnitude scalar field that approximates the similarity magnitude scalar field, wherein the parameterised model is a smooth approximation of the similarity magnitude scalar field fitted according to one or more characteristics of the similarity magnitude scalar field.

18. The method of claim 17 wherein the determining a reliability measure associated with the stored observation by performing a reliability check of the data field comprises:
determining a maximum similarity magnitude value of the parameterised model of the similarity magnitude scalar field;
dividing the maximum similarity magnitude value by a mean of the parameterised model of the similarity magnitude scalar field to determine a third scalar value, wherein the reliability measure is proportional to the third scalar measure.

19. The method of claim 17, wherein the determining a reliability measure associated with the stored observation by performing a reliability check of the data field comprises:
determining the variability between the similarity magnitude values and model values of the parameterised model; and
obtaining a fourth scalar value based on the variability, wherein the reliability measure includes the fourth scalar measure.

20-21. (canceled)

22. A computing device comprising a processor and a memory, the memory having instructions stored thereon, that, when executed by the processor, cause the computing device to perform the method of claim 1.

23. A computer program, which, when executed by a processor, causes the processor to perform the method of claim 1.

24-42. (canceled)
